(19) United States
(12) Patent Application Publication
(10) Pub. No.: US 2006/0293956 A1
(43) Pub. Date: Dec. 28, 2006

(54) Systems and methods for e-mail marketing via vending machines

(76) Inventors: Jay S. Walker, Ridgefield, CT (US); Paul T. Breitenbach, Wilton, CT (US); Daniel E. Tedesco, Shelton, CT (US); Sih Y. Lee, Northvale, NJ (US); Paul D. Signorelli, Ridgefield, CT (US); Geoffrey M. Gelman, Brooklyn, NY (US); James A. Jorasch, New York, NY (US); Matthew P. Ellenthal, Wilton, CT (US)

Correspondence Address: WALKER DIGITAL, 2 HIGH RIDGE PARK, STAMFORD, CT, 06905, US

(21) Appl. No.: 11/418,603

(22) Filed: May 5, 2006

Related U.S. Application Data
(63) Continuation-in-part of application No. PCT/US04/41395, filed on Dec. 9, 2004.
(60) Provisional application No. 60/527,987, filed on Dec. 9, 2003.

(51) Int. Cl. G07G 1/14

(52) U.S. Cl. 705/14

(57) ABSTRACT

According to an embodiment, a device provides an offer, via an interface at a vending machine, for a benefit in exchange for an e-mail address. An e-mail address is received via the interface. After receiving the e-mail address, a promotional message is transmitted to the received e-mail address.

### CROSS-REFERENCE TO RELATED APPLICATIONS

This application is (i) a continuation-in-part that claims priority and benefit under 35 U.S.C. §120 to commonly owned, co-pending International Application US2004/041395 entitled “MARKETING SYSTEM EMPLOYING VENDING MACHINES” filed Dec. 9, 2004, which claims priority to U.S. Provisional Patent Application Ser. No. 60/527,987 entitled “MARKETING SYSTEM EMPLOYING VENDING MACHINES” filed on Dec. 9, 2003, and (ii) also claims priority and benefit under 35 U.S.C. §119(e) to U.S. Provisional Application Ser. No. 60/678,457 entitled “MARKETING SYSTEM EMPLOYING VENDING MACHINES”, filed on May 5, 2005, each of these applications being hereby incorporated by reference herein.

### BACKGROUND

Conventional vending machines and vending machine systems are generally capable of dispensing offered products to customers. Such dispensing is typically conducted on a transaction-by-transaction basis, with each customer inserting money into the vending machine and selecting one or more desired products. Conventional vending machines, however, are prone to various inefficiencies, problems, and limitations.

### BRIEF DESCRIPTION OF THE FIGURES

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a block diagram of a system according to some embodiments;

FIG. 4 is a schematic illustration of a data storage structure according to some embodiments;

FIG. 5 is a schematic illustration of a data storage structure according to some embodiments;

FIG. 6 is a schematic illustration of a data storage structure according to some embodiments;

FIG. 7 is a schematic illustration of a data storage structure according to some embodiments;

FIG. 8 is a schematic illustration of a data storage structure according to some embodiments;

FIG. 9 is a flow diagram illustrating a method according to some embodiments.;

FIG. 10A and FIG. 10B are illustrations of an exemplary interface of a vending machine according to some embodiments; and

FIG. 11, FIG. 12, FIG. 13, FIG. 14, FIG. 15, FIG. 16, FIG. 17, and FIG. 18 are illustrations of exemplary promotional messages according to some embodiments.

### DETAILED DESCRIPTION

### I. Introduction

Applicants have recognized that benefits and advantages may be obtained and/or realized by providing e-mail marketing and/or promotions to vending machine customers. Transactional customers (e.g., who's identity is not known; cash customers) may, for example, be provided with offers for free products (and/or sweepstakes entries, prizes, games, etc.) in exchange for an e-mail address of the customer. According to some embodiments, the e-mail address of the customer may be utilized to identify the customer and/or to establish or identify an account associated with the customer. Customers providing e-mail addresses to the vending machine may be given accounts with one or more free products credited thereto, for example. Messages and/or promotions may, in some embodiments, then be sent to the known customers to encourage customer funding of the accounts. According to some embodiments, offers for vending machine subscriptions and/or memberships may be provided via e-mail. Similarly, account-holding customers may also or alternatively be provided with e-mail messages promoting one or more vending machines and/or products. Based on a customer's purchase history at the vending machine (and/or within a network of vending machines), for example, the customer may be given information and/or promotions relating to (i) products of historical interest to the customer, (ii) products that may be of interest to the customer, (iii) products that the customer has not historically tried, and/or (iv) the vending machine and/or another vending machine.

Applicants have also recognized that underserved markets for traditionally vended products exist in locations that do not enjoy sufficient foot traffic to justify the placement of conventional vending machines. Applicants have also recognized that significant commercial benefits may ensue through proactively marketing, through communication networks such as the Internet, the goods and services offered by vending machines.

Various embodiments described herein allow an operator of a vending machine, a vending machine itself and/or a computer associated therewith, to proactively market vended products by sending promotional messages to user devices of potential customers. The promotional messages may encourage customers to transact with one or more vending machines, such as by:
(i) redeeming promotional codes for free trial products (e.g., sample products);
(ii) making purchases at the vending machine (thereby stimulating sales);
(iii) establishing an account (e.g., a prepaid unit or “subscription” account, a membership account, a stored-value account, and/or a credit account);
(iv) redeeming units of a product purchased in association with a prepaid unit or “subscription” account;
(v) redeeming entitlements afforded to holders of vending machine membership accounts;
(vi) participating in a game (e.g., by presenting a game piece to a vending machine in order to determine if a prize is won); and/or
(vii) performing any other practicable action.

By proactively marketing vending machines and/or products offered thereby to customers, a location with even a small potential customer base may become a sufficiently profitable location for a vending machine. Further, existing vending machine locations may realize an increase in profits through employment of the proactive marketing functionality disclosed herein.

According to some embodiments, before promotional messages may be transmitted to one or more user devices, contact information (e.g., communications addresses, such as e-mail addresses) of one or more customers may be submitted to and/or confirmed by a vending machine, a computer associated therewith, and/or an operator thereof.

In some embodiments, a vending machine may receive contact information directly from a customer via an input device of the vending machine (e.g., a touch screen interface and/or keypad). Such a vending machine may solicit contact information before, during, and/or following a customer transaction. In some embodiments, the vending machine may offer a benefit, such as a free beverage and/or a sweepstakes entry, in exchange for a customer entering an e-mail address.

Applicants have also recognized many benefits that may be achieved by adapting a vending machine to an office environment, especially a small office environment. For example, companies that were previously considered too small (e.g., in terms of number of employees) to economically justify placement of a vending machine could profitably use a vending machine according to certain disclosed embodiments. Such companies may benefit from increased employee satisfaction stemming from the availability of vended items. Vending machine operators may, in turn, benefit from a more diverse set of locations for profitably operating vending machines. Vending machines in traditionally profitable areas may garner even greater profits with the use of proactive promotional functionality.

In some embodiments, an operator of a vending machine may agree to place a vending machine in a company facility (e.g., in a small company) provided the operator receives a list of e-mail addresses of company employees. The vending machine operator may then use the e-mail addresses to send promotional messages, e.g., which encourage sales at the vending machine.

Some embodiments provide rules as to when and/or how a vending machine operator and/or a third party associated therewith (e.g., a product manufacturer) may transmit promotional messages to user devices. For example, promotional messages may be limited in terms of content, times of transmission, and/or frequency. Promotional messages may also or alternatively be limited to particular recipients who have not affirmatively opted out from receiving such messages. The rules may allow a company to provide employee contact information while receiving assurances that such contact information will not be abused, and that any disruption to employees will be minimal. In various embodiments, a company official may screen promotional messages destined for company employees in order to assure that such messages are within the boundaries of appropriate rules.

According to an exemplary embodiment, a vending machine that sells coffee may display a message to a customer (e.g., upon insertion of currency) such as “Thanks for trying our Gourmet Coffee. We would love to alert you when we get new coffee brews. So just give us your e-mail address and your next coffee is free. We promise to e-mail you no more than once per week, and we promise not to give your e-mail address to anyone else.” In response, the customer may enter an e-mail address using a touch screen on the vending machine. The customer may then, for example, select a coffee to dispense. Later (e.g., that day) an e-mail message can be transmitted to the customer's e-mail address. The e-mail message can include a subject line such as “Free Gourmet Coffee” and the body of the e-mail message can include a message such as “We hope you enjoyed your coffee this morning. As promised, the next one is on us. Just type in the following code next time you visit the machine: cof9382.” Subsequently, the customer may enter the code provided into the vending machine (e.g., via a touch screen), and in response the vending machine can provide a coffee for free.

According to some embodiments, a vending machine (or computer associated therewith) may be connected to a company's computer network (e.g., a LAN, a WAN), and can send e-mails to associated e-mail addresses (e.g., an employee's e-mail address) through the company's computer network. The vending machine may determine that sales should be increased through promotions (e.g., significant inventory is predicted to be remaining at the next restock date; actual product velocity is less than ideal product velocity). The vending machine can, e.g., adjust its prices and compose promotional e-mail messages informing employee customers of those adjusted prices, such as “Hungry? Come visit the Quickstore24™ vending machine right by the elevator. All Crunchy snacks are 50% off for the next two days!!”

According to some embodiments, a vending machine may be directed to provide a customer with benefits, such as free or discounted products, in exchange for the customer providing an e-mail address. Similarly, a vending machine may be directed to provide the customer with benefits, such as free or discounted products, while another person or entity may subsidize or pay for those benefits (e.g., upon reconciliation every restock period, Mars™, Incorporated may reimburse an operator for the costs of every M&MS brand item provided as a free benefit to customers).

Various embodiments provide different advantages. For example, in various embodiments, a vending machine operator may increase sales at a vending machine by promoting the vending machine to potential customers via e-mail and/or other communication media. According to some embodiments, transactional customers and/or cash customers may be motivated to provide an e-mail address, such that the customer may establish an account with the vending machine. Account-holding customers may also or alternatively be provided with incentives and/or promotions (e.g., via e-mail) to promote funding of the customer's account and/or to promote automatic recharge (e.g., via a credit card) of the customer's account. In some embodiments a vending machine can market a particular product. In various embodiments, a vending machine operator may open up new markets for a vending machine by deriving additional sales from a customer base that would otherwise be too small.

In various embodiments, an employer may benefit by obtaining a vending machine that could not otherwise be profitably placed in the company. In various embodiments, an employer may use a vending machine as a convenient and low-cost reward mechanism for its employees, thereby potentially increasing productivity.

In various embodiments, a customer or user benefits from the ability to receive information (without having to be proximate to the vending machine) about discounts, free products, and other benefits provided at a vending machine.

### II. Terms and Definitions

Throughout the description that follows and unless otherwise specified, the following terms may include and/or encompass the example meanings provided in this section. These terms and illustrative example meanings are provided to clarify the language selected to describe embodiments both in the specification and in the appended claims.

Some embodiments described herein are associated with a “control system”. As used herein, the term “control system” may generally refer to any combination of hardware, software, firmware, and/or microcode that is operative to carry out and/or facilitate embodiments described herein. For example, a control system may comprise a processor performing instructions of a program to provide subscription accounts, account access, and/or account control or management functionality to customers and/or third parties. The control system may comprise, according to some embodiments, a single device and/or component or may comprise any practicable number of networked devices.

Some embodiments described herein are associated with a “network device”. As used herein, the term “network device” may generally refer to any device that can communicate via a network. Examples of network devices include a PC, a workstation, a server, a printer, a scanner, a facsimile machine, a copier, a PDA, a storage device (e.g., a disk drive), a hub, a router, a switch, and a modem or a wireless phone. In some embodiments, network devices may comprise one or more network components, such as a Static Random Access Memory (SRAM) device or module, a network processor, and/or a network communication path, connection, port, or cable. Some examples of network devices may include, but are not limited to, servers or controllers, customer devises, vending machines, input devices, output devices, and peripheral devices.

As used herein, the terms “server” and “controller” may be used interchangeably and may generally refer to any device that may communicate with one or more vending machines, one or more third-party servers, one or more remote controllers, one or more customer devices, one or more peripheral devices and/or other network nodes, and may be capable of relaying communications to and/or from each such device. A controller or sever may, for example, comprise one or more network devices and/or components.

As used herein, the terms “customer device” and “user device” may be used interchangeably and may generally refer to any device owned and/or operated by, or otherwise associated with a customer, which device is capable of accessing and/or outputting online and/or offline content. Customer devices may communicate with one or more servers or controllers, one or more vending machines, one or more third-party service provider servers, one or more user terminals, and/or other network devices or nodes. In some embodiments, customer devices may, for example, include gaming devices, PC devices, PDA devices, Point-Of-Sale (POS) terminals, point of display terminals, kiosks, telephones, cellular phones, Automated Teller Machines (ATM) devices, pagers, and/or combinations of such devices. In some embodiments, customer devices may communicate with vending machines and remote devices and/or computers wirelessly, through any practicable wireless communication networks, formats and/or protocols, including but not limited to those described herein.

As used herein, the term “vending machine” may generally refer to any system, apparatus, and/or module that is operable to provide and/or facilitate the provision of goods and/or services to customers. Vending machines may include, but are not limited to, for example, one or more stand-alone, networked, automated, mechanical, and/or electrical devices coupled to dispense products such as beverages and/or snacks to customers. In some embodiments, vending machines may comprise, be coupled to, and/or may be otherwise associated with one or more input devices, output devices, and/or peripheral devices (e.g., to operate in accordance with embodiments described herein).

As used herein, the terms “product,” “good,” “item”, “merchandise,” and “service” may be used interchangeably and may generally refer to anything licensed, leased, sold, available for sale, available for lease, available for licensing, and/or offered or presented for sale, lease, or licensing including individual products, packages of products (such as mystery packages), subscriptions to products, contracts, information, services, and intangibles. Examples of goods sold at vending machines may include, but are not limited to: beverages (e.g., cans or bottles of soda or water), snacks (e.g., candy bars), and recordable media (e.g., pre-recorded and/or dynamically-recorded disks or tapes). Examples of services sold by vending machines include car washes, photography services and access to digital content (e.g., permitting the downloading of digital picture, video, and/or audio files such as audio “ring tones” and/or wallpapers to a handheld device). In some embodiments, Wi-Fi™ and/or other network access (e.g., access to a peer-to-peer network), arcade style games, pinball games, and/or other media content may comprise a product and/or service offered by a vending machine.

As used herein, the term “input device” may generally refer to a device that is used to receive input. An input device may communicate with and/or be part of another device (e.g. a point of sale terminal, a point of display terminal, a customer terminal, a server, a customer device, a vending machine, a controller, and/or a peripheral device). Some examples of input devices include, but are not limited to: a bar-code scanner, a magnetic stripe reader, a computer keyboard, a point-of-sale terminal keypad, a touch-screen, a microphone, an infrared sensor, a sonic ranger, a computer port, a video camera, a motion detector, a digital camera, a network card, a Universal Serial Bus (USB) port, a Global Positioning System (GPS) receiver, a Radio Frequency IDentification (RFID) receiver, a RF receiver, a thermometer, a pressure sensor, and a weight scale or mass balance.

As used herein, the term “output device” may generally refer to a device that is used to output information. An output device may communicate with and/or be part of another device (e.g. a vending machine, a point of sale terminal, a point of display terminal, a customer device, and/or a controller). Possible output devices may include, but are not limited to: a Cathode Ray Tube (CRT) monitor, a Liquid Crystal Display (LCD) screen, a Light Emitting Diode (LED) screen, a printer, an audio speaker, an Infrared Radiation (IR) transmitter, an RF transmitter, and/or a product hopper, dispenser, and/or data port.

As used herein, the term “peripheral device” may refer to any device associated with one or more vending machines, the peripheral device being operable to perform in accordance with embodiments as described herein. For example, in one embodiment a traditional vending machine may be retrofitted with a peripheral device that comprises a processor, memory, and/or an output device for facilitating e-mailing of promotions such as mystery package promotions, subscription promotions, membership promotions, and/or other promotions associated with a vending machine, in accordance with embodiments described herein. A peripheral device may or may not be attached or coupled to a vending machine. A peripheral device may or may not be operable to direct the associated vending machine to perform certain functions. A peripheral device, or portions thereof, may be housed inside the casing of the associated vending machine. Further, a peripheral device may be operable to detect one or more events at a vending machine. For example, a peripheral device may be operable to detect one or more signals output by a processor of a vending machine. Further still, a peripheral device may be operable to communicate with a processor of an associated vending machine. According to some embodiments, a peripheral device (and/or a vending machine itself) may be configured to conserve coins and/or to facilitate intelligent dispensing of products.

Some embodiments described herein are associated with an “operator”. As used herein, the term “operator” may generally refer to the owner of a vending machine or an agent or associate thereof (e.g., a route driver or lessee of a vending machine). In some embodiments, an operator may also be associated with a server or controller and/or customer devices utilized to implement embodiments described herein. Operators may also or alternatively be associated with the manufacture and/or distribution of one or more products or services provided via a vending machine. According to some embodiments, an operator may be associated with restocking one or more vending machines (e.g., on a restock date and/or at a restock time).

As used herein, the term “promotion” may generally refer to a message that is output, regarding some product, distinct from a general offer to sell products from a vending machine at retail prices. For example, a promotion may comprise a message intended to increase machine profitability. Typically, a promotion allows customers to purchase one or more products under terms that are generally more favorable to the customer than standard retail terms (e.g., at prices less than or equal to the corresponding product's full price(s), but greater than or equal to the corresponding product's minimum price(s)). In some embodiments, a promotion may comprise an offer and/or incentive associated with providing a subscription account to a customer.

As used herein, the term “promotional message” may generally refer to a message that promotes a vending machine, e.g., by promoting sales, account relationships, and/or other marketing activities at a vending machine, or otherwise by promoting goodwill for the vending machine. Promotional messages may generally, for example, comprise e-mails that include information relating to one or more promotions associated with the vending machine. A promotional message may be transmitted to one or more customers or potential customers of a vending machine. A promotional message may be transmitted to a user device and may include audio or visual (graphics, pictures, text, video) content. A promotional message may be composed and/or sent by a controller, vending machine, or representative of a company charged with encouraging sales at a vending machine. A promotional message may indicate, for example, the existence of items on sale, a discount to be offered to a recipient, the availability of a new product, the availability of a “free” product, the availability of an account-based relationship (e.g., a subscription relationship or a membership relationship), and so on. In one or more embodiments, a promotional message may include or be accompanied by a code which, when presented to one or more vending machines (e.g., through an input device and/or user device), allows a customer to realize one or more benefits provided by the vending machine(s) (e.g., receiving a free product, a discounted product, a discounted subscription account, a discounted membership account, etc.).

As used herein, the terms “package deal”, “combination deal”, “package promotion”, “combination promotion”, “combination product promotion”, “load-up deal”, “value combo deal”, and “combo deal” may be used interchangeably and may generally refer to any offer enabling a customer to purchase at least two products. In many embodiments the at least two products are sold for a single price. In many embodiments, the two products are dispensed to the customer essentially simultaneously (e.g., within seconds of each other). Typically, package offers are configured so the price of the at least two products is less than the sum of the prices of the two products, and thus the customer saves money compared to the sum of the individual component products' retail prices. According to some embodiments, customers may be presented with package offers in association with subscription accounts (e.g., an account may comprise a subscription to a package of products that may be redeemed at various times).

As used herein, the term “package price” may generally refer to the price that is charged (typically in a single transaction) for the units of products purchased pursuant to a package offer (e.g., associated with one or more package instances). Typically, package prices reflect a net-savings to the customer when compared to the sum of the respective retail prices of the individual component products. In some embodiments, such as in the case that a package is offered to a customer as a subscription offer, the package price may be equivalent to the subscription price.

Some embodiments herein are associated with “communication”. As used herein, the term “communication” may refer to any information, data, and/or signal that is provided, transmitted, received, and/or otherwise processed by an entity, and/or that is shared or exchanged between two or more people, devices, and/or other entities.

As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encrypted, and/or otherwise packaged or manipulated in accordance with any method that is or becomes known or practicable.

Some embodiments described herein may be associated with a “customer” and/or a “user”. As used herein the terms “customer” and “user” may generally be used interchangeably and may generally refer to any person or entity that transacts or interacts with a vending machine. For example, a user may be someone who receives a promotional message from a vending machine and/or computer associated therewith, visits the vending machine, enters a promotional code indicated in the message, and/or who accordingly receives a discounted or free product. The terms “user”, “customer”, “consumer”, “employee”, and “person” may all be used interchangeably herein. Customers and users may be “transactional customers”, “unfunded account holders”, “funded account holders”, “subscribers”, and/or “members”.

As used here, a “transactional customer” may generally refer to a cash customer or a customer of a vending machine that does not have an account with the vending machine and/or vending machine network. Cash customers and/or transactional customers may generally be unidentified and/or anonymous customers. As used herein, account-holding customers or “account holders” may generally be customers that have established accounts with the vending machine. In the case that a customer's account is created to provide free and/or promotional products to the customer, the account may be “unfunded” by the customer, and the customer may therefore be deemed and “unfunded account holder”. According to some embodiments, when a customer funds an account (e.g., upon account creation and/or in response to a promotional e-mail message), he account may be funded by the customer and the customer may therefore considered a “funded account holder”.

In some embodiments, an account holder may comprise a person who is entitled to redeem units of vended product pursuant to a registered subscription. Such customers may generally be referred to herein as “subscribers”. In one or more embodiments, a customer may register a subscription at a vending machine. Further, in one or more embodiments, a customer may register a subscription online. Further still, in one or more embodiments, a third party (e.g., a parent) may register a subscription for a customer (e.g., as a gift) either online or at a vending machine. Various apparatus, systems and methods describing “subscription” (or “prepaid unit”) accounts are disclosed in Applicant's U.S. Pat. No. 6,298,972, entitled METHOD AND APPARATUS FOR ESTABLISHING AND MANAGING VENDING MACHINE SUBSCRIPTIONS, issued Oct. 9, 2001; U.S. Pat. No. 6,085,888, entitled METHOD AND APPARATUS FOR ESTABLISHING AND MANAGING VENDING MACHINE SUBSCRIPTIONS, issued Jul. 11, 2000; and U.S. Pat. No. 5,988,346, entitled METHOD AND APPARATUS FOR ESTABLISHING AND MANAGING VENDING MACHINE SUBSCRIPTIONS, issued Nov. 23, 1999; the subscription account descriptions and concepts of each of which are hereby incorporated by reference herein.

In some embodiments, an account holder may be a “member” of the vending machine network. Such “members” may generally comprise account holders that have accepted membership promotional offers. Membership promotions may generally, for example, allow an account holder to pay a fee to receive discounts via the vending machine and/or vending machine network. In one or more embodiments, a customer may purchase a limited time membership account, and may be granted a membership identifier in return. The membership identifier allows the customer, during a limited time, to realize certain benefits and privileges at one or more vending machines. For example, in one or more embodiments, a valid membership identifier permits a customer to receive products (e.g., up to two (2) sodas per day), discounts (e.g., members may purchase items at wholesale prices or cost; only members may receive sale prices), and/or promotions (e.g., sweepstakes entries). Various apparatus, systems, and methods describing vending machine membership accounts are disclosed in Applicant's co-pending International Patent Application WO US2005/023029 entitled “PRODUCTS AND PROCESSES FOR A MEMBERSHIP FOR A CUSTOMER OF A VENDING MACHINE”, filed Jun. 29, 2005, the membership concepts and descriptions of which are hereby incorporated by reference herein.

As used herein, the terms “registered subscription” and “subscription” may be used interchangeably and may generally refer to any relationship between a customer and a vending machine operator that permits the customer to redeem multiple units of a product (and/or multiple products) at different times. The relationship may, for example, comprise a contractual relationship that is (i) formed upon the customer's acceptance of a subscription offer, and/or (ii) recorded and tracked in a database (e.g., by the vending machine and/or associated devices). A registered subscription may generally be recorded in association with one or more account parameters set by an account holder and/or by a third party.

Some embodiments described herein may be associated with a “subscription code”, a “code”, and/or a “subscription identifier”. As used herein the terms “subscription code”, “code”, and “subscription identifier” may generally be used interchangeably, and may generally refer to any information or data that is associated with a vending machine customer subscription. Such a code or identifier may, in some embodiments, be correlated in a database with a registered subscription. Typically, such codes and/or identifiers may be “unique” or substantially unique identifiers. Such codes and/or identifiers may include, but are not limited to, customer-selected codes such as a Personal Identification Number (PIN) code, codes generated automatically (e.g., random digits) for the customer, a customer Social Security Number (SSN), customer credit or debit card numbers, currency serial numbers (e.g., the serial number of a dollar bill), customer birthdays, user names, passwords, device serial numbers (e.g., associated with a customer's device), and/or biometric data (e.g., a customer's retinal patterns, fingerprint and/or thumbprint patterns, topical facial patterns, signatures, or the like). In some embodiments, subscription codes may be stored on, printed on, and/or otherwise indicated by tokens, coupons, cards, vouchers, wirelessly transmitting devices, RFID transmitters, and other physical media, as described herein. Subscription codes may generally be established, defined, and/or verified upon acceptance and/or consummation of a subscription offer.

As used herein, the term “subscription offer” may generally refer to any offer that is provided to a customer proposing that the customer pay a subscription price in exchange for the ability to redeem at least two units of a product or products at a vending machine in at least two redemption transactions. Thus, by accepting subscription offers, customers may be able to purchase at least two units of a product, and redeem the units of the product at different points in time (e.g., one the first day, another the following day). Subscription offers may be presented to customers via a vending machine (e.g., via voice, sound, and/or one or more displays) and/or via other devices or methods, such as via e-mail, direct mailing, etc. Subscription offers may also or alternatively be presented to every customer that interfaces with a vending machine, or only certain customers, such as customers that insert a certain threshold amount of funds, etc.

Some embodiments herein are associated with a “subscription price”. As used herein, the term “subscription price” may generally refer to the price charged in conjunction with the registration and/or acceptance of a subscription offer. In some embodiments, the subscription price may be equal to the sum of the full prices of the products indicated by the subscription offer. In other embodiments, the subscription price may be less than the sum of the full prices of the products indicated by the subscription offer. In such embodiments, subscription offers would provide customers with the ability to purchase the products at a discount relative to the total of the retail prices of all the purchased units. In yet other embodiments, such as “hard reserve” embodiments described herein, the subscription price may be more than the sum of the full prices of the products indicated by the subscription offer. A subscription price need not be fixed. For example, the amount a customer pays may not be in return for a fixed number of items. Also, the amount paid need not be known a priori. For example, the amount may be periodically charged in portions (e.g., once per week), and the amounts so charged need not be equal. In some embodiments, a third party may at least partially subsidize a subscription price.

As used herein, the terms “full price” and “retail price” may be used interchangeably and may generally refer to the normal price charged for the purchase of a given product (e.g., the price for which any customer may purchase a given product by inserting an equivalent monetary amount into the vending machine). Typically, subscription and/or package offers present customers with the opportunity to purchase items at less than full price and/or less than the total combined retail price of all subscription and/or package items.

As used herein, the term “redemption” may generally refer to the act, by a customer, of requesting, redeeming, and/or otherwise obtaining a unit of a product in accordance with and/or pursuant to a vending machine promotion and/or associated promotional message. Redemption may generally be performed via the vending machine and/or an associated device. In some embodiments, redemption may be accomplished by and/or associated with a “redemption transaction”. Redemption and/or a redemption transaction may generally comprise the process by which an account holder enters a code or identifier into an input device that is in communication with a vending machine control system, and receives one or more units of the product indicated by the underlying promotion. In some embodiments, codes may be entered directly by customers (e.g., into a keypad and/or via a fingerprint reader). In other embodiments, codes may be entered via voucher (e.g., a bar-coded voucher is deposited into a barcode reading bill validator). In some embodiments, a vending machine and/or computer associated therewith may determine whether or not certain account parameters are satisfied before honoring a request to redeem a unit of product from a vending machine.

As used herein, the terms “restock date” and “restock time” may generally refer, respectively, to the date and/or time that a vending machine is scheduled to be restocked by an operator (or agent thereof) of a vending machine. The time between restock dates may generally be referred to as a “sales period” or “fill period”. In some embodiments however, a sales period may otherwise be defined, e.g., such that multiple (and/or fractional) sales period may occur between restock dates.

As used herein, the terms “actual velocity” and “actual item velocity” may be used interchangeable to generally refer to the actual rate at which a given product is sold by a vending machine during a sales period.

Some embodiments herein are associated with an “ideal velocity”, an “ideal product velocity”, a “target product velocity”, and/or a “target velocity”. As used herein, the terms “ideal velocity”, “ideal product velocity”, “target product velocity”, and/or “target velocity” may be used interchangeably and may generally refer to a desired rate at which a given product should be sold by a vending machine during a sales period. Thus, in some embodiments, an ideal velocity may be set or calculated for each product indicating the rate at which products must be sold in order to deplete the inventory to a certain level by the end of a given sales period (e.g., by the restock time). For example, an ideal product velocity may be calculated by a vending machine control system after an operator inputs a restock date and a desired remaining inventory for the date (e.g., an operator may wish to have only one (1) of each item remaining at the restock date so that the machine sells as many items as possible without completely selling out and thereby disappointing customers). Thus, if an operator (i) stocks fifty (50) units of Soda A, (ii) inputs a restock date fourteen (14) days away, and (iii) indicates that only one (1) unit of Soda A should remain at the restock date, the control system may divide forty-nine (49; the number of units that are desired to be sold) by fourteen (14; the number of days until restock) to conclude that, on average, three and one half (3.5) units must be sold per day within the sales period in order to realize the ideal product velocity. As discussed herein, a vending machine control system may periodically, substantially continuously, or otherwise determine whether or not actual item velocity is at least equal to the ideal item velocity, and if not, may institute subscription offers and/or promotions as described herein.

### III. Systems and Apparatus

A. Introduction

Generally, according to one or more embodiments, a vending machine may comprise a device, or communicate with a device (e.g., a server, a peripheral device, and/or a peripheral device server), configured to manage sales transactions with customers by, among other things, receiving payment from customers, controlling the pricing and/or distribution (dispensing) of goods, controlling entitlements to services, determining whether to solicit e-mail addresses from customers, determining whether to transmit promotional messages, determining promotions, transmitting promotional messages, and/or creating, registering, updating, and/or otherwise managing customer accounts.

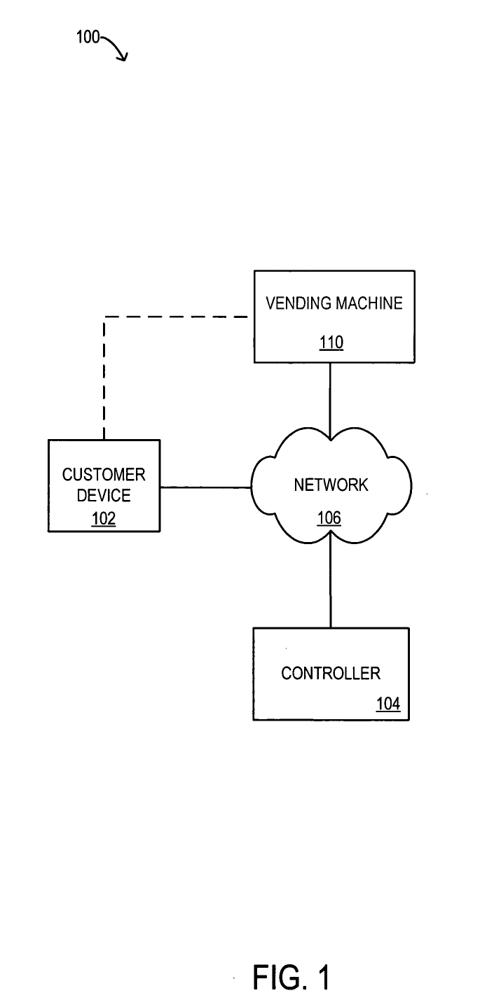

Referring first to FIG. 1, a block diagram of a system 100 according to some embodiments is shown. The system 100 may comprise, for example, a customer device 102 and/or a controller 104 in communication (e.g., via a network 106) with a vending machine 110. This communication may generally be established by and/or facilitated via the vending machine 110 (although it should be understood that in some embodiments, other and/or additional devices may be utilized to establish and/or facilitate the communication, such as a kiosk, Automatic Teller Machine (ATM), etc.). Either or both of the customer device 102 and the controller 104 may communicate directly with and/or be coupled directly to the vending machine 110. In some embodiments, either or both of the customer device 102 and the controller 104 may otherwise communicate with the vending machine 110, such as via the network 106. The network 106 may comprise any type and/or configuration of network that is or becomes known or practicable. The network 106 may comprise, for example, any number of wired and/or wireless networks.

According to some embodiments, the customer device 102 may be utilized by a customer (not shown) to communicate with the vending machine 110 to (i) purchase a product, (ii) establish an account (e.g., in response to an offer from the vending machine 110), (iii) redeem a product, (iv) and/or manage an account. The controller 104 may, according to some embodiments, be utilized to communicate with the vending machine 110 (and/or other devices associated therewith that are not explicitly shown in FIG. 1) to establish accounts (e.g., on behalf of and/or for one or more customers), to manage accounts, such as by defining, editing, and/or selecting account rules and/or parameters, and/or by monitoring, updating, and/or checking account transactions and/or balances, and/or by determining and/or transmitting promotional messages (e.g., via e-mail to the customer).

In some embodiments, the customer device 102 may comprise a PC, laptop, PDA, and/or wireless or cellular telephone. The customer device 102 may, for example, comprise a Bluetooth-enabled cellular telephone. In such embodiments, the vending machine 110 may detect and/or actively solicit the customer device 102 with an offer to purchase a subscription (e.g., instead of and/or in addition to displaying messages via the vending machine 110). The network 106 may generally comprise any practicable and/or desirable type and/or configuration of network, such as the Internet. The controller 104 may generally comprise any type of network device such as a PC and/or a server that is operable to communicate with the vending machine 110 and/or with the customer device 102. The controller 104 may, for example, be owned and/or operated by and/or otherwise associated with an individual and/or entity that desires to establish, maintain, and/or manage customer accounts and/or that is associated with providing promotional messages and/or e-mails to customers.

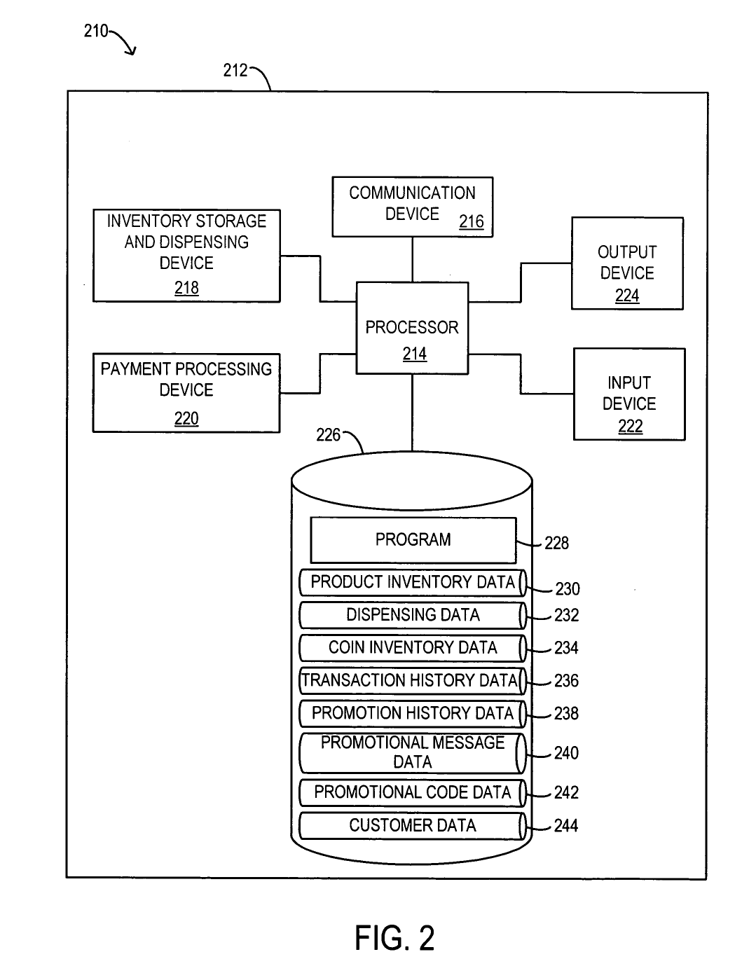

Turning now to FIG. 2, a block diagram of a vending machine 210 according to some embodiments is shown. In some embodiments, the vending machine 210 may be similar in configuration and/or functionality to the vending machine 110 of FIG. 1. The vending machine 210 may comprise, for example, a casing 212 enclosing one or more of a processor 214, a communications device 216, an inventory and dispensing device 218, a payment processing device 220, an input device 222, an output device 224, and/or a data storage device 226. According to some embodiments, the vending machine 210 may be configured to perform and/or facilitate processes in accordance with embodiments described herein. The vending machine 210 may, for example, be utilized to offer benefits in exchange for customer e-mail addresses, receive customer e-mail addresses, transmit promotional messages via e-mail to customers, dispense products, and/or manage customer accounts.

B. Casing/Cabinetry

In some embodiments, a suitable casing 212 and/or cabinetry may be constructed from any suitable material, including but not limited to any combination of (1) commercial grade sixteen-gauge steel (e.g., for exterior panels and internal shelving), (2) transparent materials such as glass or Plexiglas (e.g., for product display windows), (3) rubber (e.g., for waterproofing insulation), (4) plastic, and/or (5) aluminum.

Many commercially available casings 212 may be adapted to work in accordance with various embodiments. For example, in snack machine embodiments, a suitable casing 212 may comprise the “129 SnackShop” manufactured by Automatic Products International, Ltd. of Saint Paul, Minn., which stands at seventy-two inches (72″/1829 mm) wide, has a width of thirty-eight and seven eighths inches (38⅞″/988 mm), and a depth of thirty-five inches (35″/889 mm). Other suitable snack machine casings 112 include the A La Carte® machine from Automatic Products, and the GPL SnackVendor model #159 from Crane Merchandising Systems/Crane Co. of Stamford, Conn.

In beverage machine embodiments, casings 212 commercially available from Dixie Narco, Inc. of Williston, S.C. may be employed. Beverage machine casings 212 may comprise a “cooler” or “glass front” style front panel, featuring a transparent front panel (e.g., glass) enabling customers to see inventory for sale. Alternatively, beverage machine casings 212 may comprise a “bubble front” style front panel, featuring a decorative front panel, typically used to advertise a logo of a product manufacturer commercially interested in the operation of the vending machine 210.

Other embodiments are contemplated as well, including combination snack and beverage vending machine embodiments, such as those available from Crain Co. Further details concerning the suitability of machine casings 212 and/or cabinetry are well known in the art, and need not be described in further detail herein.

C. Processor/Controller

According to some embodiments, the vending machine 210 may include the processor 214 that may be or include any type, quantity, and/or configuration of processor that is or becomes known. The processor 214 may comprise, for example, an Intel® IXP 2800 network processor or an Intel® XEON™ Processor coupled with an Intel® E7501 chipset. In some embodiments, the processor 214 may comprise multiple inter-connected processors, microprocessors, and/or micro-engines. According to some embodiments, the processor 214 may include or be coupled to one or more clocks or timers (not explicitly shown) and to the communication device 216 through which the processor 214 may communicate, in accordance with some embodiments, with other devices such as one or more peripheral devices, one or more servers, and/or one or more user devices (such as the customer device 102 and/or the controller 104, both of FIG. 1). The communication device 216 may, for example, comprise any type or configuration of communication port, cable, modem, and/or signal transceiver that is or becomes known or practicable.

In some embodiments, the processor 214 may also or alternatively be in communication with and/or coupled to any number of other components of the vending machine 210 such as the inventory and dispensing mechanism 218, the payment processing mechanism 220, the input device 222, the output device 224, and/or the data storage device 226.

D. Inventory Storage and Dispensing Device

In some embodiments, the vending machine 210 may comprise the inventory storage and dispensing device 218. The inventory storage and dispensing device 218 may, according to some embodiments, comprise any number and/or configuration of devices and/or components that facilitate and/or are associated with the storage and/or dispensing of products or services available via the vending machine 210. Product inventory storage and product dispensing functions of the vending machine 210 configured in accordance with a snack machine embodiment may include, for example, one or more of: (i) a drive motor, (ii) metal shelves, (iii) a product delivery system (e.g., a chute, product tray, and/or product tray door), (iv) dual spiral (e.g., double helix) item dispensing rods, (v) convertible (e.g., extendable) shelves, and/or (vi) a refrigeration unit. In embodiments using the casing 212 of the “model 129 SnackShop” manufactured by Automatic Products, three (3) removable shelves may be employed, together providing for thirty (30) product rows and an inventory capacity of between one hundred and eighty-five (185) to five hundred and twenty-two (522) commonly vended snack products.

Inventory storage and distribution functions of the vending machine 210 configured in accordance with a beverage machine embodiment may include one or more conventional components, including: (i) metal and/or plastic shelving, (ii) product dispensing actuators/motors, (iii) product delivery chutes, and/or (iv) a refrigeration unit.

In many types of beverage and snack vending machines, operators will typically stock several units of the same product linearly arranged in a column, allowing individual units to be dispensed upon command. The same product may be stocked in more than one column. Similarly, more than one product may be stocked in a single column. In the case that one or more services are available via the vending machine 210, the inventory storage and dispensing device 218 may comprise any device or component that is associated with the storage, transmission, encoding or decoding (e.g., including encryption and decryption), and/or other processing, routing, or electronic delivery or redemption of such services.

Further details concerning vending machine inventory storage and dispensing devices 218 are well known in the art, and need not be described in further detail herein.

E. Payment Processing Device

According to some embodiments, the vending machine 210 may comprise the payment processing device 220. The payment processing device 220 may, according to some embodiments, comprise any number and/or configuration of devices and/or components for receiving payment and/or dispensing change, including a coin acceptor, a bill validator, a card reader (e.g., a magnetic stripe reader), and/or a change dispenser.

In some embodiments, a magnetic stripe card reader may read data on a magnetic stripe of a credit or debit card, for example, and it may cooperate with conventional POS credit card processing equipment to validate card-based purchases through a conventional transaction authorization network. Suitable card-based transaction processing systems and methods are available from USA Technologies, Inc.™ of Wayne, Pa. In some embodiments, a coin acceptor, bill validator and/or change dispenser may communicate with and/or be coupled to a currency storage apparatus (a “hopper”; not shown) and may comprise conventional devices such as models AE-2400, MC5000, TRC200 by Mars, Inc.™ of West Chester, Pennsylvania, or CoinCo™ model 9300-L.

Coin acceptors and/or bill validators may receive and validate currency that is stored by the currency storage apparatus. Further, a bill validator or coin acceptor may be capable of monitoring stored currency and maintaining a running total of the stored currency, as is discussed with reference to U.S. Pat. No. 4,587,984, entitled “Coin Tube Monitor Means”, the payment and coin-related aspects of which are incorporated by reference herein. According to some embodiments, a change dispenser activates the return of coinage to the customer where appropriate (e.g., where a customer rejects or otherwise fails to accept a promotional offer). Such apparatus may feature Multidrop Bus (MDB) and/or Micromech peripheral capabilities, as are known in the art.

In another embodiment, the vending machine 210 may be configured to receive payment authorization and/or product selection commands or signals through a wireless device communication network (e.g., via the communication device 216), directly or indirectly, from a customer device (e.g., a cellular telephone, not shown; the customer device 102 and/or the third party device 104, both of FIG. 1). In such an embodiment, the payment processing device 220 may comprise a cellular transceiver operatively connected to the processor 214 to receive, transmit, and/or process such signals. Systems and methods allowing for the selection of and payment for vending machine products via cellular telephones are provided by USA Technologies, Inc.™. Further, in such an embodiment, a customer cellular telephone may serve as an input device 222 and/or an output device 224, as described elsewhere herein.

Further details concerning vending machine payment processing devices 220 are well known in the art, and need not be described in further detail herein.

F. Input and Output Devices

According to some embodiments, the vending machine 210 may comprise the input device 222 and/or the output device 224. In some embodiments, the input device 222 may be operable to receive input from (i) a customer indicating a product and/or offer selection (e.g., an offer for a benefit such as a free product in exchange for an e-mail address provided by the customer), from (ii) an operator (or agent thereof) during stocking or maintenance of the vending machine 210, and/or from (iii) a customer, controller, and/or third party desiring to establish and/or manage a customer account. Also, the output device may be configured for outputting product and/or offer information (such as subscription and/or package deal information and/or other promotional messages) to a customer, operator, and/or third party.

Many combinations of input devices 222 and output devices 224 may be employed according to various embodiments. In some embodiments, the vending machine 210 may include more than one input device 222. For example, the vending machine 210 may include an exterior input device 222 for receiving customer input and an interior input device 222 (neither shown separately) for receiving operator input. In some embodiments, the input device 222 may provide the dual functionality of receiving input data from both operators and customers (and/or third parties). Likewise, a vending machine may comprise more than one output device 224 (e.g., an LCD screen and several LED devices, as described herein). In some embodiments, such as those which feature touch screens (described elsewhere herein), the functionality of both input devices 222 and output devices 224 may be provided by a single device.

Many input devices 222 are contemplated. Thus, an input device 222 may comprise one or more of the following: (i) a set of alpha-numeric keys for providing input to the vending machine, such as the Programmable Master Menu® Keypad, (ii) a selector dial, (iii) a set of buttons associated with a respective set of item dispensers, (iv) a motion sensor, (v) a barcode reader (e.g., a 1-D or 2-D barcode reader), (vi) a voice recognition module, (vii) a Dual-Tone Multi-Frequency receiver/decoder, (viii) a wireless device (e.g., a cellular receiver; a radio-frequency receiver; an infrared receiver; a wireless access point or wireless router; other wireless devices), (ix) a smart card reader, (x) a magnetic stripe reader, (xi) a biometric identification apparatus (e.g., an iris scanner, a retinal scanner, a facial recognition device, a thumbprint reader, etc.), (xii) a customer device, and/or (xiii) any other type or configuration of input device 222 that may be or become known or practicable.

In some embodiments, an input device 222 may comprise an optical reader (e.g., a 2-D bar code scanner) capable of scanning a barcode, such as a bar code which is displayed on a screen or monitor of a user's cellular phone, PDA, Blackberry® business phone, Blackberry® handheld or other handheld device. One system employing such technology, the Cmode® service, has been developed by a partnership between Coca-Cola® Co. and NTT DoCoMo™ Inc. of Japan. According to some embodiments, the input device 222 may comprise a fingerprint (e.g., and/or thumbprint) reader such as a Fujitsu MBF200 Scanner, which is manufactured by Tacoma Technology, Inc of Taipai, Taiwan and Fujitsu® Microelectronics America, Inc. of Tokyo, Japan. The Fujitsu® MBF200 offers a resolution of five hundred dots per inch (500 dpi), an image capture area of 12.8×15 mm (0.5″×0.6″), and a unit size of 60×40×15 mm (2.4″×1.6″×0.6″). The Fujitsu® MBF200 may communicate with a vending machine processor 214 through any practicable interface such as a USB interface. The Fujitsu® MBF200 may be desirable in an embodiment where the vending machine processor 214 is instructed through a Linux-based operating system. In embodiments featuring the Fujitsu® MBF200, fingerprint-matching software may be employed. Exemplary fingerprint matching software may include, for example, VeriFinger™ 4.2 from Neurotechnologija, Ltd. of Vilnius, Lithuania.

In some embodiments, a suitable fingerprint reader for use as an input device 222 may include the AF-S2 FingerLoc™ from AuthenTec®), Inc. of Melbourne, Fla. The AF-S2 FingerLoc™ offers a resolution of two hundred and fifty dots per inch (250 dpi), an image capture area of 13×13 mm (0.51″×0.51″), and a unit size of 24×24×3.5 mm (0.94″×0.94″×0.14″). The AF-S2 FingerLoc™ may communicate with a vending machine processor through any practicable interface such as a USB interface. The AF-S2 FingerLoc™ may be desirable in an embodiment where the vending machine processor 214 is instructed through a Microsoft® Windows®-based operating system. In embodiments featuring the AF-S2 FingerLoc™, fingerprint matching software may be employed. Exemplary fingerprint matching software may include, for example, VeriFinger™ 4.2 from Neurotechnologija, Ltd. of Vilnius, Lithuania.

Likewise, many types of output devices 224 are contemplated. For example, an output device may comprise an LCD screen or device. Alternatively or additionally, the output device 224 may comprise one or more LED displays or devices (e.g., several alphanumeric multi-color or single color LED displays on the shelves of a vending machine associated proximately with each row of product inventory).

In one embodiment, an LED display screen is mounted atop and/or on the vending machine (via bolts or other mounting hardware) and is used to communicate offers and other messages (e.g., product advertisements, such as package deals and/or subscription offers or promotions) to prospective customers. A suitable LED display screen for such an embodiment may be housed in an aluminum case having a length of approximately twenty-seven and one half inches (27.5″/698.5 mm), a height of approximately four and one quarter inches (4.25″/107.95 mm), and a depth of approximately one and three quarter inches (1.75″/44.5 mm). Such a display screen may have a display area capable of showing about thirteen (13) alphanumeric and/or graphical characters. Further, such an LED display screen may comprise a serial computer interface, such as an RJ45/RS232 connector, for communicating with the processor 214. Further still, such an LED display may be capable of outputting text and graphics in several colors (e.g., red, yellow, green, black) regarding current and upcoming promotions.

Further, in some embodiments, the output device 224 may comprise a printer. In one embodiment, a printer may be configured to print on card stock paper of approximately one hundredth of an inch or less (e.g., 0.01″/0.15 mm or less) in thickness, such as the EPSON EU-T400 Series Kiosk Printer. Further, a printer may be capable of thermal line printing of various alphanumeric and graphical symbols in various font sizes (e.g., ranging from nine (9) to twenty-four (24) point) on various types of paper. Additionally, such a printer may communicate with the processor 114 via an RS232/IEEE 12834 and/or bidirectional parallel connection. Such a printer may further comprise a data buffer of various practicable sizes, such as approximately four kilobytes (4 KB). In some embodiments, the printer may be operable to output codes and/or identifiers (e.g., by printing vouchers) to customers and/or to print stickers, labels, and/or other indications to be attached to products vended by the vending machine 210. The output device 224 may also comprise a device operable to attach and/or print indications of access codes onto one or more products of the vending machine 210 (e.g., as the products are loaded by an operator, while the products are shelved within the vending machine 210, and/or as the products are dispensed—such as a hopper printing and/or coupling mechanism). According to some embodiments, the output device 224 may also or alternatively comprise an audio module, such as an audio speaker, that outputs information to customers audibly.

As stated, in some embodiments, a touch-sensitive screen may be employed to perform both input device 222 and output device 224 functions. Suitable, commercially available touch screens for use according to various embodiments are manufactured by Elo TouchSystems, Inc., of Fremont, Calif., such as Elo's AccuTouch series touch screens. Such touch screens may comprise: (i) a first (e.g., outer-most) hard-surface screen layer coated with an anti-glare finish, (ii) a second screen layer coated with a transparent-conductive coating, and/or (iii) a third screen layer comprising a glass substrate with a uniform-conductive coating. Further, such touch screens may be configured to detect input within a determined positional accuracy, such as a standard deviation of error less than plus or minus eight hundredths of an inch (±0.08″/2 mm). The sensitivity resolution of such touch screens may be more than one hundred thousand touchpoints per square inch (100,000 touchpoints/in²/15,500 touchpoints/cm²) for a thirteen inch (13″) touch screen. For such touch screens, the touch activation force required to trigger an input signal to the processor 214 via the touch screen may typically be around two to four ounces (2-4 ounces/57-113 g). Additionally, touch screens for use according to various embodiments may be resistant to environmental stressors such as water, humidity, chemicals, electrostatic energy, and the like. These and other operational details of touch screens (e.g., drive current, signal current, capacitance, open circuit resistance, and closed circuit resistance) are well known in the art and need not be described further herein.

In some embodiments, input and/or output functionality of the vending machine 210 may be facilitated through a wireless device configured to send data to, and/or receive data from, a customer device (e.g., the customer device 102 of FIG. 1), such as a laptop computer or a cellular telephone. In some embodiments, such a wireless device may comprise a sensor that detects signals from a customer device. Such signals may include but are not limited to radio frequency signals and/or IR signals. Thus, in one or more embodiments, a wireless input device 222 may comprise a WAP or router configured to operate in accordance with an IEEE 802.11 standard, including the 802.11b and 802.1g standards, which transmit at 2.4 GHz, or the 802.11a standard, which transmits at 5 GHz. Such a wireless input device 222 may, in some embodiments, have the capability to “frequency hop” between radio frequencies so as to reduce interference and/or increase security. Encryption techniques may also or alternatively be employed to increase the security of transmissions. Suitable WAPs are available from Belkin™ Corporation of Compton, Calif. and Cisco™ Systems, Inc. of San Jose, Calif. The wireless input device 222 may, in some embodiments, be used to establish a communication link (such as a first communication link with a customer device) as described herein.

Additionally, in some embodiments, an output device 224 may comprise an audio module, such as an audio speaker, that outputs information to customers audibly. Speakers may comprise conventional speakers and/or modern hypersonic speakers. An output device 224 may include, for example, unidirectional and/or hypersonic speakers which can selectively focus sound to particular locations or customers, while not disturbing others who are not in the location of the focused sound.

For a description of such speakers, see Suzanne Kantra Kirschner, “We've heard hypersonic sound. It could change everything”, Popular Science, available at http://www.popsci.com/popsci/science/article/0,12543,351353,00.html, the unidirectional and/or hypersonic speaker concepts and descriptions of which are hereby incorporated by reference herein.

In some embodiments, the output device 224 may comprise a physical device having a game theme, such as a spinning “prize wheel” similar to those featured on the television game show Wheel of Fortune™ or The Price is Right™, a roulette wheel, mechanical slot machine reels, or the like. Such a wheel may communicate to customers various information. For example, the wheel may spin and stop on an icon that represents, e.g., a prize entitlement. A physical wheel in the general appearance of the wheel on the Wheel of Fortune™ game show may be attached to a vending machine.

Also or in addition to a wheel, another output device 224 that is a peripheral device attached to and in communication with the vending machine 210 may communicate game-related information. By utilizing such an output device 224, vending machines 210 may be retrofitted with a separate device to employ game-themed promotions. The use of removable peripheral devices may be important in certain situations (e.g., where doorways to interior locations are low), as such satellite devices may be removed during transport and attached once vending machines are brought to the intended location. Likewise, such peripheral devices may be side-mounted, where the ceiling height may impair other location of the peripheral. Further, the use of a separate device is advantageous in that it may be in communication with more than one vending machine 210, allowing many vending machines 210 to participate in game-themed vending promotions.

G. Data Storage/Memory

The data storage device 226 may include any appropriate combination of magnetic, optical and/or semiconductor memory, and may include, for example, additional processors, communication ports, RAM, Read-Only Memory (ROM), a compact disc and/or a hard disk. The processor 214 and the storage device 226 may each be, for example: (i) located entirely within a single computer or other computing device; or (ii) connected to each other by a remote communication medium, such as a serial port cable, a Local Area Network (LAN), a telephone line, RF transceiver, a fiber optic connection and/or the like. In some embodiments for example, the vending machine 210 may comprise one or more computers (or processors 214) that are connected to a remote server computer (e.g., via the communication device 216) operative to maintain databases, where the data storage device 226 is comprised of the combination of the remote server computer and the associated databases.

The data storage device 226 may generally store one or more programs 228 for controlling the processor 214. The processor 214 may perform instructions of the program 228, for example, and thereby operate in accordance with some embodiments, and particularly in accordance with the methods described in detail herein. According to some embodiments, the program 228 may comprise any number or type of programs that are or becomes known or practicable. In some embodiments, the program 228 may be developed using an object oriented programming language that allows the modeling of complex systems with modular objects to create abstractions that are representative of real world, physical objects and their interrelationships. However, it would be understood by one of ordinary skill in the art that the embodiments described herein can be implemented in many different ways using a wide range of programming techniques as well as general purpose hardware systems or dedicated controllers.

The program 228 may be stored in a compressed, un-compiled and/or encrypted format. The program 228 furthermore may include program elements that may be generally useful, such as an operating system, a database management system and/or device drivers for allowing the processor 214 to interface with computer peripheral devices and/or the various components of the vending machine 210. Appropriate general purpose program elements are known to those skilled in the art, and need not be described in detail herein.

Further, the program 228 may be operative to execute a number of invention-specific objects, modules and/or subroutines which may include (but are not limited to) one or more subroutines to determine whether a promotion should be output; one or more subroutines to determine a promotion type; one or more subroutines to populate a promotion type (such as a subscription offer or promotion), thereby constructing a promotion instance; one or more subroutines to select a constructed promotion instance from a plurality of hypothetical promotion instances; one or more subroutines to determine an expected value of a promotion being considered for output; one or more subroutines to determine how and/or when products should be dispensed from the vending machine 210; one or more subroutines to determine and/or provide codes redeemable for products; one or more subroutines to provide management access to customer accounts (e.g., to customers and/or third parties); one or more subroutines to provide and/or facilitate the sale and/or management of customer accounts; and/or one or more subroutines to determine and/or transmit promotional messages (e.g., via e-mail) to customers. Examples of some of these subroutines and their operation are detailed with respect to the processes described herein.

The program 228 may also or alternatively direct the processor 214 (possibly in conjunction with one or more peripherals or other devices) to operate with “preprogrammed intelligence”, such as “Artificial Intelligence” (AI). Among possible intelligent abilities attributed to a vending machine 210 may be the ability to recognize people by voice or image, the ability to understand spoken language, the ability to understand written language, the ability to synthesize spoken language, the ability to compose text, the ability to compose motivational text (such as promotional messages advertising products available at the vending machine), the ability to recognize patterns in human purchasing behavior, the ability to sense external “foot traffic” (i.e., people passing by), and the ability to transmit messages to a targeted group of people on a network (e.g., e-mail transmitted messages to particular customers).

According to some embodiments, the instructions of the program 228 may be read into a main memory (not explicitly shown) of the processor 214 from another computer-readable medium (such as the data storage device 226), like from a ROM to a RAM. Execution of sequences of the instructions in the program 228 may cause the processor 214 to perform the process steps described herein. In alternative embodiments, hard-wired circuitry or integrated circuits may be used in place of, or in combination with, software instructions for implementation of the processes described herein. Thus, some embodiments are not limited to any specific combination of hardware, firmware, and/or software.

In addition to the program 228, the data storage device 226 may also be operative to store one or more databases, files, and/or tables, containing information such as (i) product inventory data 230, (ii) dispensing data 232, (iii) coin inventory data 234, (iv) transaction history data 236, (v) promotion history data 238, (vi) promotional message data 240, (vii) promotional code data 242, and/or (viii) customer data 244 (e.g., which may include account data such as one or more e-mail addresses associated with a customer). Any number of other arrangements may be employed besides those suggested by the tables shown. For example, even though eight separate data tables, stores, files, and/or databases are illustrated, embodiments may be practiced effectively using fewer or more functionally equivalent databases or similar structures. These databases and/or other databases (not shown) may also or alternatively store information associated specifically with customer accounts and/or information useful in the management thereof. Product redemption codes and/or identifiers, account rules or parameters, account transaction history data, third party data, and/or other metrics may, for example, be stored to facilitate the providing and/or management of customer accounts via the vending machine 210.

Further, despite the depiction of the data as tables, an object-based model could be used to store and manipulate the data types and likewise, object methods or behaviors can be used to implement the processes described herein.

H. Vending Machine Retrofitting

In some embodiments, one or more of the processor 214, the input device 222, the output device 224, and the data storage device 226 may be included, wholly or partially, in a separate device (e.g., separate from and/or external to the casing 212; not shown), such as the e-Port™ by USA Technologies Inc., that may be in communication with the vending machine 210. The separate devices may also or alternatively be in communication with a network such as the Internet (e.g., via the communication device 216).

The e-Port™ is a credit and smart card-accepting unit that controls access to office and MDB vending equipment, and serves as a point of purchase credit card transaction device. The e-Port™ includes an LCD that allows for the display of color graphics, and a touch sensitive input device (touch screen) that allows users to input data to the device. The display may be used to prompt users interactively with, e.g., offers and information about their transaction status.

The separate device may alternatively be a programmed computer running appropriate software for performing various functions described herein. The separate device may be operable to receive input from customers, receive input from third parties, receive payment from customers, exchange information with a remotely located server (e.g., an ISP server, a VoIP service provider's server) and/or display or transmit messages to customers (e.g., promotional messages and/or offers). The separate device may be operable to instruct the vending machine that appropriate payment has been received (e.g., via a credit card read by the separate device), that a particular product or products should be dispensed by the vending machine, and/or how and/or when those products should be dispensed (e.g., to avoid product collisions and/or other complications). Further, a separate device may be operable to instruct the vending machine to execute and/or offer customer accounts, promotional messages, price changes, or the like.

Thus, a separate device may be operatively connected to a vending machine 210 to perform various processes and steps described herein including the offering of a benefit in exchange for a customer's e-mail address, as well as transmitting promotional messages to the customer's e-mail address. In this manner, conventional vending machines may be retrofitted with such separate devices so as to perform the processes described herein.

I. Other Separate Devices

It should be noted that, in some embodiments, some or all of the functions and method steps described herein may be performed partially or entirely by one or more separate devices (not explicitly shown), which are not necessarily retrofitted to a vending machine 210. Separate devices for use with such an embodiment include, but are not limited to, kiosks and customer devices (PDA devices, laptop computers, and cellular telephones). In some embodiments featuring separate devices, such devices may be capable of communicating, directly (e.g., via Bluetoot® connectivity) or indirectly (e.g., through a web server or IVRU), to a vending machine control system in order to facilitate the inventive functionality described herein. In some embodiments featuring separate devices, such separate devices are capable of communicating with a remote computer.

### J. Network Embodiments

Network environments may include a remotely located device or computer (e.g., a server, mainframe, or other device) that is in communication, via a communications network (such as the network 106 of FIG. 1), with one or more vending machines 210 and/or customer devices. Such a configuration may facilitate third party management of customer accounts and/or transmission of promotional e-mail messages as described herein.

The remote device or computer may communicate with the vending machines 210, customer devices, and/or third party devices, and the vending machines 210 may communicate with each other, directly or indirectly, via a wide variety of wired and/or wireless means, mediums, protocols and communications standards. Some, but not all, possible communication links and networks that may comprise the network or be otherwise part of the system include but are not limited to: PSTN links, satellite links, cellular links, optical links, infrared links, radio frequency links, and/or Cable TV links. Various networking configurations, standards and protocols may be employed, including but not limited to: IP addressing via the Internet, a local area network (LAN), a wireless LAN, a wide area network (WAN), Ethernet (or IEEE 802.3), Token Ring, SAP, ATP, Bluetooth™, TCP/IP and/or via any appropriate combination thereof. Communication may be encrypted to ensure privacy and prevent fraud in any of a variety of ways well known in the art.

Vending machines 210 may comprise computers, such as those based on the Intel® Pentium® or Centrino™ processor, that are adapted to communicate with the remote device or computer. Any number and type of machines may be in communication with the remote device or computer.

Those skilled in the art will understand that vending machines 210, devices and/or computers in communication with each other need not be continually transmitting to each other. On the contrary, such vending machines, devices and/or computers need only transmit to each other as necessary, and may actually refrain from exchanging data most of the time. For example, a vending machine in communication with another machine via the Internet may not transmit data to the other machine for weeks at a time.

In some embodiments, the remote device or computer may be accessible, directly or indirectly, via a separate device (such as a customer device and/or third party device) by a customer, operator, and/or third party. Accordingly, a customer, operator, and/or third party may use a device to communicate with the remote computer. A separate device may receive from the remote computer messages described herein as being output by the vending machine 210 (e.g., subscription codes), and/or may transmit to the remote computer input described herein as being provided to the vending machine 210 (e.g., e-mail addresses). Thus, various data described herein as received through an input device of a vending machine 210 may be received by the vending machine 210 from a separate device (e.g., through a Bluetooth® connection) or from a remote computer (which may relay data first received from a customer device such as a personal computer). Similarly, various data described herein as received through an input device 222 of a vending machine 210 may be received through a Web browser communicating with a remote server, which in turn communicates with the vending machine 210.

K. External Appearance

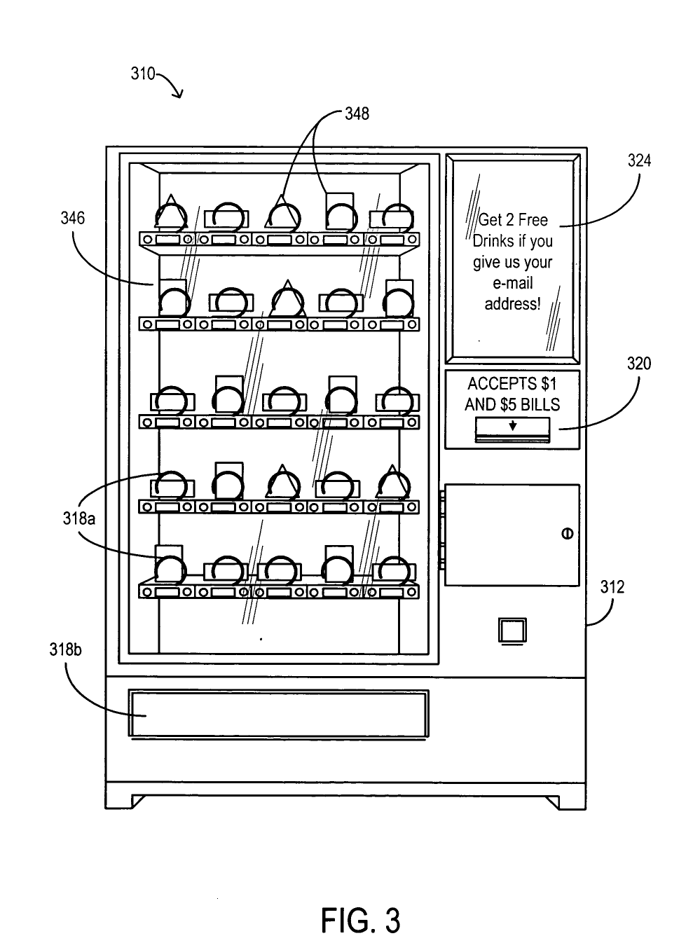

Referring to FIG. 3, a diagram illustrating an example of the external appearance of a vending machine 310 according to some embodiments is shown. In some embodiments, the exemplary vending machine 310 may be similar in configuration and/or functionality to the vending machines 110, 210 described in conjunction with any of FIG. 1 and/or FIG. 2. The exemplary vending machine 310 may comprise, for example, (i) a cabinet 312, (ii) an inventory dispensing mechanism 318a-b (comprising a product storage mechanism 318a and/or a product hopper 318b), (iii) a payment processing mechanism 320, (iii) an output device 324 (e.g., for outputting text and/or graphical information about promotions such as offers for free products in exchange for a customer's e-mail address, and/or for facilitating customer account management), and (iv) a product display window 346 behind which are visible the products 348 available for sale from the vending machine 310 and the product storage mechanism 318a that holds the products within the vending machine 310. According to some embodiments, the components 312, 318, 320, 324, 346 of the vending machine 310 may be similar in configuration and/or functionality to the similarly named and/or numbered components described in conjunction with FIG. 2 herein.

The casing 312 may, fore example, comprise any type or configuration of cabinetry or enclosure to at least partially house components of the vending machine 310. As described elsewhere herein, for example, the casing 312 may be constructed of steel, aluminum, plastic, rubber, other metals or composite materials, and/or any combinations thereof. In some embodiments, the casing 312 may be configured for the sale of various products or services such as a typical and/or modified version of a typical snack, beverage, dessert, meal, non-edible object, media, and/or any other vending machine 310. According to some embodiments, the inventory dispensing mechanism 318a-b may comprise various component such as the product storage mechanism 318a and/or the product hopper 318b). The product storage mechanism 318a may, for example, comprise a number of latches, levers, paddles, doors, spirals, and/or other product retention, detention, and/or dispensing mechanisms, as are known in the art.

According to some embodiments, a product selected and/or purchased by a customer may be released by the product storage mechanism 318a so that it falls into the product hopper 318b. The product hopper 318b may, according to some embodiments, comprise one or more doors, holes, and/or other means via which a customer may retrieve a dispensed product. The product hopper 318b may also or alternatively comprise one or more components to facilitate prevention of unauthorized product removal (e.g., from someone reaching up into the vending machine 310 via the product hopper 318b) and/or to facilitate the reduction of impact forces experienced by products dropping from the product storage mechanism 318b above.

In some embodiments, the payment processing mechanism 320 may comprise any practicable type of payment receiving, transmitting, and/or processing device that is or becomes known (such as those described elsewhere herein). The payment processing mechanism 320 may, for example, comprise a currency validator and/or input slot, such as shown in FIG. 3. According to some embodiments, the output device 324 may display various information associated with offers and/or promotions and/or product or service sales to a customer. As shown in FIG. 3, for example, the output device 324 may comprise a display screen (and/or touch screen) that advertises the option of receiving two (2) free products in exchange for a customer's e-mail address. The particular offer shown in FIG. 3, for example, allows a customer to provide an e-mail address to the vending machine 310 to receive two (2) free drink units. In accordance with some embodiments, one or more of the free products or product units may comprise a “mystery” product selected by the vending machine 310, such as to manage inventory and/or sales. Such “mystery” units or products may, according to some embodiments, be provided as part of and/or in addition to the e-mail address promotion. Various mystery and mystery package embodiments are described in Applicant's co-pending U.S. application Ser. No. 11/282,525, entitled “SYSTEMS AND METHODS FOR VENDING PROMOTIONS” and filed on Nov. 18, 2005, the mystery product and mystery package concepts of which are hereby incorporated by reference herein.

L. Software Architecture

In some embodiments, a control system may execute instructions for managing the operation of a vending machine (such as the vending machines 110, 210, 310 of FIG. 1, FIG. 2, and FIG. 3, respectively), and in particular in accordance with various embodiments described herein. Such vending machine functions include, but are not limited to: (1) product pricing (e.g., displaying prices via an LED and/or changing such prices where appropriate), (2) processing vending transactions by (i) receiving customer selections via an input device (such as product and/or offer selections), (ii) processing payment via a payment processing mechanism, (iii) actuating corresponding product dispensing mechanisms, (3) selecting promotional messages or promotion types and constructing promotion offer instances, (4) outputting promotional messages and/or offers to customers via output devices (including display of graphics/content, such as game-themed content, on LCD and LED displays), (5) recording transaction information (inventory levels, acceptance rates for promotions, etc.), (6) facilitating customer and/or third party account management, (7) receiving customer e-mail addresses, (8) transmitting promotional messages to the customer e-mail addresses, (9) receiving redemption codes, and/or (10) automatically recharging a funded account by utilizing a customer credit card.

In some embodiments, machine components (e.g., machine hardware, including mechanical hardware such as input devices, output devices, product dispensing devices, and payment processing devices including coin acceptors, bill validators, card readers, and/or change dispensers) may be controlled by the control system through a standard RS-232 serial interface. In such embodiments, embedded Application Programming Interface (API) devices or modules may be used to enable software to actuate and/or control vending machine components via RS-232 connectivity. Such vending machine components may be operatively connected to the control system directly or indirectly, in any manner that is practicable. Alternatively, machine components may communicate with the control system through a USB standard (e.g., USB ports may allow “plug-and-play” installation of machine components).

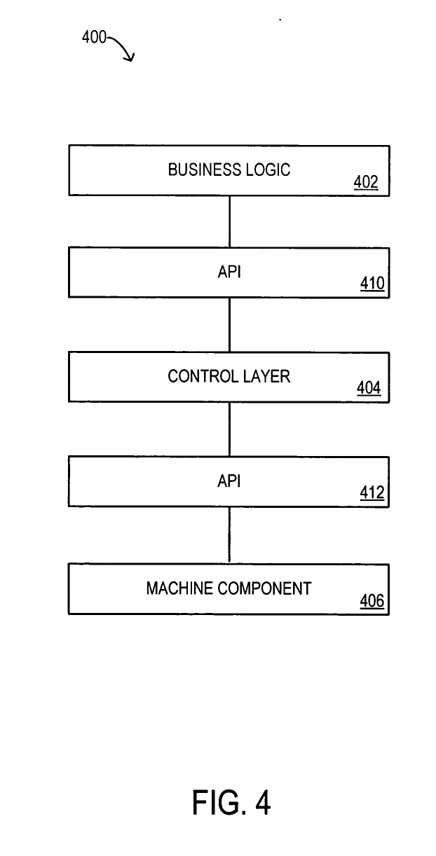

Referring now to FIG. 4, a block diagram of a system 400 according to some embodiments, is shown. The system 400 may, for example, comprise and/or represent an exemplary portion of control software that may be utilized to implement some embodiments. The system 400 illustrates, for example, control software as being divided into three abstract components. Such division may provide a clear partition of tasks, which may be desirable so that any future modification and new programming can be applied without disrupting other components. The three abstract components illustrated include a Business Logic software component 402, a Control Layer software component 404, and an exemplary Machine Components software component 406. As stated earlier, more machine components may be employed in addition to the exemplary one illustrated herein.

The software components are each connected to one another via a respective API 410, 412. As is known in the art, an API 40, 412 may comprise a set of routines, protocols, and/or tools for building software applications. The Business Logic software component 402 may, according to some embodiments, be connected to the Control Layer software component 404 via an API 410. Similarly, the Control Layer software component 404 may be connected to the Machine Component software component 406 via another API 412.

The Business Logic software component 402 visually represents the portion of the software that selects promotions or promotion type instances and/or constructs promotion instances and/or promotional messages, as discussed herein. Such a component may, for example, access a rules database and a product inventory database to perform such functions.

The Control Layer software component 404 visually represents the portion of the software which interfaces with at least one Machine Component software component 406, and thereby transmits commands to perform such functions as: (i) outputting e-mail-for-benefit offer information via an output device (e.g., a machine component), (ii) dispensing products via a product dispensing mechanism (e.g., a machine component), (iii) dispensing change due to a customer via a payment processing mechanism, which may include a change dispenser and a currency storage apparatus (e.g., several machine components), and/or (iv) transmitting promotional messages to customer e-mail addresses.

The Machine Component software component 406 generally represents software or machine hardware, including mechanical hardware such as input devices, output devices, inventory dispensing devices, and payment processing devices including coin acceptors, bill validators, card readers, change dispensers, etc.

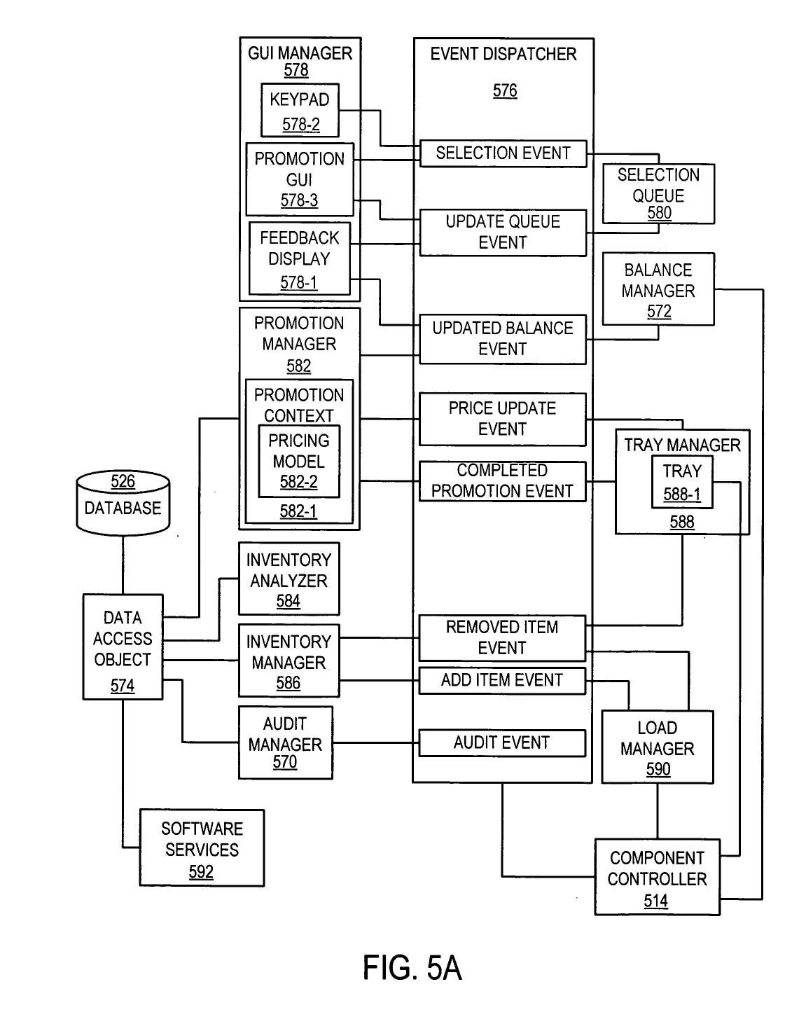

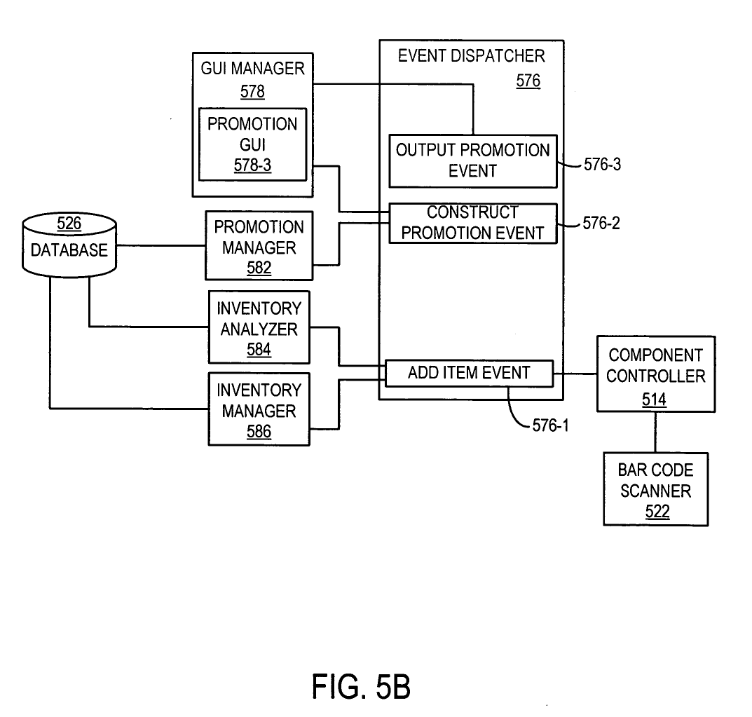

Referring now to FIG. 5A, a schematic block diagram of an exemplary configuration of software architecture 500 according to some embodiments is shown. It should be noted, however, that many architectural configurations are possible to carry out the inventive processes described herein. The software architecture 500 is a model of a software application for use in execution of embodiments described herein, designed using Unified Modeling Language™ (UML™). The model comprises various software components and illustrates how the various software components may interact with one another.

According to some embodiments, the software architecture 500 may comprise a component controller 514 and/or a database 526. The component controller 514 may manage (and mask the implementation of) vending machine components. Examples of vending machine components include: input devices, output devices, coin acceptors, bill validators, card readers, change dispensers, product dispensing mechanisms, and bar code readers. In some embodiments, the component controller 514 may be similar in configuration and/or functionality to the processor 214 described in conjunction with FIG. 2. The database 526 may comprise a persistence store (e.g., MySQL, file based, and/or Oracle®). The database 526 may, for example, be similar in configuration and/or functionality to the data storage device 226 described in conjunction with FIG. 2.

In some embodiments, an audit manager 570 listens for audit events fired by other management components and acts on them by persisting meaningful state about the event to audit data structures. This function journals all significant events, transactions, and other meaningful system operations so that they can be used in subsequent analysis and reporting functions. The definition of “meaningful state” can potentially be specified through configuration management. The event/configuration driven approach provides flexibility if auditing/reporting requirements change.

According to some embodiments, a balance manager 572 represents the current monetary balance in the machine. It interacts with the component controller 514 and responds to money insertion by incrementing its balance value. It fires UpdatedBalance events whenever the balance changes. It listens for DrainBalance events and executes processes of the component controller 514 that return funds to the user.

In some embodiments, a data access object 574 may be the layer of abstraction that is responsible for persisting domain objects such as inventory objects and audit data. The data access object 574 may, for example, be in communication with the database 526 and/or one or more other data stores (not shown).

According to some embodiments, an event dispatcher 576 acts as a proxy broker for events so that components do not need to explicitly listen to each other (e.g., have undue knowledge of each other by reference). Some examples of events that may be managed by this component, and that are shown in FIG. 5A, include: a SelectionEvent event, an UpdatedQueueEvent event, an UpdatedBalanceEvent event, a TrayLEDUpdateEvent event, a CompletedPromotionEvent event, a DispensedItemEvent event, an AuditEvent event, and/or an EnterOperatorModeEvent event.

In some embodiments, a Graphical User Interface (GUI) manager 578 is a container for all GUI components and/or sub-components and defines their layout in reference to one another. The GUI manager 578 will also listen for events from the event dispatcher 576. Swing events may be handled by the individual sub-components 578-1, 578-2, 578-3 of the GUI manager 578. According to some embodiments, the sub-components may comprise a feedback display 578-1, a keypad 578-2, and/or a promotion GUI 578-3. The feedback display 578-1 is a sub-component that manages feedback from the keypad 578-2, instructions, and error messages.

The keypad 578-2 is a sub-component that represents the keypad data entry interface (rendered as Swing graphical objects on a touch screen LCD). It forces selection events to be fired that are relevant to the feedback display 578-1 and a selection queue 580.

The promotion GUI 578-3 is a sub-component that represents promotion-related user interface rendering such as graphical selection menus, banners, animation, etc. The promotion GUI 578-2 fires events that can affect the selection queue 580 and listens for events from a promotion manager 582. The selection queue 580 is a container for cumulative product selections made during the course of user interaction with a promotional offer and/or promotion. The promotion manager 582 manages the entire promotional offer and/or promotion-related business rules in play in a vending machine. It can manage multiple promotional offer and/or promotion contexts simultaneously and executes all rules related to validation, execution, and workflow related to these subscription offer or promotion contexts. This component implements a promotional offer or promotion context factory object that encapsulates business rule logic related to promotional offer and/or promotion eligibility, selection, pricing and composition.

In some embodiments, the promotion manager 582 may comprise, define, and/or manage one or more components such as a promotion context 582-1 and/or a pricing model 582-2. The promotion context 582-1 may comprise all of the state and workflow rules required by the promotion manager 582 to execute a given promotional offer and/or promotion. The pricing model 582-2 may, according to some embodiments, be a sub-component of the promotion context 582-1. The pricing model 582-2 may, for example, contain all the product pricing data needed to execute the promotional offer and/or promotion described by that context.

According to some embodiments, an inventory analyzer 584 performs derivation and aggregation computations on inventory state and audit data. The results of these computations are persisted for use by other components (e.g., the promotion manager 582). The computation functions may be initiated on demand or by a scheduler service when the system is dormant.

In some embodiments, an inventory manager 586 maintains the current state of the machine's inventory. It listens for events that will ask it to update the inventory that was fired by components such as a tray manager 588 and a load manager 590. The tray manager 588 is the container and manager of composite tray components. It is responsible for initiating and coordinating multiple-product dispense operations. According to some embodiments, the tray manager 588 may be a module and/or device that operates and/or manages a tray 588-1. The tray 588-1 may, for example, be a sub-component of the tray manager 588 and/or may represents a product dispensing apparatus and its composite rows/slots in the vending machine. Its responsibilities include dispensing products and displaying LED data through the component controller 514.

According to some embodiments, a load manager 590 manages the inventory load processes. It may interact with a bar code scanner via the component controller 514, such as when an operator restocks the machine's inventory. The load manager 590 may also or alternatively fire inventory change events. Examples of load processors and/or devices are described in commonly owned and co-pending U.S. patent application Ser. No. 10/951,296 entitled “METHODS AND APPARATUS FOR DEFINING AND UTILIZING PRODUCT LOCATION IN A VENDING MACHINE” and filed on Sep. 27, 2004, the load management concepts and descriptions of which are incorporated by reference herein.

In some embodiments, a software service 592 may provide miscellaneous application services, including (but not limited to): account management, configuration management, connection pooling, diagnostic logging, and/or scheduling services.

Referring now to FIG. 5B, a schematic block diagram of another exemplary configuration of the software architecture 500 according to some embodiments is shown. The configuration of the software architecture 500 shown in FIG. 5B is a model of a software application for use in some embodiments, designed using UML™. The software architecture 500 may comprise various software components and one or more hardware components. For example, the software architecture 500 may comprise a component controller 514, a barcode scanner 522, a database 526, an event dispatcher 576, a GUI manager 578, a promotion manager 582, an inventory analyzer 584, and/or an inventory manager 586. According to some embodiments, the components 514, 520, 526, 576, 578, 582, 584, 586 of the software architecture 500 may be similar to the similarly named and/or numbered components described in conjunction with any of FIG. 1 and/or FIG. 5A herein.

In some embodiments, the event dispatcher 576 may include and/or define three (or more) exemplary events. The events may comprise, for example, an AddItem event 576-1, a ConstructPromotion event 576-2, and/or an OutputPromotion event 576-3. According to some embodiments, some or all of the events 576-1, 576-2, 576-3 may be triggered by an addition of a product to a vending machine.

As shown in FIG. 5B, the component controller 514 may be in communication with a particular vending machine component such as the bar code scanner 522. In some embodiments, the bar code scanner 522 may be similar in configuration and/or functionality to the input device 122 described in conjunction with FIG. 1. The bar code scanner 522 may, for example, be a particular type of input device 122 (i.e., one that is operable to scan barcodes). In some embodiments, the component controller 514 may be in communication with fewer or more components (such as input devices 122 and/or output devices 124) than are shown in FIG. 5B.

In some embodiments, when an operator of the vending machine adds a product to the inventory of the vending machine, the operator may scan a bar code of the product (e.g., using the bar code scanner 522). The component controller 514 communicates the input of the bar code scanner 522 to the event dispatcher 576, which recognizes the input of the bar code scanner 522 as an AddItem event 576-1. As described above, the event dispatcher 576 may act as a proxy broker for events, alleviating the need for components to listen for events from other components. Thus, the event dispatcher 576 may communicate the AddItem event 576-1 to the inventory manager 586, without the need for inventory manager 582 to listen for events from the component controller 514. The inventory manager 582, in turn, may cause a record of the added item and/or of the AddItem event 576-1 to be stored in the database 526 (e.g., via the data access object 574 from FIG. 5A, which is not illustrated in FIG. 5B for purposes of simplicity).

The inventory analyzer 584, in turn, may analyze the current inventory (e.g., based on the addition of the product or based on another event, such as the occurrence of a predetermined time) and store an indication of a need for a promotional offer and/or promotion for two (2) or more products based on the current state of the inventory. The indication may be stored in database 526. The promotion manager 582 may, according to some embodiments, access the database 526 and determine the need for a promotional offer and/or promotion. The promotion manager 582 may then, for example, construct a promotional offer and/or promotion, based on the need. The event dispatcher 576 may determine the occurrence of the ConstructPromotion event 576-2 and communicate the occurrence of this event to the GUI manager 578. The GUI manager 578 may, in turn, cause the promotional offer to be displayed via a promotion GUI 578-1 sub-component. The promotion GUI sub-component 578-1 and/or the GUI manager 578 may then, for example, construct the OutputPromotion event 576-3. The event dispatcher 576 may, according to some embodiments, detect the OutputPromotion event 576-3 and communicate the occurrence of this event to another component (e.g., promotion manager 582) and thus, indirectly, cause a record of the output of the promotional offer to be stored in the database 526.

### IV. Databases

As indicated above, it should be noted that although the example embodiments generally depict five (5) particular databases stored in storage devices 226, 526, other database arrangements may be used which would still be in keeping with the spirit and scope of the present disclosure. In other words, some embodiments may be implemented using any number of different database files or data structures, as opposed to the five (5) databases depicted generally herein. Further, the individual database files may be stored on different servers (e.g., located on different storage devices in different geographic locations, such as on a controller 104). Likewise, the programs 228 may also or alternatively be located remotely from the storage devices 226, 526 and/or on another server. As indicated, the programs 228 generally include instructions for retrieving, manipulating, and storing data in the databases 230, 232, 234, 236, 238, 240, 242, 244 as necessary to perform the methods described herein.

A. Customer Database

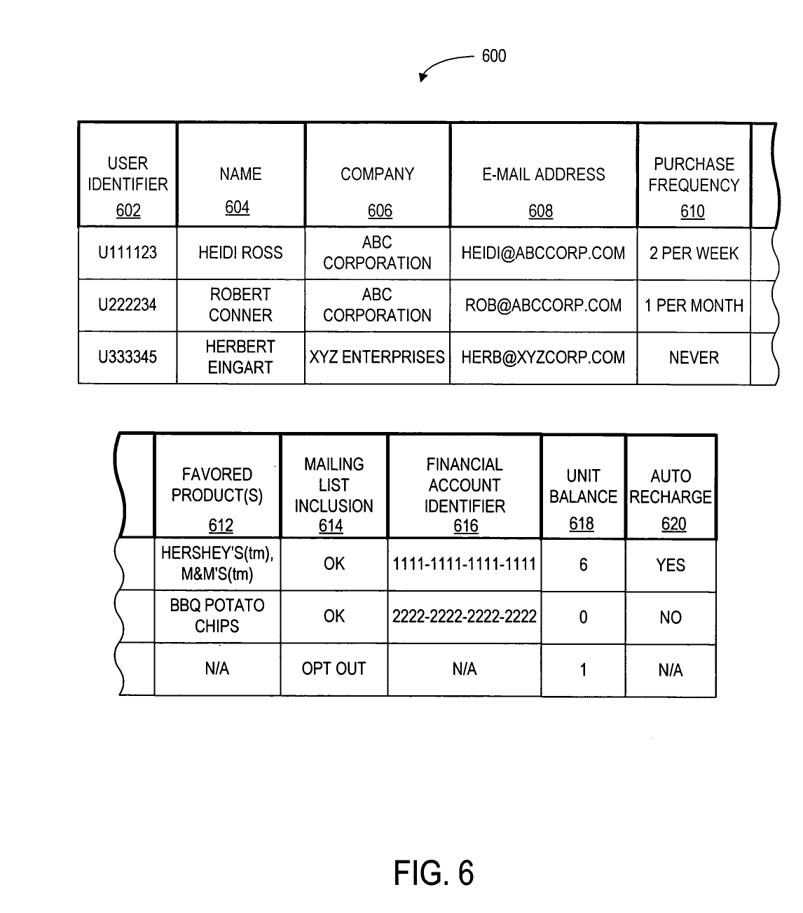

Turning to FIG. 6, a tabular representation of an embodiment of a customer database 600 (e.g., the customer data database 244 of FIG. 2) according to some embodiments is illustrated. This particular tabular representation of a customer database 600 includes sample records or entries which each include information regarding a particular customer. In some embodiments, the customer database 600 may be used to store information associated with customers and/or customer accounts associated with a vending machine. Those skilled in the art will understand that such a customer database 600 may include any number of entries or fields, instead of and/or in addition to those shown in FIG. 6.

The particular tabular representation of the customer database 600 depicted in FIG. 6 includes ten (10) fields for each of the entries or records. The fields may include: (i) a user identifier field 602 that stores a representation uniquely identifying the user; (ii) a name field 604 that stores a representation of the user's name; (iii) a company field 606 that stores a representation a company associated with the customer (e.g., the customer's employer); (iv) an e-mail address field 608 that stores a representation of an e-mail address associated with the customer; (v) a purchase frequency field 610 that stores a representation of how often the customer has historically made purchases via the vending machine and/or vending machine network; (vi) a favored products field 612 that stores a representation of one or more products that the customer appears to have a propensity for (e.g., based on historical purchase data); (vii) a mailing list inclusion field 614 that stores a representation of whether or not promotional messages are allowed to be sent to the customer; (viii) a financial account identifier field 616 that stores a representation of a bank account number, a credit card number, and/or other financial account information needed to charge an account associated with the customer; (ix) a unit balance field 618 that stores a numerical indicator of a number of units of product currently credited to the customer's account; and (x) an auto recharge field 620 that stores an indication of whether or not the customer has permitted the account to be automatically re-funded in the case that the number of units currently credited to the account drops below a pre-determined threshold.

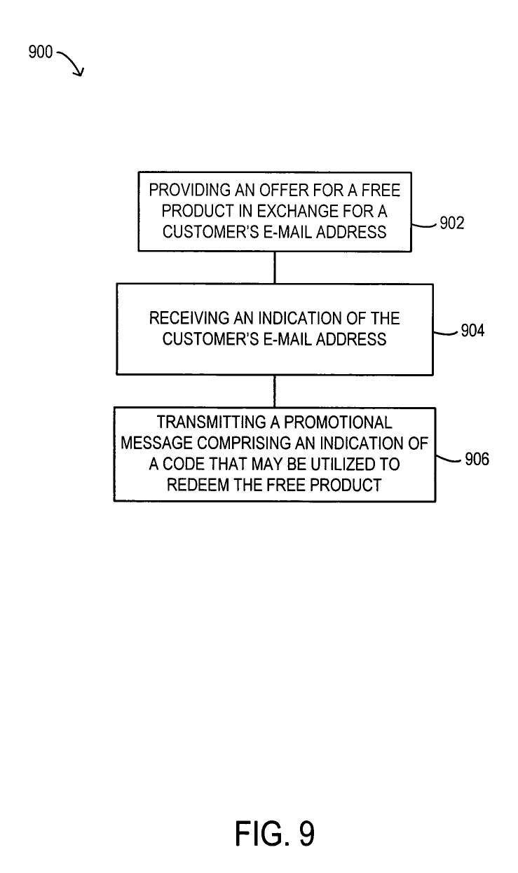

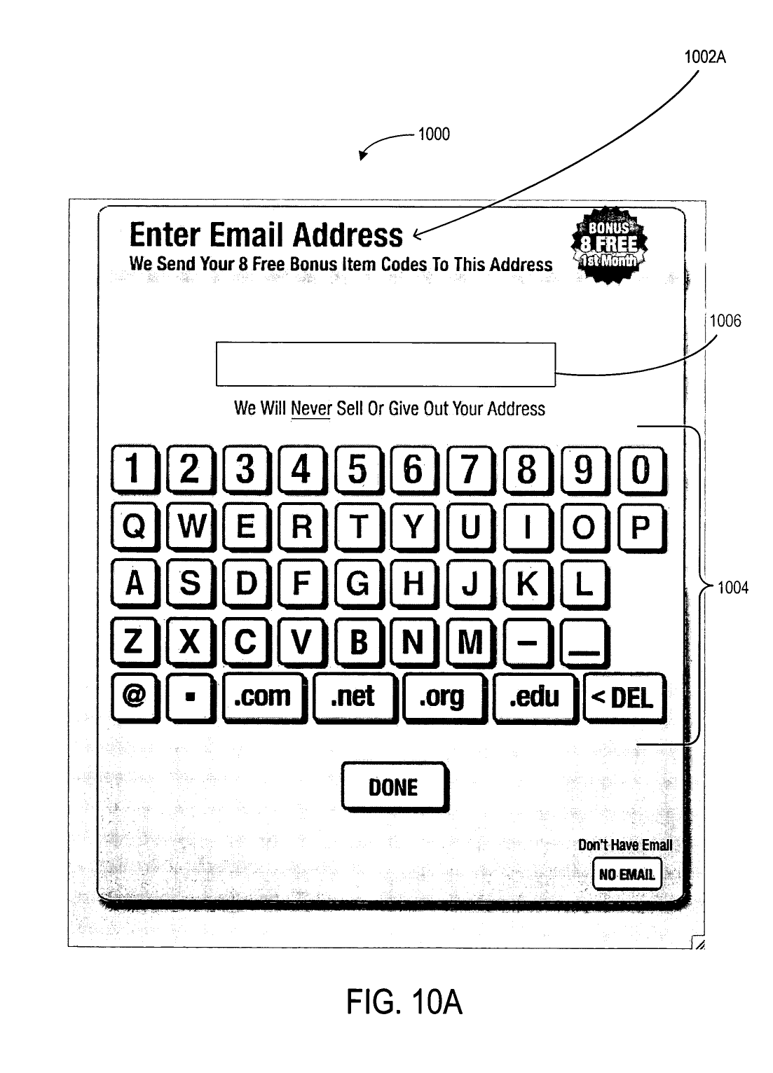

The example customer database 600 depicted in FIG. 9 provides exemplary data to illustrate the meaning and/or typical use of the information stored in this database embodiment. The customer identifier 602 (e.g., “U111123”, “U222234”) may be used to identify and index the customers listed in the customer database 600. It should be noted, however, that in cases where the only information gathered regarding a customer is the customer's e-mail address, the e-mail address field 608 may be utilized instead of and/or in place of the customer identifier field 602.

Three (3) examples of customer information are provided: “Heidi Ross” with credit card number “1111-1111-1111-1111” generally purchases “2 units per week” at the vending machine, has a current unit balance of six (6) units, and has allowed auto recharge of the account. In some embodiments, an additional field (not shown) indicating a minimum account unit balance that may trigger automatic re-funding of the account may be specified. In some embodiments, this threshold may be set and/or defined by the customer, operator, and/or a third party (e.g., a credit card company). Based on the information stored in the customer database 600, “Heidi Ross” may be considered to be a “funded account holder” and/or an “automatically funded account holder” (e.g., since auto recharge is allowed); “Robert Conner” with credit card number “2222-2222-2222-2222” generally purchases “1 unit per month”, has a current balance of zero (0) units, and has disabled auto recharge. “Robert Conner” may, for example, be a funded account holder that has allowed the account to be debited of all product units. This may have occurred, for example, due to the fact that “Robert Conner” has chosen not to allow the vending machine to automatically monitor and re-fund the account; and “Herbert Eingart”, whom has never made a purchase at the vending machine (at least a purchase in which “Herbert Eingart” was able to be identified as the customer), has not provided a credit card number, has opted out of the promotional e-mail mailing list, and has a current account balance of one (1) unit. Since “Herbert Eingart” has not provided a credit card to the vending machine, the auto recharge option may, as shown, be moot. In some embodiments, such as in the case that “Herbert Eingart” provided his e-mail address to the vending machine in exchange for a free unit of product, the current account balance may reflect that the free unit has not yet been redeemed. “Herbert Eingart” may also be considered to be an “unfunded account holder”, as he has an account with the vending machine, yet has not provided funds to credit units of product to the account (at least not yet).

B. Promotional Message Database

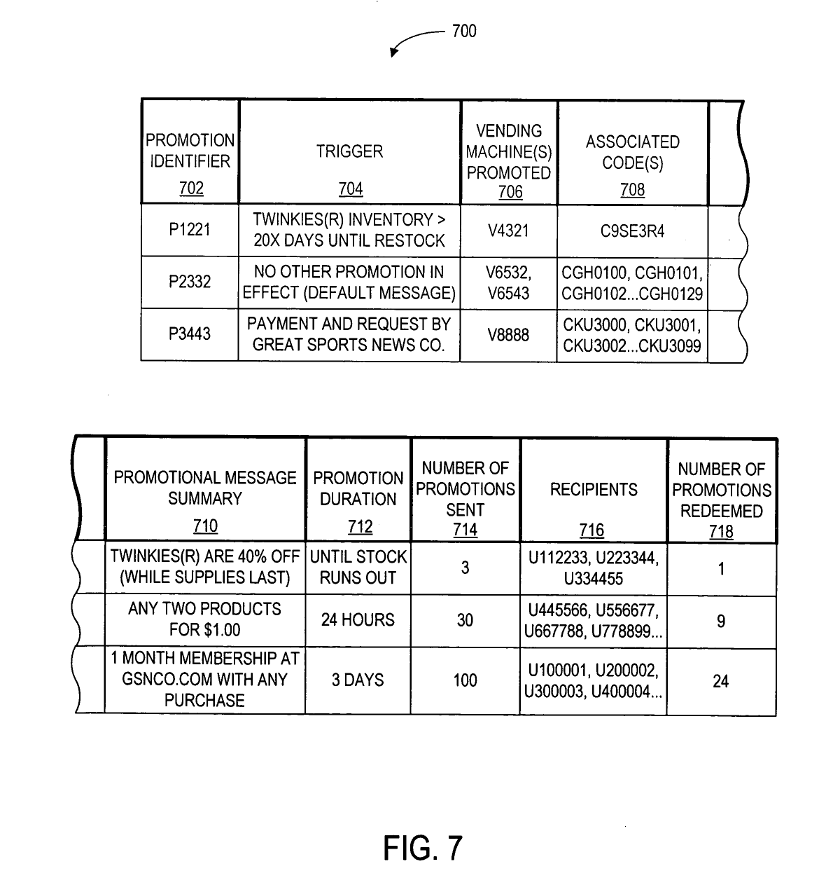

Turning to FIG. 7, a tabular representation of an embodiment of a promotional message database 700 (e.g., the promotional message data database 240 of FIG. 2) according to some embodiments is illustrated. This particular tabular representation of a promotional message database 700 includes sample records or entries which each include information regarding particular promotions and/or promotional messages that may be provided to customers. In some embodiments, the promotional message database 700 may be used to store information associated with promotional messages that have or will be e-mailed to customers. Those skilled in the art will understand that such a promotional message database 700 may include any number of entries or fields, instead of and/or in addition to those shown in FIG. 7.

The particular tabular representation of the promotional message database 700 depicted in FIG. 7 includes nine (9) fields for each of the entries or records. The fields may include: (i) a promotion identifier field 702 that stores a representation uniquely identifying a particular promotion, promotion instance, and/or promotional message; (ii) a trigger field 704 that stores a description of an event or condition that may trigger the offering of a benefit in exchange for an e-mail address and/or the transmittal of the promotional message; (iii) a vending machine promoted field. 706 that stores a representation of which vending machines are to be promoted via the promotional message; (iv) an associated codes field 708 that stores a representation of any redemption codes that may associated with the promotion and/or promotional message; (v) a promotional message summary field 710 that stores a description of the promotional message to be sent to customers; (vi) a promotion duration field 712 that stores a representation of a time frame during which the promotion is valid; (vii) a number of promotions sent field 714 that stores an indication of a number of promotional messages sent for each promotion; (viii) a recipients field 716 that stores a representation of customer identifiers to which corresponding e-mail addresses the promotional message has or will be sent; and (ix) a number of promotions redeemed field 718 that stores a numerical indicator of a number of redemptions associated with each promotion and/or promotional message.

As shown in FIG. 7, a first promotion “P1221” may indicate that “Twinkies® are 40% off (while supplies last)”, such promotion being triggered by an inventory event where a restock date is more than five (5) days away and Twinkie® inventory is greater than twenty (20) units. This promotion may last until the Twinkie® inventory is depleted, may be sent to the three (3) customers for which identifier are listed, and may be realized via use of the code “C9SE3R4”. In other words, a customer receiving an e-mail of the promotional message, including an indication of one or more codes stored in the associated codes field 708, may provide the code(s) to the vending machine to obtain the discount on Twinkie® products.

C. Promotional Code Database

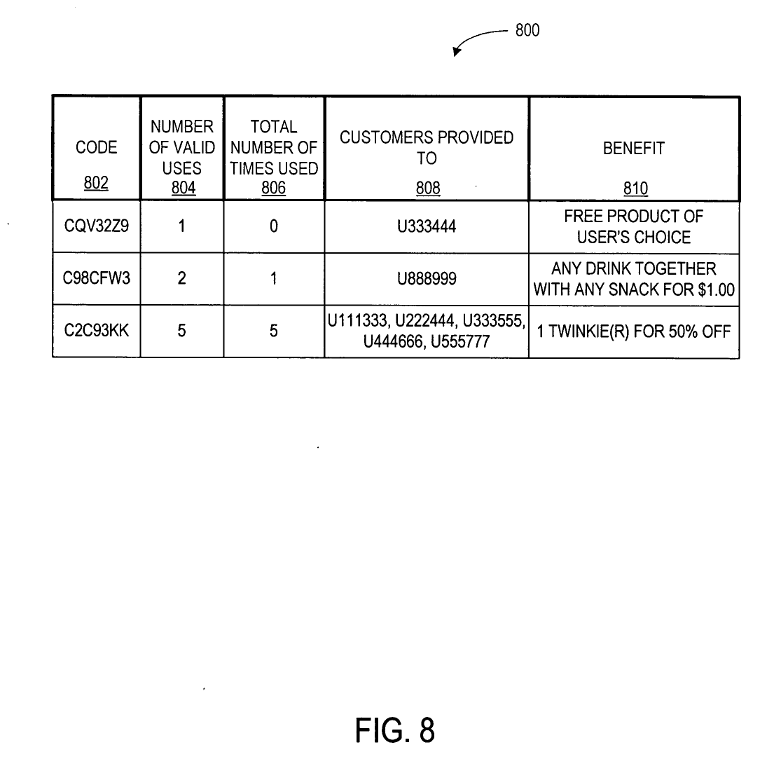

Turning to FIG. 8, a tabular representation of an embodiment of a promotional code database 800 (e.g., the promotional code data database 242 of FIG. 2) according to some embodiments is illustrated. This particular tabular representation of a promotional code database 800 includes sample records or entries which each include information regarding particular promotion codes that may be redeemed to obtain benefits associated with various promotions (e.g., that are e-mailed to customers). Those skilled in the art will understand that such a promotional code database 800 may include any number of entries or fields, instead of and/or in addition to those shown in FIG. 8.

The particular tabular representation of the promotional code database 800 depicted in FIG. 8 includes five (5) fields for each of the entries or records. The fields may include: (i) a code field 802 that stores an indication of a promotional code; (ii) a number of valid uses field 804 that stores an indication of a number of times that a particular promotional code may be utilized (e.g., before expiring or becoming invalid); (iii) a total number of times used field 806 that stores an indication of a total number of times that the promotional code has been utilized; (iv) a customers provided to field 808 that stores a representation of which customers have been provided with the code (e.g., via e-mail); and (v) benefit field 810 that stores a description and/or indication of one or more benefits that may be obtained by utilizing the code.

As shown in FIG. 8, for example, a first code of “CQV32Z9” may have been provided to the customer associated with the identifier “U333444”, may only be good for a single use (which has not yet occurred), and may entitle the customer to a free unit of any product offered for sale by the vending machine. In some embodiments, as described herein, such a code may be e-mailed to the customer via a promotional message. The promotional message may be sent to the customer's e-mail address, for example, in response to having received the customer's e-mail address via. the vending machine. In some embodiments, the free product may be provided in exchange for the provision of the customer's e-mail address to the vending machine. According to some embodiments, the free product may be provided to any account holding customer (e.g., as a reward).

### V. Processes

The systems and devices described herein, including the hardware components and the databases, are useful to perform various methods pursuant to some embodiments. However, it should be understood that not all of the above described components and databases are necessary to perform any particular method. In fact, in some embodiments, none of the above-described systems and/or devices may be required to practice one or more of the methods described herein. The systems and/or devices described herein are examples that may possibly be useful in practicing some or all of the embodiments described herein.

Further, the flow diagrams described herein do not necessarily imply a fixed order to the actions, and embodiments may be performed in any order that is practicable. Note that any of the methods described herein may be performed by hardware, software (including microcode), firmware, or any combination thereof. For example, a storage medium may store thereon instructions that when executed by a machine result in performance according to any of the embodiments described herein.

Referring to FIG. 9, a flow diagram illustrating a method 900 according to some embodiments is shown. In some embodiments, the method 900 may be performed by and/or otherwise associated with a vending machine 110, 210, 310 as described in conjunction with any of FIG. 1, FIG. 2, and/or FIG. 3 herein, and/or may be associated with additional and/or alternative devices such as controllers (e.g., the controller 104 of FIG. 1), user devices (e.g., the user devices 102 of FIG. 1), peripheral devices, etc.

In general terms, and referring to FIG. 9, the method 900 may begin at 902, by providing an offer, via an interface at a vending machine, for a free unit of a product in exchange for an e-mail address associated with a customer. Other benefits may also or alternatively be provided in exchange for the e-mail address, such as discounts, media (e.g., entertainment and/or news media), services, opportunities, etc. The offer may generally be provided via a display device such as a touch screen interface coupled to the vending machine, such that customers approaching the vending machine may view the offer. In some embodiments, a determination may be made whether or not such an offer should be presented. Based on sales and/or inventory data of the vending machine, for example, it may be determined that sales should be increased by providing offers and/or incentives. The particular offer provided may also or alternatively be determined. Based on vending machine data and/or other rules, for example, one of a plurality of available promotions may be output as an offer to customers. In the case that sales are determined to be in need of a boost, for example, but inventory of products is generally low, an offering of discounts on future purchases or a subscription or membership offer may be output, such that, if accepted, current inventory may be preserved. Similarly, in the case that inventory levels are high (and even if sales are not particularly low), a free product may be offered in exchange for an e-mail address, as shown on the vending machine 310 of FIG. 3.

In some embodiments, the method 900 may continue by receiving, via the interface at the vending machine, the e-mail address associated with the customer, at 904. In the case that the customer accepts the offer provided at 902, for example, the customer may provide the e-mail address to the vending machine in an attempt to obtain the offered benefit (e.g., a free product, trial product, and/or other benefit). According to some embodiments, the vending machine (and/or associated controller or peripheral device) may receive contact information for one or more customers.

In one or more embodiments for example, a vending machine, a computer associated therewith (e.g., a controller or server hosting a website affiliated with a vending machine), and/or an operator may receive contact information. In one or more embodiments, the received contact information may be stored in a database.

Contact information may generally include, but is not limited to, communications address(es) or identifiers. In one or more embodiments, one (or more) communications address(es) or identifiers may identify, and/or facilitate communication with, one or more customers and/or user devices. Communications addresses may include, but are not limited to IP addresses, serial numbers, Media Access Control (MAC) addresses, telephone numbers, e-mail addresses, desk phone numbers, home phone numbers, mobile (cellular or satellite) phone numbers, fax numbers, pager numbers, Instant Messenger (IM) handles, chat room handles, Website address (e.g., a Uniform Resource Locator (URL), etc. Communications addresses may facilitate communication between one or more vending machines and/or controllers and one or more user devices, such as PC devices or telephones. It should be noted that contact information may also includes postal addresses (such as a work address, home address, or other address), GPS coordinates, or other information.

Contact information, such as a communications address, may be received in one or more ways, according to one or more embodiments. In one embodiment, a communications address is received by a vending machine directly from a customer via an input device. In another embodiment, a communications address is received by a vending machine through a communications port. For example, a customer may transmit, to a vending machine, a communications address through a user device that communicates with the vending machine processor through a communications port. In yet another embodiment, a communications address is received by a controller from a user device. In still another embodiment, a communications address is received by a controller from an operator (who may have solicited communications addresses from customers, employers, etc.).

For example, in an embodiment, the controller may receive a list of e-mail addresses of company employees. The list may include an e-mail address for all employees of a company, or for a subset of company employees. In addition, if a company employee has multiple e-mail addresses, then the controller may receive one or more of the employee's e-mail addresses.

Such a list may be (i) input to the controller by an operator (e.g., who received such a list directly); or (ii) received by the controller via, e.g., a Web interface, such as when a company representative transfers a file of e-mail addresses to the controller utilizing a suitable file transfer method and/or means, including but not limited to a Web interface or e-mail. Other methods of receiving a set of e-mail addresses are known and within the scope of the embodiments described herein.

In some embodiments, the controller may receive a single item of information representing contact information for more than one employee. For instance, the controller may receive a “list address” or the like, such that any e-mail sent to the list address is automatically forwarded or provided to the e-mail addresses of individual employees associated with the particular distribution list. For example, a list may allow contact with certain groups according to a functional unit (e.g., the marketing group; customer service department) or according to location (e.g., third floor employees). The controller need not be aware of the individual e-mail addresses that form a part of the list.

In various embodiments, the list of e-mail addresses or other employee contact information may facilitate a function of the controller. The list of e-mail addresses may allow the controller to send promotional messages to the employees. The promotional messages may encourage the employees to transact with a vending machine that a vending machine operator has placed or intends to place at a company's offices. The operator may thereby expect to generate more sales per employee at a vending machine placed inside the company offices than the operator could hope to make without the ability to send e-mail messages to the employees.

In some embodiments, the vending machine may also receive rules governing use of the e-mail address and/or other contact information and/or transmission or receipt of promotional messages. In one or more embodiments for example, a vending machine, controller, and/or operator may receive one or more restrictions or rules governing the use of the contact information (e.g., communications addresses) and/or the transmission or receipt of promotional messages.

In one or more embodiments, restrictions or rules may be received from a user device, a customer, an operator, a product manufacturer, a school principal or teacher, a medical doctor, a pharmacist, a nutritionist, a parent, or any other person or device. For example, in one or more embodiments, a customer may, through an input device of a vending machine or a user device, input parameters governing the transmission of promotional messages to, and/or the receipt of promotional messages by, the customer or user device. Thus, in an embodiment, a customer may set preferences as to what type of promotional messages the customer may wish to receive.

For example, a customer may only wish to receive promotional messages concerning Snickers® bars, Diet Coke®, or the like, and may set preferences accordingly. Further, a customer may only wish to receive promotional messages concerning items of a certain price, sales or discounts of a certain percentage or magnitude, etc., and may set preferences accordingly. Further still, a customer may only wish to receive promotional messages concerning items possessing or lacking certain nutritional attributes (e.g., calorie content, fat content, carbohydrate content). Additionally, a customer may wish to prevent or restrict the transmission of certain promotional messages (e.g., concerning certain products, manufacturers, etc.). Of course, a customer may set any combination of preferences and/or rules. In one or more additional embodiments, one or more of a parent, a teacher, a school principal, a nutritionist, a personal trainer, and/or an employer or company representative may set rules, restrictions or parameters governing the transmission of promotional messages to, and/or the receipt of promotional messages by, a user device and/or customer. For example, a parent, teacher and/or school principal may restrict the transmission of certain promotional messages to one or more children (e.g., promotional messages promoting high calorie snacks may be banned).

As stated, in various embodiments, an employer or company representative may place limits, rules, or restrictions upon when the controller and/or vending machine may send messages to the company employees. The restrictions may, e.g., be structured to protect company employees from excessive numbers of e-mails. The restrictions may also be structured to discourage the controller from distracting the employees during work hours (e.g., by encouraging the employees to get up from their desks to go to the vending machine). Restrictions may further be structured to protect the company's employees from types of messages that may be deemed inappropriate for a work environment.

The following are some example restrictions that may be placed upon the controller, a vending machine, and/or an operator with regards to sending promotional messages, such as e-mail messages, to one or more user devices and/or customers (e.g., company employees):

a. Messages are permitted to be sent only (or are not permitted to be sent) during certain hours, days of the week, time periods;

b. Messages are permitted to be sent only (or are not permitted to be sent) to certain customers (e.g., employees);

c. A limit (e.g., one (1) message per day) on the number of messages sent to a given customer (e.g., a particular customer) employee per unit of time;

d. A limit (e.g., five (5) messages during any one-hour (1-hr) period) on the total number of messages sent out per unit time;

e. Messages are restricted to a certain size or less (e.g., as measured in bits, bytes, and/or lines of text);

f. Messages are restricted from containing certain words, such as e.g., common vulgar words;

g. Messages are restricted from containing content of a violent, mature, or racially insensitive nature;

h. Messages are restricted from containing content concerning various controversial topics, such as politics, abortion, religion, etc.;

i. Messages are restricted to topics related only to one or more vending machines (e.g., relating only to the vending machine placed by the operator in the company offices, relating only to what the vending machine has in inventory);

j. Messages may be restricted as to their origin. For example, messages must always originate from a particular sender (e.g., an e-mail address thereof), such as an e-mail address of the controller or vending machine; and/or

k. Messages must be clearly marked as having been sent by the vending machine or by the controller. For example, messages must contain “Vending” as the first word in the subject line of the e-mail, or as the first word of the message body. With this restriction, employees may more readily filter or avoid messages from the vending machine if desired. Such restrictions may be required by applicable state or federal legislation.

The above (and other) restrictions may be received via a Website of the controller. For example, a customer, an operator, or an appropriate and authorized third party (e.g., a product manufacturer, a school principal or teacher, a nutritionist, a parent, an employer or company representative) may visit the Website and may enter in one or more restrictions electronically (e.g., through known web browser graphical user interface components). There may be a predetermined HTML form for entering restrictions. For example, the user may be able to check boxes next to the hours that promotional e-mails are permitted. Alternatively, restrictions may be entered freely, such as via a block of text. Additionally, restrictions may be communicated by any other practical means (e.g., by postal mail, facsimile, telephone) to the operator, who in turn converts (if necessary) these restrictions to a form that the controller and/or vending machine may employ.

In some embodiments, communication from the controller may be directed to one or more “proxy” or alias e-mail addresses, rather than other e-mail addresses in use by the employee/the company. For example, employee John Doe, whose real e-mail address is “jdoe@company.com”, a proxy e-mail address of “jmx34@company.com”. E-mails sent to a proxy address may be forwarded (in a known manner by a company server or by other well known means) to the actual address corresponding to the proxy address.

For instance, the controller may send an e-mail to the address “jmx34@company.com”. The server at the company may then automatically associate or translate the address “jmx34@company.com” to “jdoe@company.com” using e.g., a table of proxy and corresponding actual e-mail addresses. The server at the company may then send/forward the e-mail to John Doe via the actual address of “jdoe@company.com”. The use of proxy e-mail addresses may be safeguarded against abuses, such as the unauthorized selling or dissemination of e-mail addresses to marketers. If desirable, the company may readily discontinue the use of the proxy addresses, or otherwise sever the link between the proxy addresses and the actual addresses. The actual addresses would then be protected from unwanted e-mail messages.

According to some embodiments, the method 900 may continue at 906 by transmitting, after receiving the e-mail address associated with the customer, a promotional message to the e-mail address associated with the customer, wherein the promotional message comprises an indication of a code that may be utilized to redeem the free unit of the product. As described herein, the promotional message may also or alternatively comprise other information such as information associated with product discounts, product availability, vending machine inventory, sweepstakes entries, game pieces and/or game results, etc. In some embodiments, the transmission of the promotional message may be triggered by various events such as an elapse of a pre-determined amount of time, an inventory level and/or event of the vending machine, and/or based on sales metrics of the vending machine (e.g., the current or actual product velocity may be less than the ideal product velocity for one or more products—or for the entire vending machine). The satisfaction of other and/or additional conditions or criteria may also trigger the transmission or output of the promotional message. According to some embodiments, the promotional message may not be sent. In the case that vending machine sales and/or revenues are within acceptable limits, for example, the transmission of the promotional message may be delayed (e.g., until a sales boost is needed) and/or simply not triggered.

In some embodiments, a promotional message may be output upon the decision of, e.g., the operator (e.g., believing such a message will attract more customers or lead to greater profits at a vending machine).

A promotional message may be output for purposes of testing (e.g., testing a promotion). If the promotional message is successful in increasing profits at a first vending machine, then the same message may be useful in promoting sales at other vending machines. The use of test promotions, and the propagation of successful test promotions is described in U.S. Pat. No. 6,230,150, entitled “VENDING MACHINE EVALUATION NETWORK” which issued on May 8, 2001, the promotion testing and propagation concepts and descriptions of which are hereby incorporated by reference herein.

Further, in some embodiments, a promotional message may be output on the decision of one or more customers to accept a similar promotion. Thus, promotional messages which have proven effective may be sent to additional customers.

The outputting of a promotional message may be based on the sales of a vending machine (e.g., output if the sales of a vending machine or a set of vending machines are below a threshold). An appropriate promotional message may, in such a case, be one that is intended to increase sales of the vending machine or set (e.g., network) of vending machines.

The outputting of a promotional message may be based on the scheduled restock date of a vending machine being less than a predetermined amount of time in the future. An appropriate promotional message would generally, in such a case, be one that is intended to encourage the sale of as many items as possible prior to the restocking.

The outputting of a promotional message may be based on the incorporation of a new product (e.g., new flavor of Kellogg's® Pop Tarts®) or feature (e.g., a credit card acceptor, a new price for a product) in the vending machine. An appropriate promotional message in such a case may be one that is intended to inform recipients of the new product or feature and/or encourage purchase/use of the new product feature.

The outputting of a promotional message may be based on the restocking of the vending machine. An appropriate promotional message may, in such a case, be one that is intended to inform recipients that the vending machine has been restocked.

The outputting of a promotional message may be based on the location of the vending machine changing. An appropriate promotional message may, in such a case, be one that is intended to inform recipients of the new location of the vending machine.

The outputting of a promotional message may be based on a new occurrence with the vending machine that is of interest to a particular employee. An appropriate promotional message may, in such a case, be one that is intended to inform that employee that when the price of his favorite drink goes below a predetermined level.

The outputting of a promotional message may be based on a regulary scheduled time for a promotional message. For example, every Monday at 5:00 PM, the controller may send out a promotional message.

The outputting of a promotional message may be based on the time of day, and in particular the sales during that time of day. For example, if during certain hours of the day there are lower sales, an appropriate promotional message may, in such a case, be one that is intended to encourage sales during these hours (e.g., by offering a benefit, such as a discount, during these hours).

The outputting of a promotional message may be based on the purchase history of a particular employee. For example, the outputting of a promotional message to a particular employee may be based on whether the employee has (i) made more than a predetermined number of purchases at the vending machine, (ii) had greater than a predetermined response rate to prior promotions, (iii) agreed to receive promotional messages with at least a predetermined frequency, (iv) spent more than a predetermined amount at the vending machine, (v) encouraged a predetermined number of friends to transact with the vending machine, and/or (vi) met any other criteria.

An appropriate promotional message may, in such a case, be one that provides the employee with a benefit, even one which is so large as to result in no immediate profit for the operator (e.g., providing the employee with a free product). However, providing the employee with the benefit may encourage the employee to remain a good customer of the vending machine. For example, the employee may wish to remain on the mailing list of the operator because of the prospect of periodically receiving offers with a large and easily apparent benefit. The employee may also share his good fortune with friends, thereby encouraging them to remain on, or to join a promotional mailing list. Thus, the operator, vending machine and/or controller may benefit from an overall increase in sales or profits. Furthermore, even if the operator may suffer a loss on the initial benefit provided, the operator may ameliorate this by providing as a benefit a product that was not likely to sell before the next restocking.

The outputting of a promotional message may be based on the number of units remaining of a particular product (e.g., whether the number of units of a particular product exceeds or is less than a predetermined threshold). An appropriate promotional message may, in such a case, be one that encourages sales of the particular product.

The outputting of a promotional message may be based on the number of a units remaining of a category of products such as “beverages” (e.g., whether the number of a units remaining of beverage products exceeds or is less than a predetermined threshold). An appropriate promotional message may, in such a case, be one that encourages sales of the category of product.

The outputting of a promotional message may be based on the number of a units remaining of all products in the vending machine (e.g., whether the number of a units remaining of all products exceeds or is less than a predetermined threshold). An appropriate promotional message may, in such a case, be one that encourages overall sales at the vending machine.

The outputting of a promotional message may be based on the occurrence or imminence of a holiday and/or other special event (e.g., the week before Halloween). An appropriate promotional message may, in such a case, be one that encourages sales of, e.g., candy or whatever product is desirable to sell during the period of time in question (chocolate eggs proximate to the Easter holiday, chocolate Santas proximate to the Christmas holiday, etc.).

The outputting of a promotional message may be based on product preferences of a particular employee and/or customer (e.g., whether there is a discount on particular products, whether there are many units of a particular product remaining in inventory, whether new items likely to be as desirable are in stock) and/or information desired by the employee. An appropriate promotional message may, in such a case, be one that encourages the employee to purchase the product, or otherwise exploits the information regarding the product preference. An employee's preferences (e.g., preferred foods, beverages, or other products) may have been indicated by the employee using an input device of the vending machine, or using a Website of the controller. An employee may also have implied a preference by having frequently purchased a particular product from the vending machine.

The outputting of a promotional message may be based on a change in purchasing behavior of an employee and/or customer (e.g., decrease in sales volume per time attributable to that employee). An appropriate promotional message may, in such a case, be one that indicates the change in purchasing behavior (e.g., “Hey Bob, we noticed you haven't bought any soda this week? Is everything o.k.?”) and/or attempts to change the behavior to the previous state or to a more desirable state (“Don't forget to buy a soda today. Use the code “G4-H5-I2” to get a 20% discount on your purchase.”).

The outputting of a promotional message may be based on the unavailability of a product (e.g., whether there are few items of a particular product remaining, whether there are few items of any product remaining). In such a situation, a decision may be made to not send a promotional message regarding that product that would otherwise have been sent. Thus, the condition (unavailability of a product) serves as an “inhibitor” which prevents or reduces the chance of sending a (particular) promotional message.

Similarly, another condition which may inhibit the sending of a message is whether a maximum number of messages has already been sent (e.g., maximum for a time period).

The outputting of a promotional message may be based on a cost, profit margin or sales of a product (e.g., whether the cost/profit margin/sales of a product is or becomes above/below a threshold). An appropriate promotional message may, in such a case, be one that promotes sales of the product (e.g., products with low sales, high profit margins).

The outputting of a promotional message may be based on whether sales goals have been met. For example, messages may be output (possibly in increasing frequency) if sales continue to fall short of sales goals.

The outputting of a promotional message may be based on the ability to reach a goal, such as a sales goal. For example, messages may be sent to progressively increasing numbers of recipients until a desired sales goal is reached. Similarly, messages may be sent to the same recipients repeatedly. Successively sent messages may provide successively increasing benefits (e.g., initially a ten percent (10%) discount, then a twenty percent (20%), then twenty-five percent (25%) or decreasing benefits if goals are being met). Similarly, successively sent messages may be targeted to increase sales of different products, thereby increasing sales for the vending machine if, e.g., one product sells out completely.

The outputting of a promotional message may be based on a change in price of a product. An appropriate promotional message may, in such a case, be one that informs an employee of the new price of the product.

In some embodiments, the promotional message may be transmitted to recipients in accordance with specified criteria. Once the promotional message has been determined/generated/selected (and also approved in various embodiments), the message may, for example, be transmitted to its intended recipients (e.g., such that it is output on a user device). Such transmission may occur in accordance with any restrictions and other desired criteria (e.g., as specified by the company). Such transmission can make use of conventional transmission protocols (e.g., e-mail via SMTP or POP protocols; to a telephone via an outbound IVR module of controller). For example, as described herein, there may be restrictions on the time such messages can be sent to certain recipients, as well as on the number of such messages.

According to some embodiments, the promotional message (and/or a plurality of promotional messages) may also be determined. The controller may determine (e.g., generate or select), for example, a promotional message for transmission to one or more customers (e.g., company employees) and/or user devices. In various embodiments, a promotional message may include content that encourages customers (e.g., company employees) to make a purchase from a vending machine. A promotional message may include various information, such as is described herein, alone or in various combinations.

Promotional messages may include inventory information pertaining to one or more vending machines. For example, a promotional message may indicate the number of remaining units of one or more product, the actual sales rate of one or more products, graphics associated with one or more products, and/or pictures of one or more inventoried products. Thus, a promotional message may allow a customer to remotely view the inventory of one or more vending machines.

Promotional messages may be generated based upon one or more price management factors or revenue management factors. For example, a vending machine and/or controller may determine that actual product velocity is less than ideal product velocity, and may discount one or more products in an effort to promote the clearance of inventory before the end of a fill period. Alternatively or additionally, the use of price management factors in creating promotions (e.g., discounts) at a vending machine may be similar to that described in U.S. patent application Ser. No. 08/947,798, filed Oct. 9, 1997, entitled “METHOD AND APPARATUS FOR DYNAMICALLY MANAGING VENDING MACHINE INVENTORY”; U.S. patent application Ser. No. 10/902,397 filed Jul. 29, 2004, entitled “PRODUCTS AND PROCESSES FOR VENDING A PLURALITY OF PRODUCTS”; and/or in U.S. patent application Ser. No. 10/966,407, filed Oct. 15, 2004 entitled “PRODUCTS AND PROCESSES FOR MANAGING THE PRICES OF VENDING MACHINE INVENTORY”; the price management and related promotional features of each of which are hereby incorporated by reference herein.

In some embodiments, an operator or other person may generate or select a promotional message, or may alter the contents of a promotional message selected generated by the controller, a vending machine or by a third party. For example, a company representative may visit a Website of the operator which provides an interface for specifying (i) a message, (ii) desired graphics, and (iii) the times and dates during which the message is to be displayed.

Such messages specified by company representatives may be promotional messages (e.g., for the vending machine). Alternatively, such messages may be company specific, such as a general reminder (e.g., of an upcoming meeting), an advertisement for an upcoming social event, a reminder to submit checks for reimbursement, a reminder to turn in time sheets, a congratulatory message (e.g., if it is an employee's birthday or if an employee has just had a baby), a message of praise (e.g., for an employee or group of employees that has done good work), and/or any other message of relevance to a company.

Such messages specified by company representatives may provide benefits (e.g., discounted products, free products) to employees, e.g., for purposes of rewarding or showing recognition to employees. Further, in an embodiment, an employer may reimburse an employee or operator for all or a portion of products redeemed or purchased from one or more vending machines.

A promotional message may include information indicating a price of a product available at one or more vending machines or the occurrence of a reduced price of a product. For example, a promotional message may indicate that a package of potato chips may be purchased for fifty percent (50%) off during the next hour. A promotional message may include information indicating the availability of a package deal. For example, a promotion may indicate that a customer may purchase both a soft drink and a snack for only one dollar ($1).

A promotional message may include a code redeemable at a vending machine for (i) a specific product, (ii) a product from a particular class of products (e.g., any soda, any Coca-Cola® product, any chocolate bar; any product indicated by a green flashing light), and/or (iii) a “mystery” product selected by the operator, vending machine, and/or controller (e.g., a product unlikely to sell out before the end of a fill period).

A promotional message may include information indicating the duration of any discount, special offer, or other promotion. For example, the promotional message may indicate that all carbonated drinks are two (2) for the price of one (1) for the next ten minutes (10-min).

A promotional message may include information indicating the start or end time of a promotion. For example, a promotion may not take effect until one hour (1-hr) after a message is sent. Thus, a person may receive a promotional message at 3:00 PM that states: “Tortilla Chips are 50% off starting at 4:00 PM”. Similady, a promotional message may indicate the end time of a promotion. For example, a promotional message may indicate that Tortilla chips will be fifty percent (50%) off until the end of the day. In various embodiments, a promotion may end at the time of the next restocking. Thus, for example, potato chips may be sixty percent (60%) off until the vending machine is next restocked . Advantageously, this would allow a promotion to remain in effect only long enough to clear out as much old inventory as possible before a restocking event.

A promotional message may include information indicating the availability of a supplementary prize. For example, the message may indicate that a customer may obtain a free ticket to an event, a club or the like with any purchase at a vending machine.

A promotional message may include information indicating the availability of various information, such as news information, entertainment, educational information, and so on. For example, the message may indicate that Britney Spears' new music video is playing on the display screen of the vending machine. As another example, the message may indicate that there is breaking news about an approaching hurricane being shown on the display screen of the vending machine.

A promotional message may include information indicating a way in which further information may be obtained. For example, the promotional message may include information regarding a web site or web content (e.g., a URL address; a hyperlink); and/or a code which, when entered, allows access (or a particular level of access) to a web site or web content. The web site may provide any information desired, such as information that may be appropriate for promotional messages (e.g., information indicating a price of a product available at the vending machine).

A promotional message may include information indicating the availability of a product, or the impending availability of a product, and/or the relative availability (e.g., quantity remaining) of a product at one or more vending machines. For example, a promotional message may indicate that Tiffany's™ Fine Chocolates are now in stock, that Cokes® are out of stock, or that the stock of potato chips has just been replenished. A promotional message may also offer a benefit that is of limited quantity. Therefore, the promotional message may indicate that only ten (10) promotions are available. For example, “Twinkies® are two for the price of one. Hurry, there are only eight Twinkies® left in stock.”

A promotional message may include information indicating a particular vending machine (e.g., of a plurality within an office building). For example, a promotional message may indicate that Snickers® candy bars are available at the Mars® Vending Machine. In various embodiments, promotional messages may promote only a single vending machine, or only a subset of vending machines. Thus, there may be only two vending machines at which a person might receive the benefit of a promotion (e.g., two vending machines which may be configured to honor a code provided in the promotional message).

A promotional message may include information indicating a location of one or more vending machines, such as “the snack machine is on the first floor and the beverage machine is in the lobby” or “the vending machine in the main lobby”.

A promotional message may include information indicating directions to a vending machine, either generically or from each of a plurality of locations, such as “from the lobby, take the elevator to the second floor of the building, and go to the right to find the vending machine”. Thus, in one or more embodiments, a process or subroutine may include the steps of (i) determining a location of a vending machine, (ii) determining the location of a customer and/or user device, (iii) determining directions (e.g., redeeming directions and/or maps from a database) based on the determined locations, and/or (iv) transmitting the determined locations to a customer and/or user device.

A promotional message may include information indicating a particular vending machine among several that an employee may visit. For example, an office may contain several vending machines. A promotional e-mail may indicate that an employee should visit a first vending machine rather than a second, because the first still has a particular product in stock. For example, “If you are looking for Rice Bars, visit the vending machine in the kitchen. The vending machine in the lobby is out.” A promotional message that steers an employee towards a particular vending machine may help the controller to manage inventory simultaneously at multiple vending machines. One advantage is that a controller can encourage usage such that all vending machines run out of products at approximately the same time. In this way, a fill person may refill all vending machines at once during the same trip. Alternatively, the controller can encourage use of a vending machine that is not currently being serviced (e.g., maintenance), that is not currently malfunctioning, and/or that is scheduled for service at a later time than one or more other vending machines. In this manner, a controller and/or operator can reduce the likelihood that the servicing of one or more vending machines would interfere with sales opportunities.

A promotional message may include information that is customized, e.g., customized to the recipient (e.g., a particular customer), customized to the company of the recipient. For example, a message sent to a particular employee may contain the employee's name in the greeting. A message sent to a group of employees of a company may contain the company's name. A message may also refer to an employee's purchase history or to other known information about the recipient. For example, a message might say, “Hey Bob, your favorite snack, Aunt Susan's Honey Butter Cookies, is now twenty percent off!”

A customized promotional message may be determined based on a customer's past purchase behavior or lack thereof. For example, in one or more embodiments, a customer who has provided a communications address but has not established an account with a vending machine and/or controller may be prompted by a promotional message to purchase a subscription account or a membership account, as described herein. For example, a message may explain that subscriptions enable customers to realize volume discounts.

Further, in one or more embodiments, a customer who has provided a communications address but has not established an account may be prompted by a promotional message to establish a “free” account (e.g., no purchase necessary) which may, in some embodiments, entitle the customer to receive free products. In one such embodiment, a “free” account functions like a subscription account, where a unit balance is maintained in a memory in association with a customer account identifier, although the customer may receive one or more free units of product, which are added to the balance of the account. In another such embodiment, a customer may be awarded free units over one or more periods of time (e.g., one (1) free trial product every week). Should the customer not redeem the free unit(s) within the appropriate time period(s), the unit(s) may expire or be forfeited. Alternatively, the awarded but unredeemed units may remain in the balance of the account unless or until the customer redeems the units. Such “free” account embodiments may be particularly advantageous to product manufacturers or other entities associated with national brands (e.g., The Coca-Cola Company), as they provide a novel and effective way to promote trial of new products.

Further, in one or more embodiments, a customer who has provided a communications address and has established a “free” user account may be prompted to “fund” an account, such as by (i) purchasing one or more items, (ii) purchasing a membership, (iii) establishing a cash balance (e.g., establish a stored-value account), and/or (iv) accepting an offer from a third party, who may subsidize the purchase and/or redemption of one or more vended products. Further still, in one or more embodiments, a user may not be permitted to redeem “free” items or benefits unless or until the customer has funded the account.

Further still, in one or more embodiments, a customer who has provided a communication address and has purchased or otherwise “funded” an account, such as by purchasing one or more items pursuant to a subscription or by purchasing a membership, may be prompted by a promotional message to provide a financial account identifier (e.g., a credit card number, a debit card number, a checking account number) that may be used by the vending machine, controller and/or operator to automatically renew an such account upon its expiration and/or upon depletion of the account's unit balance. For example, should a customer provide such a financial account identifier, upon the redemption of all units purchased pursuant to a subscription (e.g., where a customer has purchased a subscription to eight (8) units for five dollars ($5) and has redeemed all eight (8) units), a controller may utilize the financial account identifier to charge the customer's financial account the price of a new subscription (e.g., another five dollars ($5)), and may thereafter credit eight (8) more units to the account balance in a memory (e.g., in a record of a database).

Additionally, in one or more embodiments, a customer who has provided a communications address and has established an account (e.g., a free user account, a subscription account, a membership account, a stored value account) may be reminded (via message sent to a user device) to utilize the established account (e.g., by redeeming a unit of product using a subscription account identifier; by redeeming a code good for a free product; by purchasing a product at a discount pursuant to the terms of a membership account).

For example, a promotional message may include information indicating a status of a subscription. As discussed above, in various embodiments, a user may purchase a “subscription” to a vending machine, as described, e.g., in U.S. Pat. Nos. 6,298,972, 6,085,888, and 5,988,346, the subscription embodiments of each of which are incorporated by reference herein. A subscription may allow a user to pay upfront for a number of items, with the items to be obtained over a number of transactions. For example, a user may purchase a subscription that allows him to obtain one soda per week for the next ten weeks. A promotional message may indicate the status of a subscription by, e.g., indicating the number of units of the subscription left to be redeemed, that it has been more than a predetermined time since the subscription was used, etc. For example, a promotional message may indicate that a user still has four items in the subscription left to be redeemed. A promotional message may also warn a customer that he must pick up a certain item within a certain time period, or he will no longer be able to. For instance, if a customer has subscribed to receiving one (1) soda per week, the customer may be unable to receive one (1) of the sodas if a given week passes without any redemptions. Thus, such messaging functionality may be particularly useful to customers in embodiments where some or all items in a unit balance (e.g., a free user account or a paid subscription account) expire or are forfeited if they are not redeemed within a certain period of time.

Thus, according to some embodiments, the above-described ability to transmit customized promotional messages based on a customer's past purchase behavior or lack thereof may be used to encourage customers to transact with vending machines in more profitable ways and/or to bolster or modify account relationships. For example, in an embodiment, an anonymous/transactional/cash customer may be encouraged to provide a communications address to a vending machine or controller. Thereafter, the vending machine or controller may transmit an e-mail message to the customer encouraging the customer to establish an account, such as a free sample account. After the customer establishes such an account, the vending machine or controller may transmit a message to the customer encouraging the customer to fund such an account, such as by purchasing a subscription (e.g., pre-paying for units of product), establishing a monetary balance, or the like. Further, the vending machine or controller may transmit a message to the customer encouraging the customer to utilize such an account. Finally, the vending machine or controller may transmit a message to the customer encouraging the customer to provide a credit card account number that may, upon the customer's redemption of all or some of the prepaid units in the subscription account, be utilized to charge the customer for the price of a new subscription and/or additional items. It should be noted that more valuable benefits may be offered in exchange for more valuable behavior (e.g., longer-term memberships, higher value subscription accounts, etc.).

In this manner, a marketing system is provided by the present invention, which functions to encourage “transactional”, anonymous vending machine customers to become (through one or more promotional messages) registered, account-based customers. Once established as regular, account-based customers with on-file financial account identifiers, such customers may enjoy the convenience of automatic, recurring billing, so that customer accounts always have positive balances of prepaid units, thus eliminating the need for customers to provide cash or even credit cards at each vending machine transaction-a customer need only provide a valid account identifier (e.g., a fingerprint and/or alphanumeric code).

Further, in one or more embodiments, a promotional message may include information indicating any other recipients of a promotional message. For example, a promotional message may indicate that thirty other people are receiving the same message. Therefore, the message may indicate that the person should hurry to obtain the promotional benefit before all of the benefits are given away to other recipients of the message.

A promotional message may include information indicating special instructions for a consumer. For example, instructions may direct the recipient to interact with two vending machines (e.g., pursuant to a promotion). Such a promotion might indicate that a consumer may take a first item from a first vending machine, and a second item from a second, adjacent vending machine, for only seventy-five percent (75%) of the combined price of the two (2) items. A consumer may be unaccustomed to receiving items from two (2) separate vending machines as part of the same transaction. Thus, the promotion might emphasize that the consumer must take a product from each of two (2) or more vending machines. In some embodiments, instructions might indicate that the customer is to pay for a transaction at a first vending machine, and to receive a product at a second vending machine.

A promotional message may include information indicating a sweepstakes entry. For example, a promotional message may provide a code to a consumer. The promotional message may further indicate to the user to bring the code to a vending machine in order to see whether he has won. The consumer may later visit the vending machine and enter the code into an input device of the vending machine. If the consumer has won, then the vending machine may arrange for the consumer to receive a prize. For example, the vending machine may dispense a product. Or, the vending machine may arrange for a check to be sent to the user, or a credit to be applied to the user's account (e.g., ten (10) free items added to a subscription account balance). Thus, one benefit of some embodiments is that they function to encourage consumers to visit vending machines by, among other things, promoting the possibility of prize entitlements. In one or more embodiments, entitlement to prizes may be determined randomly, pseudo-randomly, or otherwise, as is described with reference to Applicant's co-pending U.S. Provisional Patent Application Ser. No. 60/527899, entitled PRODUCTS AND PROCESSES FOR PROMOTIONS WHICH EMPLOY A VENDING MACHINE, filed Dec. 8, 2003, the prize concepts and descriptions of which are hereby incorporated by reference herein.

A promotional message may include part of a message that may be completed upon the customer's visit to a vending machine. For example, a promotional message may include part of a joke, and the punch line may be provided at the vending machine. Alternatively, a promotional message may include a trivia question, and an answer to the question may be provided at a vending machine. Further, in one embodiment, a trivia question may be sent to two (2) or more users, who may debate the answer online, and visit the vending machine in order to determine which user knew the correct answer. The user having the correct answer may be awarded a prize or benefit (e.g., a free product). Further, a promotional message may refer to a horoscope, fortune, lucky numbers, etc., which may be revealed at a vending machine.

A promotional message may include information indicating a gift certificate or like award. For example, a promotional message may include a portion (e.g., a bar code) that a person may print out (e.g., through a printer of a personal computer) and insert into an input device a vending machine (e.g., in order to receive products at no cost). The printed portion may, for example, contain a bar code that is readable by the vending machine's bill validator in order to allow the vending machine to determine an amount associated with the gift certificate. For such an embodiment, suitable bill validators capable of reading bar codes are marketed by Mars, Incorporated (e.g., the Mars Series 1000-ZT1200 Bill Acceptor).

The gift certificate may alternatively consist of one or more codes that may be input to the vending machine in return for benefits, such as free or discounted products. A gift certificate may be sent by the controller as a reward for frequent purchases, or as an incentive to try a vending machine. A gift certificate may also be paid for by a first user and provided to a second user. For example, if it is someone's birthday, then other employees in an office may contribute toward the purchase of a gift certificate. A representative of the gift-givers may take the aggregated money and insert it into the vending machine. The representative may indicate an identifier for the recipient of the gift certificate, such identifier possibly including an e-mail address. The vending machine may then transmit the gift certificate to the recipient at, e.g., his e-mail address. Many others, including a company official who wishes to reward an employee, may pay for a gift certificate. Note that a gift certificate may include a note from the givers, such as, “Happy Birthday!” Note that a gift certificate may also be provided in hard copy directly from a vending machine. For example, a giver may insert money, retrieve a printed gift certificate from a vending machine, and physically give it to a recipient. A giver may also insert money and indicate to a vending machine that a gift certificate should be provided to a recipient the next time the recipient transacts at the vending machine.

In various embodiments, a code which is included in a promotional message may consist of a sequence of characters or character combinations that may be entered via keys (e.g., an input device) at a vending machine. Accordingly, it can be advantageous to have the character set of the code based on the vending machine(s) where the code is intended to be redeemed.

For example, a vending machine may have a keypad of keys labeled “A1”, “A2”, “C3”, and so on. These labels reference a row and column from which a purchaser would typically select a snack. For instance, “C3” may refer to the snack in the third row and third column of the vending machine. Thus, a code may consist of sequences of such character combinations, such as “A2-D5-F3”, which permits entry of the code by pressing the keys at the vending machine in the proper sequence. In some cases, a vending machine may contain only numeric keys. In such cases, codes may consist of just sequences of numerals.

A promotional message may include a code that is redeemable only a particular vending machine, or at a particular set (e.g., network) of vending machines.

A promotional message may include a machine-readable code. For example, a controller may transmit a bar code to a user device for display on an LCD screen of a user device. In order to redeem the promotional code, the customer may, in turn, hold the user device up to an optical bar code scanner of a vending machine. Alternatively, a controller may transmit data to a user device which can be, in turn, provided to a vending machine via other wireless data transmission protocols and methods, including but not limited to infrared, RF transmission, the Bluetooth™ protocol, and audio-based data transfer protocols (e.g., DTMF tones).

A code may be made invalid upon a triggering event. In one embodiment, a code may be made invalid after being redeemed in transactions a predetermined number of times. For example, each code may become invalid after only one use. To facilitate a restricting the number of uses for codes, the vending machine and/or the controller may maintain a database of valid codes, such as illustrated by the database 800 of FIG. 8. When a code is inputted, the vending machine may determine whether it is a valid code by consulting such a database. If the code is valid, then the vending machine may allow the current customer to receive a benefit (e.g., receive a product) associated with the code. The vending machine may then update a record of the database by e.g., recording one more use for the code. If the code has been used its maximum number of times, then the vending machine may designate the code as invalid in the database, thereby preventing its further use.

In another embodiment, a code may be invalid if a user device is taken outside the vicinity of a vending machine. For example, a code transmitted to a user device by a controller may be invalidated (e.g., in a database) one the user device is no longer detectable by a vending machine via Bluetooth™ technology.

Additionally, the controller may send a unique code to each recipient of a promotional message. The controller may track which recipient received which code. After redemption of such a code, the vending machine may inform the controller of its redemption. Thus, the controller may track the purchases made by a particular recipient. For example, the controller may maintain and periodically update a user database, such as the customer database 600 of FIG. 6. The database may include preferred products for the user, frequency of purchase, average transaction amount, preferred times of purchase, preferred days of purchase (e.g., Mondays), etc. The controller may use knowledge of a person's purchasing preferences and purchasing habits to tailor promotional messages to the person. For instance, promotional messages may highlight certain preferred products, or may be sent only during days when the user normally transacts with the vending machine.

Further, in one or more embodiments, a vending machine may communicate with a controller during or after a consumer presents a code for redemption. The controller may verify that the code was validly issued and/or not yet redeemed (e.g., by consulting a local or remote database). If the controller verifies that the code is valid, then it may send an authorization or approval signal to the vending machine, which may, in turn, provide a benefit (e.g., dispense a product) to the customer in accordance with a promotion.

A promotional message may include information indicating a benefit from a party other than the operator (e.g., a cross promotion with a third party merchant). Such a benefit can granted in exchange for transactions with a vending machine. For example, a person may receive a gift certificate redeemable at Amazon.com™ with every purchase of a candy bar at the vending machine. In another example, a person may receive a free candy bar or other vending machine item in return for buying one or more products at Amazon.com™.

A promotional message may promote other merchants besides the operator, and/or other products besides those sold in a vending machine. The controller may receive a payment from the makers or sellers of other products or services it promotes in its promotional messages.

In some embodiments, a controller may offer in a promotional message a benefit, such as a free product at the vending machine, if a consumer is willing to receive one or more messages from a third-party merchant. The controller may also offer a benefit if a consumer will allow the promoter to provide the consumer's e-mail address to a third-party merchant. In one embodiment, a vending machine, a controller and/or a computer associated with a third party transmits to a user device one or more of (i) advertising or promotional content and/or (ii) one or more questions.

Should the customer view the content and/or answer the questions by submitting an appropriate response to the server (e.g., via e-mail or through a Web page), the vending machine, a controller and/or a computer associated with a third party may transmit a code to the user device. The code may be used by the customer to redeem a benefit (e.g., a product) at one or more vending machines. Additional embodiments for encouraging a vending machine customer to review a marketing promotion or to participate in a survey are described in U.S. Pat. No. 6,161,059, entitled “VENDING MACHINE METHOD AND APPARATUS FOR ENCOURAGING PARTICIPATION IN A MARKETING EFFORT”, which was issued on Dec. 12, 2000, the survey concepts and descriptions of which are hereby incorporated by reference herein.

A promotional message may include information indicating that a vending machine is operable to accept payment for remote third-party merchants. For example, a vending machine may include an appropriate interface (e.g., flat panel display, keyboard, pointing device) which allows a person to access Web sites or the Internet in general. The interface can permit certain third party merchant Websites to be accessed (e.g., web sites of on-line merchants which permit on-line purchases), and even restrict access to only one or more of such third-party sites. Such an embodiment is advantageous in that a credit card number or other financial account number need not be provided to the web site to render payment. Further, the third-party merchant need not rely on the customer's representation that payment has been sent in the mail, etc. Instead, the vending machine can verify to the third-party web site operator that payment has been made (e.g., by the customer depositing currency in a bill reader of the vending machine). An appropriate amount of funds may be paid to the on-line merchant (e.g., by the operator, automatically by the controller) via any known means such as wire transfer, or credit card account payment using an account such as the operators account. Such an embodiment further facilitates online commerce by expanding payment options for both merchants and consumers.

A promotional message may include information indicating a coupon, such as a coupon that provides a discount for purchases made at the vending machine. Such a coupon may be embodied in a code which, when entered at the vending machine (e.g., into the vending machine's bill validator), provides a discounted product or free product. For such an embodiment, suitable bill validators capable of reading bar coded coupons are marketed by Mars™, Incorporated (e.g., the Mars™ Series 1000-ZT1200 Bill Acceptor).

In some embodiments, a promotional message may include information indicating a volume discount. For example, a promotional message may indicate that a free soda is available with the purchase of eight (8) sodas. As another example, a promotional message may indicate that eleven (11) cans of soda may be had for five dollars ($5), whereas normally only ten (10) cans might be had for five dollars ($5).

According to some embodiments, a promotional message may include information indicating a membership-type promotion. In such a promotion, a person might pay an upfront fee to become a “member”. As a member, the person may have the privilege of getting a discount on items purchased at the vending machine for the duration of the membership period.

A promotional message may include information indicating an “all you can eat” promotion. For example, for a fixed price a person may obtain as many snack items as desired. The person may, however, be constrained by certain restrictions. For example, the person can take as many snack items as he wants for the next week, so long as he takes no more than one (1) per hour.

A promotional message may include information indicating a commission based sales system. In such an embodiment, a first person may be encouraged to bring others to transact at a vending machine. The first person may receive, in the promotional message, one or more codes, which may be distributed to one or more other persons. The first person may then earn benefits for every transaction made by the others at the vending machine. For example, the first person may receive a benefit for every vending machine transaction consummated with a code distributed in the promotional message. Further, the first person may also earn benefits for still other people brought to the vending machine by the people the first person has brought. A person may thereby be encouraged to bring as many people as possible to transact at a vending machine.

A plurality of promotional messages may be interrelated, or designed with a collective goal. For example, each of a plurality of promotional messages may provide promotions that are in effect at non-overlapping periods of time. For example, a first promotional message may indicate that beverages are “two for one dollar” until 1:00 PM today. A second promotional message may indicate that beverages are “two for one dollar” from 1:00 PM to 3:00 PM. A third may indicate that beverages are “three for one dollar” from 3:00 PM to 5:00 PM. Therefore, the different promotions will not interfere with each other. As described herein, one manner of limiting the duration of a promotion is to require that an employee enter a code at a vending machine in order receive the benefit of a promotion. The vending machine can be programmed to accept the codes only during the respective periods of time.

A message may be filtered or verified by one or more company employees or other people before it is allowed to be sent to the intended recipient(s). For example, a promotional message may be composed by the controller, and then transmitted another for approval (e.g., the Human Resources Director of the company). The Human Resources director may then read the message and determine whether the message meets appropriate criteria (e.g., does not contains inappropriate language or graphics). If the Human Resources Director is satisfied with the message, then he may forward the message to one or more other company employees who are its intended recipients. Alternatively, he may express approval of the message (e.g., clicking a button on a Web browser interface), after which the controller is permitted to transmit the message directly to the intended recipients.

In an embodiment, a message may be composed or proposed by a person (e.g., an employee) and submitted to the controller for dissemination (e.g., to a particular set of recipients specified by the person). The controller, in turn, may determine whether the message is approved (e.g., submit the message to a Human Resources Director of a company) before distributing the message.

According to some embodiments, a transaction may also be processed at the vending machine. In an embodiment, the vending machine may engage in one or more transactions pursuant to a promotion (e.g., a half price product, a twenty percent (20%) discount, a coupon redeemable for a discount on a future purchase), especially (but not exclusively) where a promotional message describes such a promotion. In addition to the various promotions described herein and in addition to those promotions known in the art, the vending machine may provide discounts at certain time periods (e.g., half price after 8:00 P.M. on weekdays). Discounts may be limited to a predetermined number of items (e.g., half price on the first ten (10) candy bars to be sold after 8:00 P.M. on weekdays). Discounts may be paid for by, e.g., the company as a reward or incentive.

The processing of the transaction at the vending machine may include receiving a code, and providing a benefit based on the code. The code may be input to the vending machine via any of a number of input devices, such as buttons, keypads, touch screens, or remote control devices. After receiving the code, the vending machine and/or controller may verify that code was validly issued and/or not yet redeemed. Upon such verification, vending machine and/or controller may provide the corresponding benefit that is associated with the code. The vending machine and/or controller may also update a database of codes (e.g., the promotional code database 800 of FIG. 8), indicating one more uses of a code, or indicating that a code may no longer be used. Similarly, the vending machine and/or controller may update an account database, such as a subscription registration database, to reflect the redemption of one or more benefits, products, etc.

The transaction at the vending machine may also or alternatively include receiving a customer identifier (e.g., customer's initials, e-mail address, phone number, birthday, room number, credit card account number, PIN code and/or fingerprint) via an input device. If the identifier is already stored by the controller and/or the vending machine and associated with the customer, then the customer can be identified. An identified customer may pay automatically, e.g., through a credit card account or other financial account stored by the controller and/or the vending machine.

In some embodiments, an account associated with the customer may be created, modified, and/or updated pursuant to the transaction. According to some embodiments, the customer's account may be created after receiving the customer's e-mail address. In the case that one or more products are dispensed and/or funds are transacted with respect to the customer's account, the account may be updated to reflect an appropriate current balance of funds and/or units of products. In the case that a “free” or trial account is depleted of all free or trial products, for example, the account balance may be updated to a balance of zero (0) units of product. According to some embodiments, in the case that the customer does not fund an empty account for a period of time, the account may be deleted and/or marked as inactive (e.g., archived).

After a period of time or after a number of redemptions pursuant to a promotion (e.g., redemption of codes distributed through promotional messages), the controller may evaluate the effectiveness of the promotion. For example, the controller may determine, based on transactions performed at the vending machine(s), and based on the codes received during such transactions, the response rate of employees to a promotion (number of redemptions relative to the number of recipients of the corresponding promotional message). Similarly, effectiveness may be determined with respect to the consequential changes (if any) in sales, profitability, inventory levels, etc. The controller and/or vending machine may record the success of various promotions using a database such as the promotional message database 700 of FIG. 7.

The controller and/or vending machine may evaluate the relative effectiveness of a promotional message to determine promotional messages to use in the future. For example, if a promotional message was deemed successful, then the controller and/or vending machine may, for future promotional messages, use similar wording, use the promise of similar benefits, choose recipient in a similar manner (e.g., targeted to a similar demographic group, to a group consisting of a similar type of employee). Similarly, if a promotional message was deemed unsuccessful, then the controller and/or vending machine may, for future promotional messages, use different messages.

To facilitate customized service, it can be advantageous to collect identification information (as described herein) from a customer transacting with a vending machine. The customer may even be provided with a benefit for providing an identifier (e.g., an e-mail address) at the vending machine. For example, operator or controller may promise the customer a good promotional message to be sent to the customer later in the day if the customer enters his identifier. For instance, by entering the identifying code “1960”, the customer may later receive an e-mail in which he is offered two (2) products for the price of one (1).

The vending machine and/or controller may identify a customer in a number of ways. For example, the customer may enter a code (e.g., a sequence of alphanumeric characters chosen by the customer or by the vending machine and/or controller) that serves as a unique identifier. The vending machine may also or alternatively identify the customer through reading a credit card or other card with readable data (e.g., electromagnetically encoded data). Such a card may be swiped through a card reader or other input device of the vending machine. Other means of identification include facial recognition (e.g., using appropriate hardware such as a camera and recognition software), voice recognition, and biometric identification (e.g., a thumbprint reader).

An employee's e-mail address may function as a code for receiving benefits at the vending machine, and/or as a unique identifier. The vending machine and/or controller may thus track, e.g., the number of benefits redeemed by an employee, and may limit each employee to redeeming a particular number of benefits.

For example, the vending machine may identify the customer by sensing a “prox card” or RFID badge. Such cards are often used to gain access to a building with an electronically controlled lock on a door. The prox card, when placed in proximity to a reader, is detected magnetically by the reader, which in turn can trigger the lock to release, allowing access. A vending machine may detect a prox card via an input device in a manner similar to that used at doorways. The vending machine may identify a customer via an electromagnetic transmission from a user device, such as a cell phone, watch, or personal digital assistant. The vending machine may additionally identify the customer through a fingerprint, through voice analysis, through retinal scan, and/or through facial recognition. The vending machine may recognize a customer passively. In other words, the vending machine may recognize a customer without the customer actively attempting to identify himself to the vending machine. Such a passive recognition system may include facial recognition, or the automatic transmission by a user device to the vending machine of an identifying signal.

Any means of identification may be used in combination, such as a biometric input and a user code which is input via a keypad.

An embodiment therefore includes a method for associating a customer with an identifier, receiving the customer identifier at a vending machine, updating a customer profile for the customer based on his interaction with the vending machine, determining a promotional message based on the updated profile, and transmitting the promotional message to the customer. The method may further include offering the customer a benefit in return for his providing the customer identifier.

In some embodiments, the method 900 may comprise receiving an indication that an employee wishes to opt out of the e-mail list. In an embodiment for example, an employee may indicate that he does not want to receive further promotional messages. The employee may, in some embodiments, reply to a promotional message with a certain key phrase, such as “opt out” in the subject line of his e-mail reply. The employee may also visit a Website of the controller. For example, the employee may click on a link to a Website embedded in a promotional message. At the Website of the controller, the employee may type in his e-mail address, and the controller then removes that e-mail address from the promotional mailing list. The command to prevent receiving promotional messages may also be entered through an input device of a vending machine.

In some embodiments, other people (e.g., a company official such as the Human Resources Director) can-remove an employee's e-mail address from a promotional e-mail list.

In an embodiment, the controller may allow an employee to opt out from receiving promotional messages provided that a predetermined minimum number of employees still remain on a promotional mailing list. For example, if the controller requires at least fifty (50) employees, and there are currently fifty-two (52) on a mailing list, then the controller may allow only up to two (2) employees to opt out of the mailing list. If less than a predetermined number of employees remain on the list, the controller may send a warning signal (e.g., a warning message in an e-mail) to a destination (e.g., a Human Resources Director, the remaining employees, other employees).

In an embodiment, instead of a minimum number of employees being required to remain on a mailing list, if there are less than a predetermined number of employees on the list, the number of promotional messages sent to the remaining employees is increased (e.g., to make up for the diminished number of recipients). For example, the controller may be limited to sending one (1) promotional message per day to each employee on a promotional mailing list, provided there are at least fifty (50) employees. However, if fewer than fifty (50) employees are to remain on the list, then the controller may be permitted to send two (2) promotional e-mail messages per day to the remaining employees.

The number of employees required to be on a promotional mailing list may vary dynamically in response to a number of factors (e.g., recent sales volume, profit margins, number of employees, season).

In various embodiments, rather than opting out completely, an employee may alter the frequency with which he receives promotional messages. For example, the employee may indicate that he wishes to receive messages only once per week rather than twice per week. An employee may additionally alter any other parameter for when messages are sent to him. For example, the employee may indicate a day of the week on which messages are to be sent, a time of day during which messages are to be sent, a maximum length of a message, what should be in the subject line of the message, what types of promotions should be included in the message, and so on. In various embodiments, an employee or consumer may wish to increase the frequency with which he receives messages.

In some embodiments, the method 900 may comprise determining an end to a promotion. For example, a promotion (e.g., a reduction in prices of all products) may last for any period of time, such as a week from Saturday to Sunday, a month consisting of a particular calendar month, or a restock period consisting of e.g., a three-day (3-day) period from Monday to Wednesday. A promotion period may be a period of time over which the controller or vending machine evaluates the performance of the vending machine, the period being deemed over when performance is sufficient (or is insufficient). The performance may be evaluated using such metrics as revenue, profit, number of transactions, number of customers, amount of inventory cleared, and the like. Performance may also be evaluated in terms of a number of supplementary offers accepted. For example, a vending machine may periodically offer a customer thirty free food items, to be redeemed over the course of a month, provided the customer switches his long distance phone service. The controller may evaluate the performance of the vending machine based on the number of such supplementary offers that were accepted during the promotion period.

After examining a vending machine performance over a promotion period, the controller may determine whether goals have been met. Goals such as sales goals may include earning a predetermined amount of profit (e.g., at least one hundred dollars ($100)), receiving a certain amount of revenue (e.g., at least three hundred dollars ($300)), selling a predetermined number of items (e.g., three hundred (300) items), making at least a predetermined number of transactions (e.g., at least one hundred (100) transactions), transacting with a predetermined number of customers (e.g., with fifty (5) customers), and the like.

In some embodiments, the method 900 may comprise distributing vending machine profits. For example, a fee may be collected from the location owner (e.g., a company) if goals (e.g., sales goals) have not been met. Such a fee may serve to, e.g., provide the company with an incentive to promote the vending machine, or otherwise attempt to have the goals met.

The amount of the fee may be determined in various ways. In some embodiments, the fee may be equal to the amount by which profits fell short of desired or agreed-upon profits. In some embodiments, the fee may be equal to some fraction of the amount by which profits fell short. The fee may also be determined as some fraction of a revenue shortfall. In various embodiments, the fee may be equal to some fixed amount for every non-monetary shortfall. For example, the fee may be determined as fifty cents ($0.50) for every customer less than eighty (80) that transacted with the vending machine. Thus, if only seventy (70) customers transacted with the vending machine, the fee would be equal to fifty cents ($0.50) per customer×(eighty (80) customers−seventy (70) customers)=five dollars ($5). The fee may be collected by cash, check, wire transfer, or by any other means.

In some embodiments, the operator may receive other privileges if there is a shortfall. For example, if the controller was previously limited to sending out one (1) promotional message per employee per day, the controller may increase this limit to two (2). In another example, if there was previously a lower limit of fifty (50) employees on a promotional mailing list, this limit may be increased to sixty (60). In another example, if there was previously a restriction as to what times promotional mailings could be sent out (e.g., only during lunch hours), then these restrictions may be eased or eliminated.

In some embodiments, a portion of profits from the vending machine sales may be distributed to the company.

In some embodiments, the operator or controller may distribute a portion of profits, revenue, or other financial measurement to the company. For example, the operator or controller may distribute any profit in excess of three hundred dollars ($300) per month to the company. As another example, the operator or controller may distribute half of all revenue in excess of five hundred dollars ($500) per month to the company. For instance, if revenue for a month is six hundred dollars ($600), then the operator or controller may distribute half of the amount in excess of five hundred dollars ($500) (equal to 1%×($600−$500), or fifty dollars ($50)) to the company. The operator or controller may use any other desired calculation for funds distributed to the company. For example, the operator or controller may distribute one third of all profits in excess of four hundred dollars ($400) but less than five hundred dollars ($500), and one half of all profits in excess of five hundred dollars ($500), but in no event more than a total distribution of two hundred dollars ($200).

Such funds may be paid to the company in the form of cash, check, or other consideration. Funds may also be distributed towards the company in the form of credits toward future shortfalls. For example, if a company is due one hundred dollars ($100), the operator or controller may withhold the one hundred dollars ($100; e.g., in an account). If, in a succeeding month, the company owes the operator or controller money (e.g., due to a revenue shortfall), then the operator or controller may deduct the funds owed to it from the one hundred dollar ($100) account.

In various embodiments, funds may be distributed to the company in the form of products, or in the form or rights to free products. For example, if the operator or controller owes the company one hundred dollars ($100), then the operator or controller may instead provide the company with one hundred (100) sodas, with each soda presumably valued at one dollar ($1). The operator or controller may provide the company with one hundred (100) unique codes, each redeemable at the vending machine for a free soda. The company may then distribute the codes to its employees as it sees fit. The company may use the codes as reward mechanisms to reward employees.

In various embodiments, such as where a company may be obligated to compensate the operator, or where the operator may be obligated to compensate the company, the controller or vending machine may present the company with an audit report (e.g., of sales, transactions, and/or benefits provided at the vending machine). Such a report may be requested via the vending machine or controller (e.g., through an input device of the vending machine, through a web site of the controller). The report may then be, e.g., printed by the vending machine, transmitted via e-mail by the controller, and/or presented in a browser interface by the controller.

For example, the controller may provide a listing of transactions, including a time, amount paid, amount used for tax, margin, method of payment (e.g., cash, credit), product(s) vended, code received (e.g., in exchange for a free product), person to whom the code was originally given (e.g., via e-mail), and so on. The controller may include any costs in its transaction report, such as the cost of power over the past week, or the cost of labor inherent in restocking the vending machine. The controller may aggregate the figures from various transactions to come up with a total amount of profit made for a sales period, a total amount of revenue for a sales period, and so on.

In various embodiments, if sales goals have not been met, then the operator may remove the vending machine from the company offices.

### VI. Exemplary Interface

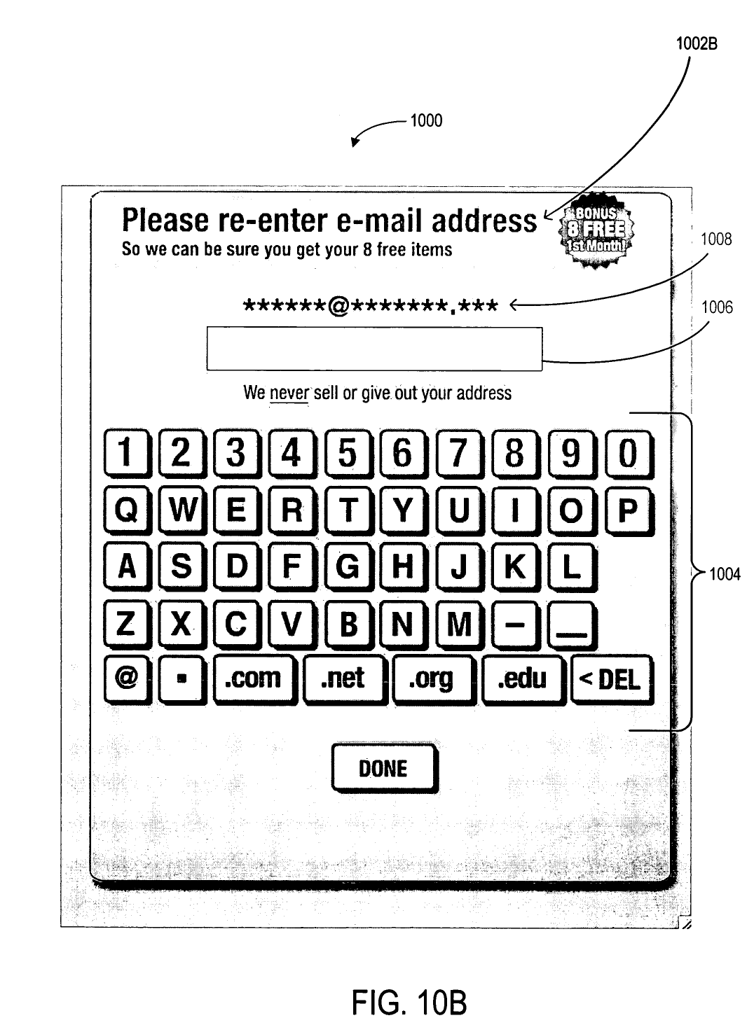

Referring to FIG. 10A and FIG. 10B, illustrations of an exemplary interface 1000 of a vending machine according to some embodiments is shown. The interface 1000 may generally comprise any type or configuration of interface that is or becomes known or practicable. The interface 1000 may, for example, be or include a touch screen interface such as a touch screen interface that functions as an input and/or output device of a vending machine (e.g., and input device 222 and/or an output device 224 of the vending machine 210 of FIG. 2, and/or an output device 324 of the vending machine 310 of FIG. 3).

As shown in FIG. 10A and FIG. 10B, the interface 1000 may be configured to accept e-mail addresses provided by customers. In response to an offer for free products in exchange for the customer's e-mail address, for example, a customer may be presented with the interface 1000, via which the customer may provide and/or indicate the customer's e-mail address to the vending machine. In some embodiments, the interface 1000 may comprise instructions 1002A-B that tell the customer what to do and/or how to properly enter an e-mail address. As shown in FIG. 10A, for example, a first instruction 1002A may simply instruct the customer to enter an e-mail address. Also as shown, the first instructions 1002A may also or alternatively describe the benefit(s) that the customer will or may receive in exchange for the provision of the e-mail address.

The customer may generally utilize the interface 1000 by pressing one or more keys and/or areas on a keypad 1004. The keypad 1004 may, in some embodiments, comprise a standard keypad with separate physical buttons. According to some embodiments, the keypad 1004 may comprise a “soft” keypad, such that an area of the interface 1000, such as an area of a touch screen display, is configured to resemble, simulate, and/or emulate a standard keypad. The keypad 1004 may also or alternatively comprise one or more non-standard keypad buttons such as the “.com” and/or “.edu” buttons that are shown, to facilitate entry of e-mail addresses via the interface 1000.

Generally, as the customer utilizes the keypad 1004 to enter an e-mail address, the e-mail address may be displayed in a text box 1006, such that the customer may visually inspect the entered information (e.g., to ensure correctness). As shown in FIG. 10B, once the customer has entered the e-mail address, the e-mail address may appear in a confirmation area 1008 to indicate the information already entered. As shown, this information may be displayed “securely” by replacing many, most, or all entered characters with an asterisk (“*”). The interface 1000 may also be changed to provide second instructions 1002B, that may indicate, for example, that the customer needs to re-enter the e-mail address for confirmation, verification, and/or consistency purposes.

In such a manner, for example, a customer may be able to easily enter and verify an e-mail address such that the customer may receive promotional messages as described herein. In the example illustrated by the interface 1000 of FIG. 10A and FIG. 10B, for example, the customer, upon providing the e-mail address, may be eligible to receive eight (8) free items in the first month that the customers account becomes active. In some embodiments, codes that may be utilized to redeem these free units of product may be sent, via e-mail, to the customer. According to some embodiments, the customer may simply need to become identified by the vending machine (e.g., by utilizing a thumb and/or fingerprint scanning device) to initiate a redemption transaction.

### VII. Exemplary Promotional Messages

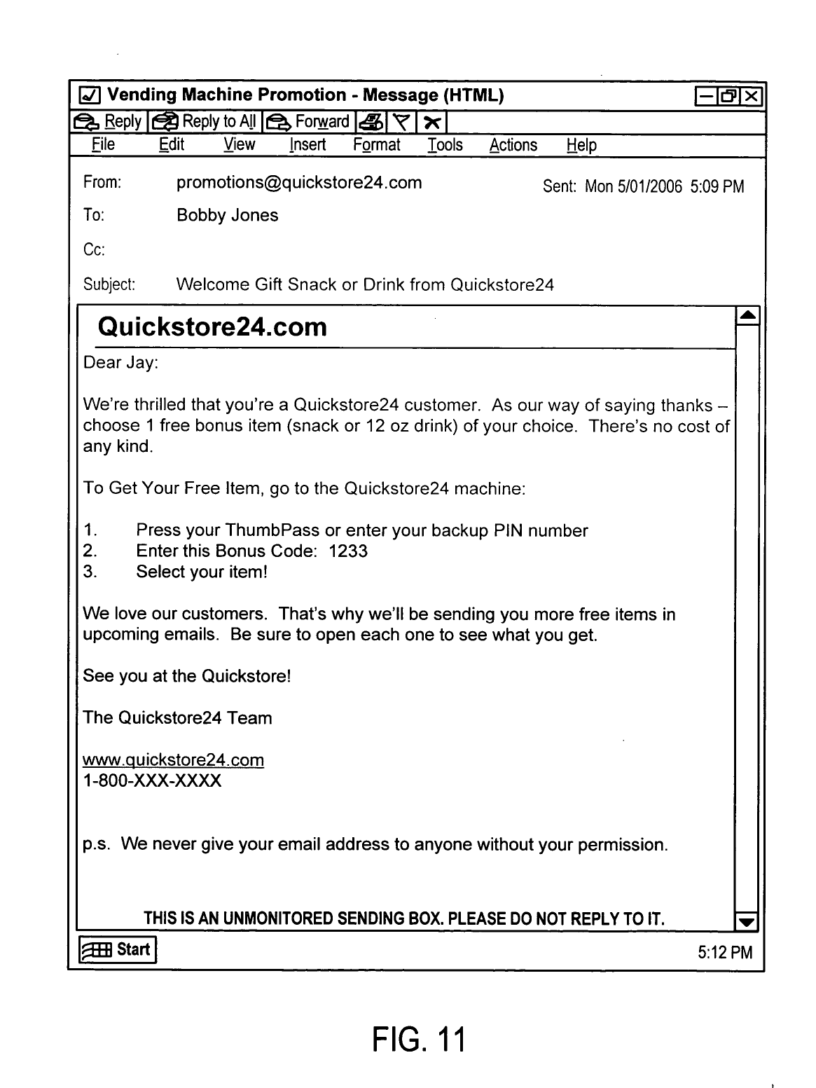

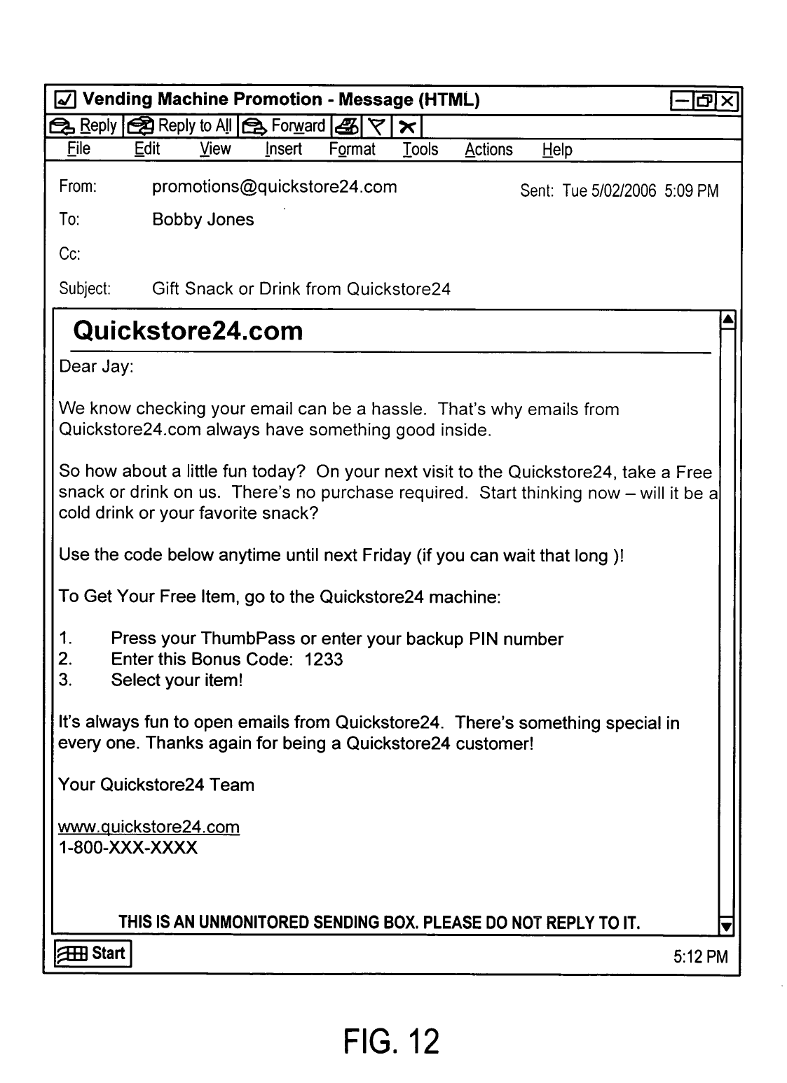

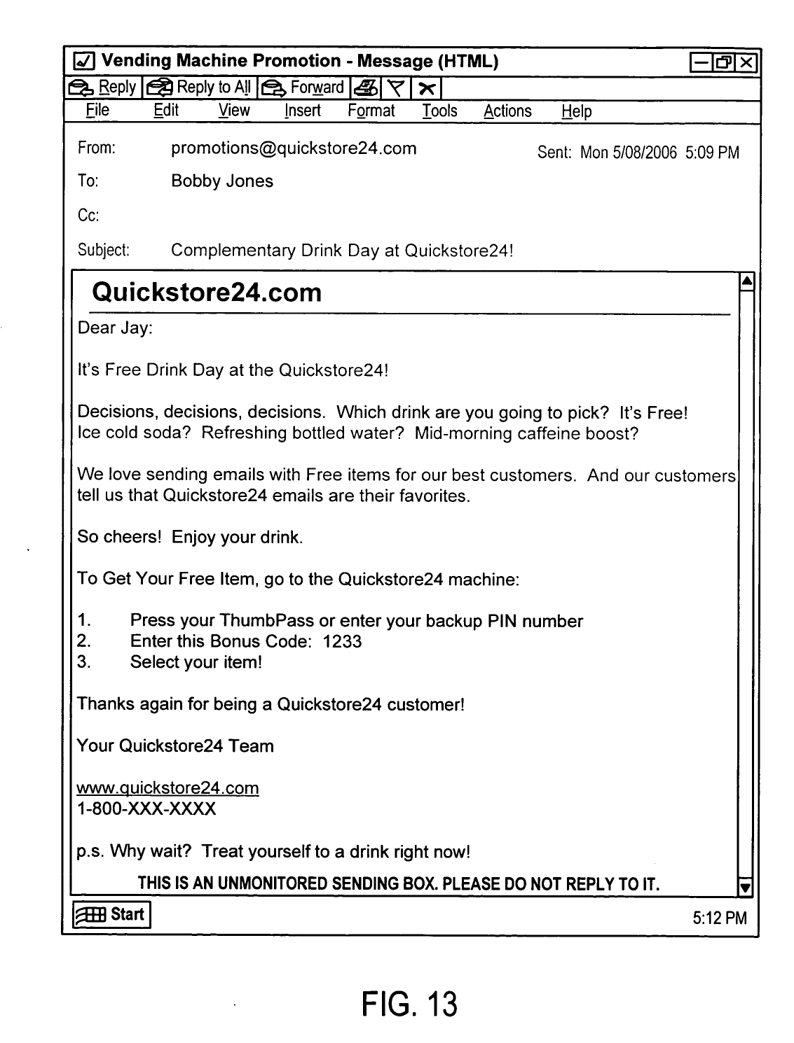

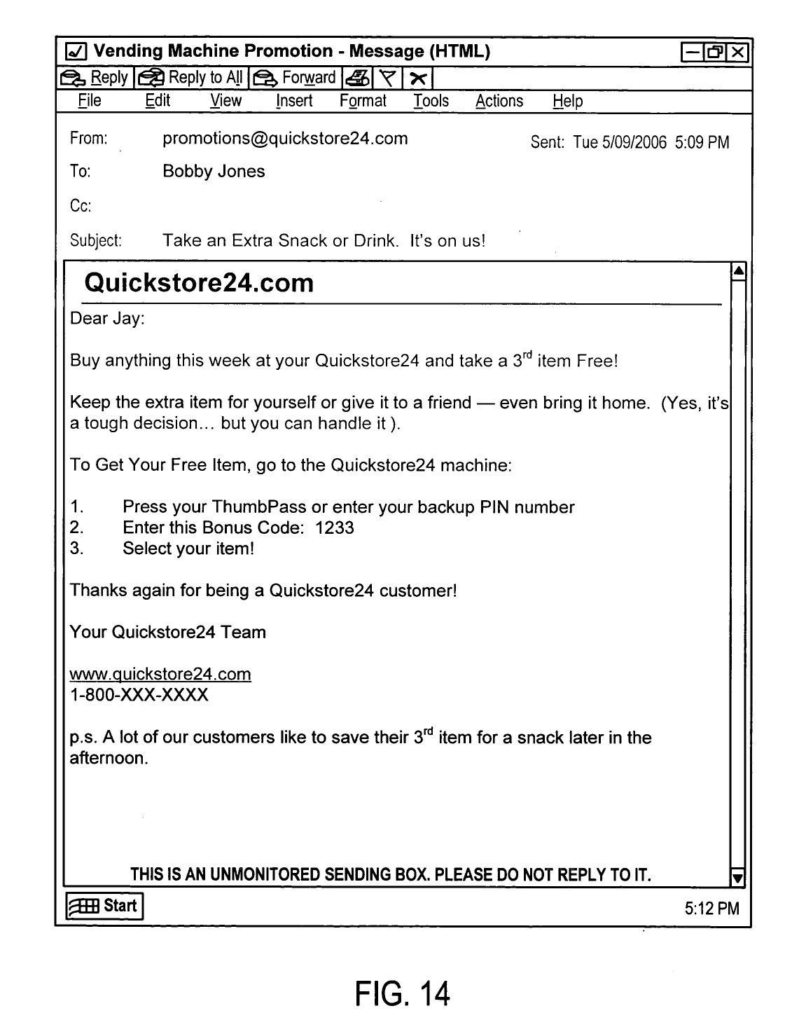

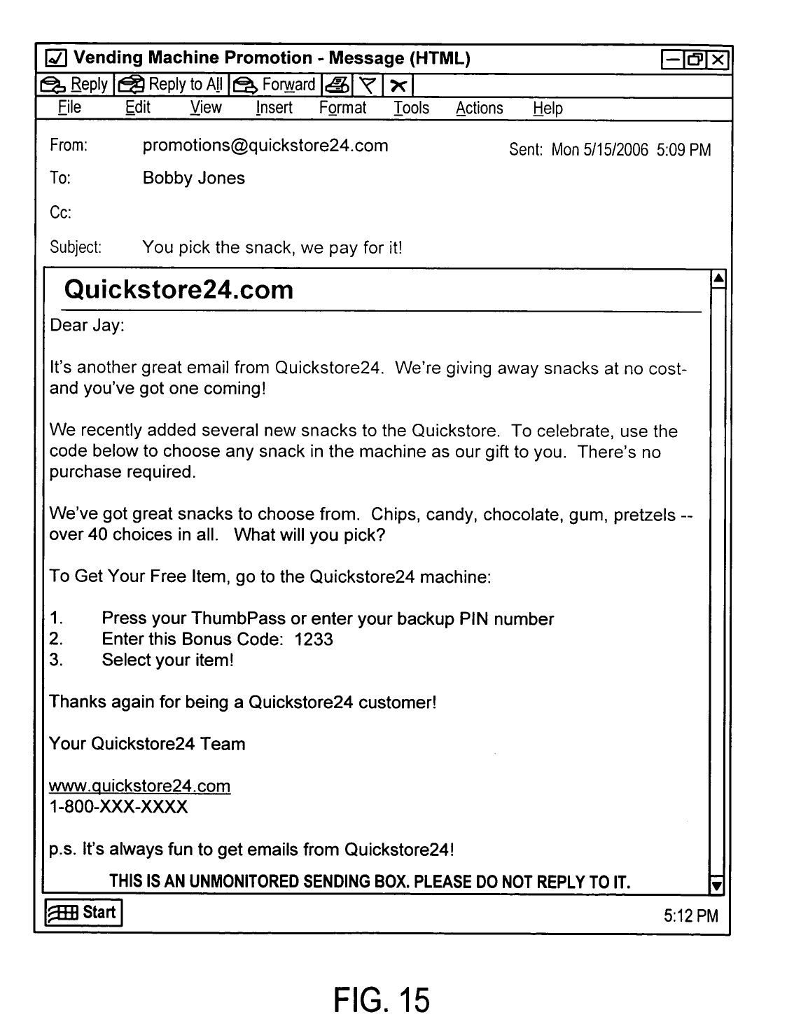

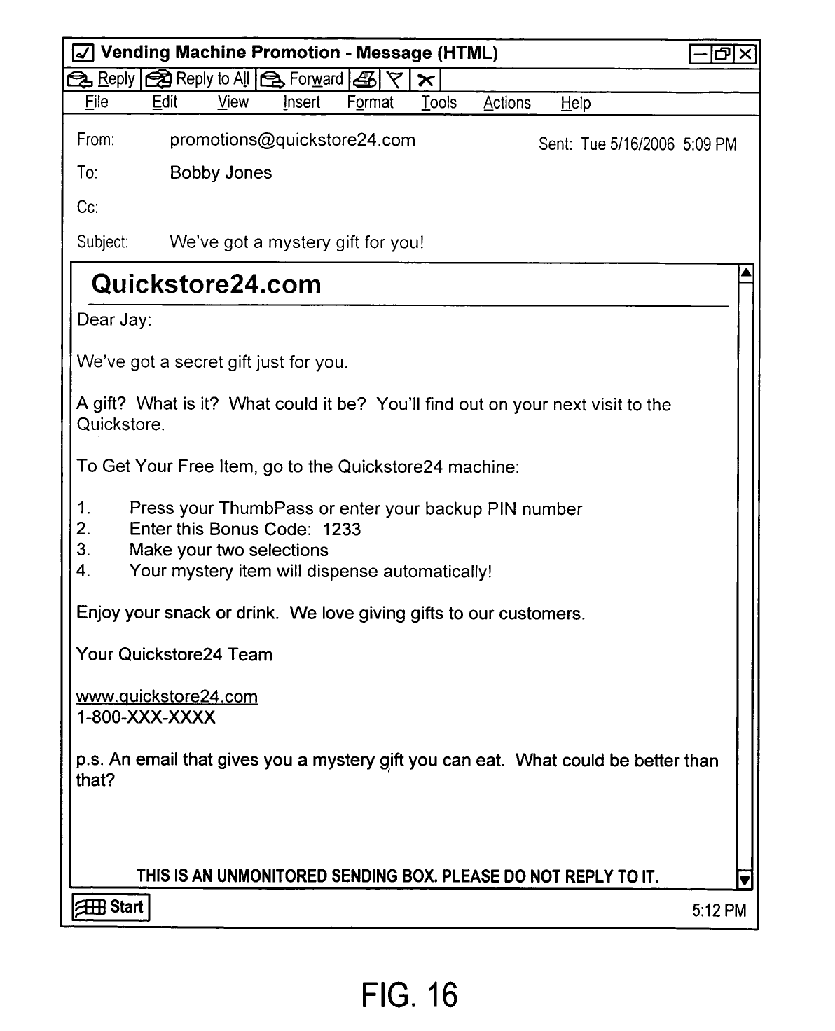

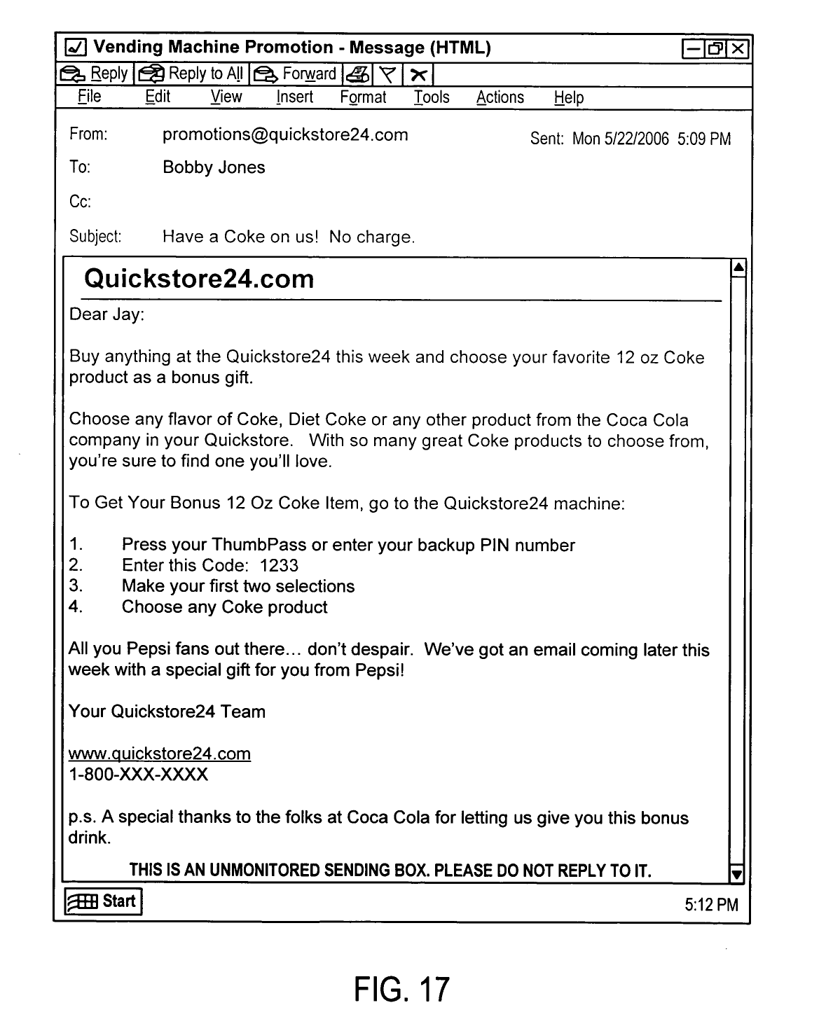

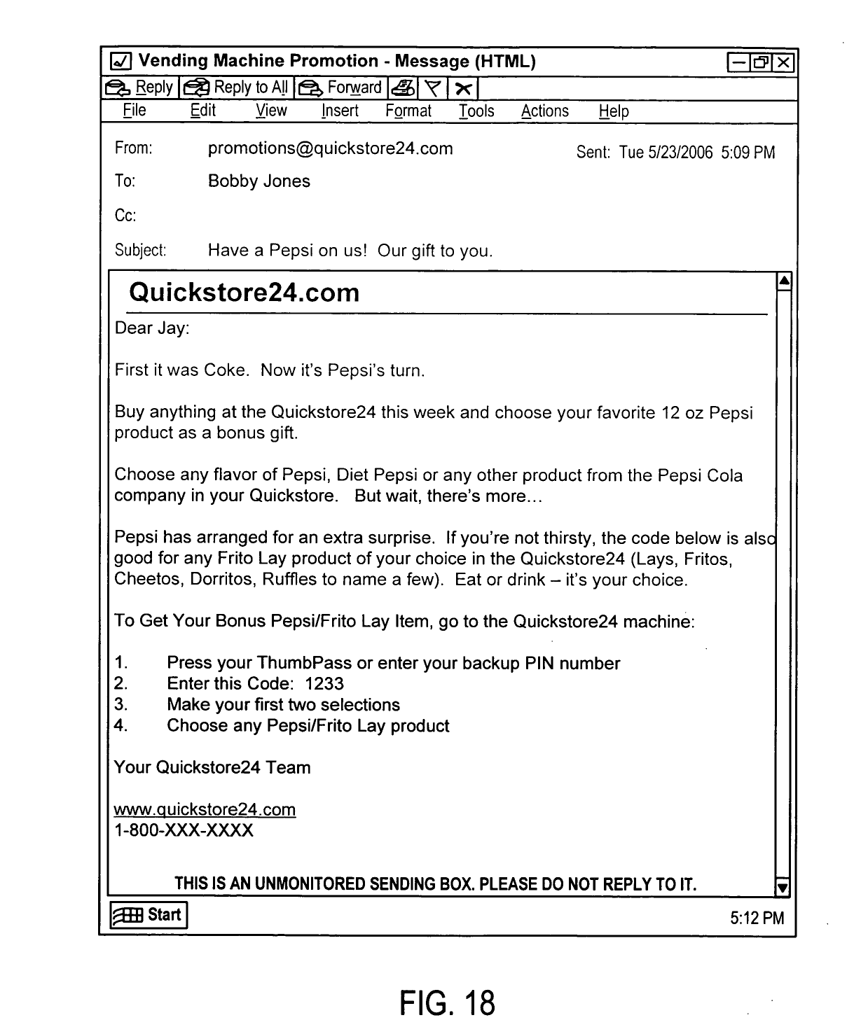

Referring to FIG. 11, FIG. 12, FIG. 13, FIG. 14, FIG. 15, FIG. 16, FIG. 17, and FIG. 18, exemplary promotional messages 1100, 1200, 1300, 1400, 1500, 1600, 1700, 1800 according to some embodiments are shown. The promotional messages 1100, 1200, 1300, 1400, 1500, 1600, 1700, 1800 may, according to some embodiments, be e-mailed to customers to promote sales at one or more vending machines. In some embodiments, the promotional messages 1100, 1200, 1300, 1400, 1500, 1600, 1700, 1800 may also or alternatively be displayed to the customer via an output device of a vending machine (such as via the interface 1000 of FIG. 10A and FIG. 10B).

As described herein, the promotional messages 1100, 1200, 1300, 1400, 1500, 1600, 1700, 1800 may generally be provided in an attempt to convert unfunded account holders to funded account holders (e.g., by encouraging funding of customer accounts) and/or in an attempt to have funded account holders allow automatic funding of their accounts. As shown, such attempts may be facilitated by offering free, bonus, and/or trial units of products to account holders. Other methods of encouraging customers to fund accounts and/or become account holders are described herein.

### VIII. Additional and/or Alternate Embodiments

The following are example alternative variations that illustrate additional and/or alternate embodiments. It should be understood that the particular variations described in this section can be combined with the different embodiments, or portions thereof, described above in any manner that is or becomes practicable. These examples do not constitute a definition or itemization of all possible embodiments. Further, although the following examples are briefly described for clarity, those skilled in the art will understand how to make any changes, if necessary, to the above-described apparatus and methods to accommodate these and other embodiments and applications.

In one embodiment, the controller may be programmed to attempt to obtain contact information of customers or potential customers in other ways. For example, a vending machine may prevent access to all customers except those who have already provided contact information (as described herein) and/or that contact information has been validated (as described herein, e.g., by sending a message to that e-mail address and requiring a response).

In some embodiments, when a person interacts with a vending machine, the vending machine may solicit contact information from the person. For example, the vending machine may request an e-mail address, phone number, home mailing address, etc. The vending machine may solicit contact information by outputting a text message on a display screen, by backlighting a pre-composed message inscribed in the exterior of the vending machine, by outputting a prerecorded voice message, or through any other means. The person may then provide contact information via any number of possible input devices on the vending machine, such as a touch screen.

When soliciting contact information, the vending machine may encourage a person by describing the potential benefits of providing such information. For example, the vending machine may indicate (e.g., via a display device) that the person may be alerted when hot new products come in stock, when there are sales at the vending machine, or when there are various special deals to be had at the vending machine.

The vending machine may also offer immediate benefits to a person who provides contact information. For example, a person may receive a free or discounted product from the vending machine for providing contact information. A person may also receive a coupon or certificate good for future free or discounted products at the vending machine. A person may receive benefits with other merchants as well. For example, a person may receive a certificate from the vending machine that is good for five dollars ($5) off any item at the clothing store where the vending machine happens to be located. The provision of benefits redeemable at other merchants is described in co-pending U.S. patent application Ser. No. 09/714,574, entitled “METHOD OF OUTPUTTING OFFERS AT A VENDING MACHINE FIELD”, which was filed on Nov. 16, 2000, the third-party benefit provision concepts and descriptions of which are hereby incorporated by reference herein.

When soliciting contact information from a consumer, the vending machine may provide various assurances as to how the contact information will be used. For example, the vending machine may indicate that the contact information will not be provided to any other merchants or marketers besides the owner of the vending machine. The vending machine may also assure the customer that he will receive promotional messages at no more than a certain rate, e.g., at no more than two per week. The vending machine may further assure the consumer that he may opt out from the promotional mailing list at any time, and receive no further messages.

A benefit provided by the vending machine in return for contact information may be conditioned upon the fact that the contact information is valid. Therefore, in some embodiments, a vending machine may provide any benefit to the consumer via the channel defined by the received contact information (e.g., an e-mail channel). For example, the vending machine may e-mail a discount coupon to the consumer at the e-mail address provided by the consumer. The vending machine may also e-mail a code to the consumer, wherein the code may be entered to the vending machine at a later time in return for a free product or other benefit (as described herein), subject to any other requirements as described herein (e.g., the code must first be used a minimum number of vending machine transactions). The consumer will thus be able to receive the benefit only if he has provided a valid e-mail address that belongs to him or is otherwise accessible by him.

In various embodiments, a consumer may also supply his e-mail address at a Website, such as at the Website of the controller. A consumer may visit the Website, type in his e-mail address, and indicate that he wishes to receive promotions for vending machines located in a particular geographic region (e.g., in the area near the consumers home or near the consumer's workplace). The customer may also, in the same or different interaction with the web site, indicate one or more vending machines he transacts with or desires to transact with.

In an embodiment, a consumer may transact at a vending machine that instructs the consumer to subsequently send a message, such as an e-mail or telephone call, to the controller or to the vending machine. If the consumer later sends such a message, then the vending machine and/or controller may obtain the consumer's contact information by looking at the e-mail address and/or telephone number from which the message originated. The vending machine may encourage the consumer to send a message to the controller or vending machine by promising the consumer a benefit for doing so. For example, the consumer may be promised a free product at the vending machine if he sends an e-mail to the controller. When the user later sends such a message, the controller may reply with a code, coupon, or other indicia that is redeemable for a benefit at the vending machine.

One benefit a consumer may receive in return for providing an e-mail address or other contact information may be a sweepstakes entry. For example, a consumer may provide an e-mail address at a vending machine and receive a code in return. The consumer may later visit the Website of the controller and type in the code in order to be entered into a sweepstakes drawing. If the consumer wins, then the controller may e-mail the consumer with the good news, ask for the consumer's home address, and then mail the consumer a check for the winnings. In some embodiments, the consumer need not even visit the Website. Rather, the controller may enter the consumer into a sweepstakes drawing directly based on the consumer having provided his e-mail address at the vending machine. The controller may later inform the consumer (e.g., via e-mail) of whether or not the consumer has won.

In an embodiment, employees of a company (or other potential consumers) may provide the controller with parameters for sending promotional information to them. For example, an employee may visit the Website of the controller. At the Website, the employee may answer a question “Inform me when . . . ” after which are listed several check boxes labeled, “1) Items go on sale; 2) New items are introduced; 3) Items run out of stock; 4) Caramel Popcom is restocked; . . . ” The controller may then send promotional e-mails to the employee based on the preferences the employee filled out and based on the status of the employee's local vending machine. In some embodiments, a consumer may provide parameters or preferences while he is at a vending machine using, e.g., keypads or touch screen input devices.

Any of the aforementioned rules, criteria, and limitations for sending e-mails to the employees of a company might vary from employee to employee. For instance, the times at which a controller may send e-mails to employees may be different for night-shift and for day-shift employees. As another example, the controller may be allowed to send only one (1) promotional e-mail per week to any company vice-president, but up to three (3) per week to lower-level employees.

In an embodiment, the controller may be given special privileges or techniques to bypass company spam filters. For instance, Information Technology specialists at the company may work with the controller on the format of the controller's e-mails so that the e-mails will be able to bypass company filters. Information Technology Specialists, or other company employees, may also set the company spam filters to allow the passage of messages from the controller (as indicated by return e-mail address, subject line, etc.). Another way for promotional messages to bypass company spam filters may be for the vending machine to possess its own address or account on a company intranet.

The controller or vending machine may periodically verify that company employees have actually received promotional messages. One method of verification may involve offering a particularly desirable benefit through a promotional e-mail. If the benefit is not redeemed, then the controller may assume that a company employee is not receiving promotional e-mails. For example, the controller might offer a company employee two (2) free products at the vending machine, provided he enters a code from an e-mail. Presumably, such a benefit would be too valuable to ignore, unless a company employee was not seeing the promotional e-mails. Using another method, a vending machine may inquire during a transaction about information contained in a prior promotional message. For example, a vending machine may output three graphics on its display screen, and ask the customer to select the one that appeared in the last promotional e-mail. If customers consistently answer incorrectly, then the vending machine may assume its promotional messages are not being read. Using still another method, the controller may check for changes in sales patterns following the dissemination of a promotional message. If no such changes occur, then the controller may infer that the promotional message has not been seen by company employees, for example.

In various embodiments, a vending machine need not be in direct communication with the controller or even be connected to a communications network. In such embodiments, a vending machine may receive information from the controller (or from another device/entity) via a route operator. For example, a route operator may insert a disk into the vending machine, where the disk contains messages for the vending machine from the controller. Messages may indicate for example, what promotional codes are valid, how many times they may be used, what benefits the vending machine is to provide upon receiving the promotional codes, and so on. The vending machine may then record the use of promotional codes. Later, the vending machine may indicate via the route operator which codes were used, how often they were used, and so on. The vending machine may also report other information via the route operator, such as the total amount of sales for a given sales period, the particular products remaining in inventory, etc.

Other information that may be transmitted to the vending machine via the route operator may include what promotions to offer. For example, the controller may indicate to the vending machine that it should offer fifty percent (50%) off on all cupcakes until they sell out.

The controller may account for possible delays in its transmission of information to a vending machine by timing promotions to occur in the future. For example, suppose the controller is programmed to offer a two-for-one (2-for-1) package deal, where a consumer may buy any two (2) items from the vending machine for one dollar ($1). However, the route operator will not visit the vending machine for another three (3) days. Therefore, the controller may transmit a promotional message to company employees indicating that there will be a two-for-one (2-for-1) package deal at the vending machine in three (3) days (as soon as the route operator can get the message to the vending machine).

In one embodiment, the vending machine and/or controller may instruct a company employee as to how to enable promotions at a vending machine. For example, the controller may instruct the HR Director at a company to enter the code, “932Ix2qa2z” into the vending machine. The vending machine may contain a database of codes and interpretations, and may therefore be able to interpret the aforementioned code as “offer a 20% discount on all carbonated drinks for the next three days.” The vending machine may then implement a promotion without the need to wait for a route operator. The code entered by the HR Director may be valid only once, preventing the HR Director from re-starting the promotion at a later point at his own initiative.

In an embodiment, a promotional message may be directed to a subset of company employees, such as a single company employee, who is charged with encouraging other company employees to transact with the vending machine at the company. For example, the controller may send a message that reads, “Hey Bob! We need to squeeze $80 more in sales from the vending machine in the next three days. See what you can do.” Bob may then promote the vending machine at his company in any way he sees fit. He may send an e-mail to other company employees, he may post signs in the company offices, or he may talk to the company employees to encourage them to transact with the vending machine. For their efforts, the company employees charged with promoting the vending machine may receive special benefits, such as free or discounted products, package deals, or a portion of vending machine profits. In some cases, the company employees charged with promoting the vending machine may be company officials or may otherwise represent the company. Part of the benefits for promoting the vending machine may go to the company as a whole. For instance, a portion of profits from the vending machine may go towards the company holiday party.

In one embodiment, the vending machine, controller a company representative, or other party, may declare a day or a time period to be a “vending drive.” A vending drive may be a time when people are encouraged to make purchases from the vending machine. Progress towards revenue goals may be tracked. Such progress may be displayed at the vending machine and via promotional e-mails. Similarly the onset of the vending drive may be declared via displays at the vending machine and via promotional e-mails. A portion of proceeds from a vending drive may, in some embodiments, go towards a charitable cause.

In one embodiment, promotional messages may be physically attached to vended items. For example, a package of potato chips may have a promotional message stapled to it. When a person then buys the potato chips, the person may read and act upon the promotional message. Promotional messages may be attached to vended products by the route operator who fills the vending machines. In various embodiments, promotional messages may be printed on stickers. Thus, the promotional messages may be affixed to products by pressing the adhesive sides of the stickers to the products.

In various embodiments, an employee or other customer need not pay immediately for a vended product. Rather, the employee may be identified by the vending machine, and a charge for the product may be posted to an account of the employee. The account may be a conventional credit account, where, e.g., the employee owes the controller for purchases. Alternatively, the account may be backed by previously tendered funds (e.g., a 'stored value” account), in which case an amount of a purchase may be deducted from such funds. Alternatively, a company official may be provided with a list of employees who owe money to the vending machine, and the company official may then collect from the employees. In another exemplary embodiment, amounts owed to the vending machine may be deducted from employees' paychecks.

If an account is a credit account, then the employee may be responsible for compensating the controller after predetermined periods of time. For example, at the end of every week, an employee may be responsible for paying the vending machine for purchases he made on credit during the prior week.

The employee may compensate the controller by inserting currency into the vending machine. The employee may also visit a Website of the controller and provide a credit card number. The employee may then authorize the controller to charge his credit card for the amount owed the vending machine. The employee may also insert a credit, debit, or other card into the vending machine. The vending machine may then process a financial transaction in standard fashion known in the art, thereby receiving funds from a financial account of the employee as compensation for items purchased on credit. The employee may further insert a check into the vending machine, the check made out for sufficient funds to cover the week's purchases.

One benefit of allowing a person to pay an aggregate total for purchases at a vending machine is that a number of credit card transactions may be reduced. For example, rather than a person separately charging his credit card for five different candy bars purchased over the course of a week, the person may charge his credit card once for the aggregate cost. The person may thereby avoid the inconvenience of taking out and swiping his credit card on every transaction. The controller may, in turn, avoid expensive credit card processing fees for multiple, small transactions. Such fees may compromise a large percentage of small transactions.

There are a number of other ways in which an employee may compensate the operator for purchases made on credit. An employee may perform work. For example, an employee may answer product survey questions at the vending machine using a touch screen to input his answers.

An employee may also accept a marketing offer. For example, the employee may agree to switch long-distance phone services, in return for which his debt may be waived. An employee may further provide names and or contact information for other people. The controller may then have the opportunity to market to these other people by transmitting a promotional message to the supplied e-mail address, for example. In another embodiment, the amount of employee purchases may be deducted from the employee's paycheck. In another embodiment, an unpaid amount may be deducted from, or charged to a departmental or company account. For example, if an employee does not pay a five-dollar ($5) credit owed by him, then the five-dollar ($5) charge may be posted to a company account. The company may then be responsible for paying the five dollars ($5). The company may, in turn, seek compensation from the employee. In further embodiments, an employee may pay using a PayPal™ and/or various forms of electronic currency transfer.

In various embodiments, an employee with an outstanding charge to his account may be charged interest. For example, the vending machine may have a prevailing interest rate of five percent (5%) per year, compounded weekly. Therefore, an employee may owe more and more interest for every week in which he does not pay an outstanding balance.

To purchase an item on credit, an employee may enter one or more identifiers (e.g., via an input device at the vending machine during a transaction). He may enter a name, phone number (e.g., office extension), birthday, room number, e-mail address, title (e.g., “VP Marketing”), code, or other identifier, including a random identifier. The employee may also purchase on credit using a non-employee-specific account. For example, an employee may make a purchase using an account of the legal department or of the finance department. If the employee is charging a purchase to a non-employee specific account, the employee may be required to enter some authorization code, or some other identifier that proves he has the authority to charge such an account. For example, the employee may enter an identifier proving that he has at least a director level title. Such an identifier may be, for example, a title or a code that has been given out only to employees with director level titles or above. One exemplary use of a non-employee-specific account may be the purchase of multiple items for a meeting. For example, the head of sales may use an account for the sales department to purchase a number of sodas for a meeting.

An employee may identify himself in a number of other ways in order to gain access to an account. An employee may use an electronic access card. For example, a vending machine may be configured to recognize the same access cards that are used by the company offices. The vending machine may be further configured to recognize individual employees from their access cards. An employee may also identify himself through biometric information, such as fingerprints, voiceprints, retinal scans, facial scans, and so on.

In various embodiments, a person may fund an account in advance (e.g., a stored-value account). For example, an employee may insert a twenty-dollar ($20) bill into the vending machine without receiving any change. The employee may then draw upon the twenty dollars ($20) in making further purchases, with each additional purchase deducting from the twenty dollars ($20). The controller may benefit from this advanced funding behavior, because people with funded accounts may be more likely to make purchases. Thus, the controller may provide a person with a funding bonus. For example, the controller may provide an employee with a twenty percent (20%) bonus such that, for example, funding an account with twenty dollars ($20) may result in an account balance of twenty-four dollars ($24). When an employee funds an account, the employee may determine a password that will allow him access to the funds in the future.

In various embodiments, a first employee may fund an account of a second employee. For example, a first employee may insert five dollars ($5) into a vending machine, key in an identifier for the second employee (e.g., the second employee's name), and indicate that the five dollars ($5) is to be added to the second employee's account. Alternatively, the five dollars ($5) may be used to pay off a debt accumulated by the second employee. When a first employee funds the account of a second, the funding may be considered a gift. For instance, a first employee may provide a second with a five-dollar ($5) gift credit at a vending machine in return for the second employee's having covered the first at a meeting. The first employee may even key in a message for the second employee when he indicates a desire to provide funds for the second. An exemplary message might read, “Hey, you did a great job on that project last week. Use this to buy yourself a few cold drinks.—Bob.” When the second employee later keys in an identifier to make a purchase using his account, the message from the first may appear. In any event, a message may appear from the vending machine indicating that another person has provided the second employee with a gift of five dollars ($5). In various embodiments, the gift may be anonymous, and so the second employee may not know the identity of the first employee. As with self-funding events, gifting events may result in bonus funds being awarded. For example, when a first employee gives a second employee a gift of five dollars ($5), the second employee may have six dollars ($6) added to his account, the extra dollar courtesy of the controller.

In various embodiments, an employee may purchase a gift certificate on credit. For example, an employee may insert ten dollars ($10) into the vending machine. The vending machine may then print out a gift certificate for ten dollars ($10). The employee may then give the gift certificate to another person. The other person may then purchase vending items by inserting the gift certificate into the vending machine, or by entering a code on the gift certificate into the vending machine. Of course, a person need not buy a gift certificate on credit. Additionally, a vending machine may add a bonus amount to a gift certificate. For example, a person may purchase an eleven-dollar ($11) gift certificate for ten dollars ($10).

For embodiments in which people may make purchases on credit, honest behavior may be more likely when people are making purchases at a vending machine within their own company. By acting dishonestly, e.g., by making purchases on credit without intending to repay the credit extension, or by attempting to use someone else's account without permission, a person might jeopardize his standing at a company. Therefore, embodiments in which a person may make purchases on credit, or where a person may fund an account in advance, are particularly well suited to situations where a vending machine is internal to a company. Furthermore, fraud may be avoided if a company official has the ability to access or track account records. For example, if the Human Resources director can see that a given employee has a large unpaid debt to the vending machine, the person may be more likely to repay the debt.

The status of an employee's account may be sent to him periodically by the controller. A status may include recent purchases made, amounts owed, or funds available for future purchases. The status report may include amounts of accrued interest, bonus amounts added to the account, or gifts added to the account. The status report may include warnings about suspension of privileges. For example, a user will not be allowed to make further purchases on credit unless he pays off prior purchases. The status report may indicate a manner in which the employee may pay off prior purchases, such as e.g., visiting a Website of the controller and entering a credit card number, or inserting currency at the vending machine. The status report may also include a message that a password or other account access code is expiring and/or should be changed within a certain time period.

Employee accounts may be set up by employees themselves. For example, a person may set up an account by visiting the Website of the central controller and by typing in an identifier (such as a name) and an access code or password. The identifier and password may later be keyed into the vending machine in order to access the account. For example, the identifier and password may later be keyed in to allow the employee to make purchases on credit, or to make a deposit to his account. Alternatively, an identifier or password alone may be sufficient for accessing an account. At the Website of the central controller, the employee may also provide a financial account identifier or other means to fund his account. The employee may or may not authorize automatic deductions from the financial account for purchases made on credit. In various embodiments, an employee may also set up an account at a vending machine. Here too, the employee may choose an identifier and password, and may enter financial account information.

In various embodiments, a person's account with the controller may be set up automatically by the controller due, e.g., to the person's status as an employee of a company in which the controller has placed a vending machine. For example, when the controller first agrees to place a vending machine in a company, the controller may obtain a list of the company employee e-mail addresses. The controller may then set up accounts automatically with the e-mail addresses serving as identifiers or access codes to the account. An employee may subsequently purchase an item from the vending machine on credit by simply entering his e-mail address at the vending machine. In some embodiments, a company may provide guidance to the controller over which accounts should be set up automatically. For example, the controller may indicate that accounts should be set up automatically only for employees with more than one year of work experience at the company. Other third parties besides an employer may likewise direct the establishment of an account for another.

In some embodiments, an employee account may be set up automatically, but the employee may still be required to activate the account. Activating an account may include agreeing to certain terms or conditions. Agreeing may include agreeing to pay the balance of an account periodically, agreeing not to share passwords or account identifiers, agreeing not to use other people's accounts, and so on. Activating an account may also include determining an identifier and access code or password.

In various embodiments, when an employee first activates or first uses an account, the controller may automatically add funds to the employee's account. For example, the controller may automatically put three dollars ($3) into a person's account when he activates it. In this way, the person may make three dollars ($3) worth of purchases, without having to insert any money, and without owing anything. This may acclimate a person to making purchases without depositing money.

In various embodiments, the controller and/or vending machine may allow users to have accounts by tracking one or more of: (i) a user financial account identifier, such as a credit card or debit card number; (ii) a credit limit for user (e.g., a limit on a total amount of purchases a user can make at a vending machine without paying immediately); and (iii) an amount currently owed by a user based on previous purchases made on credit. The controller may track the aforementioned information in a database such as the customer database 600 of FIG. 6. For example, tracking a user financial account identifier may allow the controller to bill the financial account for the total price of purchases made on credit by the user during a given time period. Additionally, the controller may track a user identifier, password, and/or access code; an interest rate that is to be applied to unpaid balances; a schedule of times when a user is obligated to repay outstanding balances; a minimum payment amount or percent that indicates, for example, the minimum amount of an outstanding credit balance that a user must repay at a given time; contact information for an official at the user's company or for some other party that may be able to influence the user to repay outstanding balances; and so on.

In an embodiment, a controller and/or vending machine may treat the recipients of messages as two or more different groups of people. For example, the controller may send different promotional messages to the accounting department of a company than are sent to the legal department of the company. The controller may use this distinction between groups of people to promote some friendly competition. For instance, the controller may encourage the accounting department to buy more at the vending machine than does the legal department. At the same time, the controller may encourage the legal department to buy more than does the accounting department. At the end of a designated period, such as at the end of a month, the controller may provide a benefit to the group that has collectively made the most purchases. For example, if the accounting department bought one hundred beverages as a whole, and the legal department bought eighty beverages as a whole, then each person in the accounting department may be rewarded with a free beverage at the vending machine. Other exemplary groups of people might be managers, non-managers, men, women, new employees, senior employees, employees of a first company, employees of a second company, people with names beginning with “A” through “M”, and so on. In addition to increasing the sales at a vending machine, the group competition may lead to more cohesion in general among groups of people at a company.

The operator, controller and/or vending machine may also single out various groups as a way to make the group members feel important. For example, the controller may send a promotional message to the accounting group indicating that there is a two-for-one package deal going on today, just for accountants. The controller may provide a unique code in each message to a member of the accounting department, so that only members of that department may obtain the package deal. The employees of the accounting department, upon receiving such a promotional message, may feel especially privileged and may therefore be more likely to obtain the two-for-one package deal.

In various embodiments, two or more groups may attempt to promote sales at the vending machine. Each group may have an associated code. Whenever a code is inputted into a vending machine during a transaction, the corresponding group may get credit for the transaction. Thus, members of a group may recruit friends and coworkers and others to make purchases at the vending machine, and to use the group's code, in order that the group may get credit for the transaction. At the end of a designated period, the group associated with the most number of transactions may win a prize. The promotion of vending machines by non-owners is described in U.S. patent application Ser. No. 09/688,372, entitled “METHOD AND APPARATUS FOR FACILITATING PROMOTION OF SALES AT A VENDING” which was filed on Oct. 10, 2000, the third party promotional concepts and descriptions of which are hereby incorporated by reference herein.

The operator, controller and/or vending machine may, in various embodiments, provide money or other benefits to a charity or other organization. The controller may base the donations on sales at a vending machine. For example, the controller may donate five percent (5%) of all profits at a vending machine to a charity. As another example, the vending machine may donate forty percent (40%) of revenue received from the sale of a particular item, such as Arctic Ice Cream Bars. As a third example, the vending machine may donate twenty percent (20%) of all revenue received at a vending machine during a certain promotional period, such as during the two hours (2-hrs) before a restocking event.

The controller and/or vending machine may emphasize in promotional messages that a portion of sales at the vending machine will benefit charity. For example, a promotional message may say, “If you buy something from the vending machine by the elevator in the next hour, ten cents will go to supporting the Special Olympics.” Knowing that their purchases are contributing to a worthy cause, people may be encouraged to make purchases at vending machines.

In various embodiments, charitable donations from revenue at a vending machine may be based only on purchases in which a customer submits a code. For example, the controller may send a promotional message that includes a code to be entered by customers who wish a portion of their purchases to go to charity. A user who receives such a message may visit a vending machine, make a purchase, and enter the corresponding code. The controller may then donate a portion of the purchase price paid by the customer to charity. In some embodiments, there may be multiple possible codes for a customer to enter. Each code may correspond to a different charity. The customer may indicate a desired charity to receive the donation based on the code he enters.

In various embodiments, employees at a company may come to a joint agreement as to the charity to which a vending machine will donate. For example, employees at the company may vote on the charity. Each employee may indicate a desired charity by, for example, replying to a promotional message with a particular charity indicated (e.g., written in the subject line of the reply), by visiting the Website of the controller and selecting a charity, by indicating a charity at the vending machine (e.g., by entering the name of a charity with a touch screen keypad), or in some other manner. In some embodiments, an employee's sway in the selection of a charity will depend on his purchase history at the vending machine. For example, an employee may be entitled to one (1) vote for every one dollar ($1) he has spent at the vending machine in the past week.

The ability of employees or other customers of a vending machine to participate in the selection of a charity may make them more actively interested in the vending machine, and therefore more likely to make purchases. In addition, the employees are more likely to care about the charity that is ultimately selected, and may therefore be more likely to make purchases that will benefit the charity.

In various embodiments, a vending machine may print out a promotional message consisting of a game piece or game entry (and/or e-mail such a game piece or entry). For example, a user may collect such game pieces and try to obtain a complete set of a particular type of game piece (e.g., a complete color group in a Monopolythemed game).

In various embodiments, a vending machine may print out a promotional message for any customer that walks by, even if the customer does not engage in a transaction at the vending machine. The vending machine may, for example, have a promotional message perpetually dangling from a message printer. If the message is taken by a passer-by, the vending machine may print out a new message to dangle for the next passer-by.

In various embodiments, a vending machine may produce printed promotional messages after every transaction at a vending machine, so that customers become accustomed to receiving such promotional messages from the vending machines.

In various embodiments, a first consumer may derive benefit at a vending machine from encouraging a second consumer (e.g., a friend) to make a purchase at a vending machine. When a person transacts at a vending machine, the person may have the opportunity to indicate the person who encouraged him to visit the vending machine. For example, when Bob makes a purchase at a vending machine, Bob may key in the e-mail address for Linda Brown, “lbrown@sunrise.com”, in order to give Linda credit for referring him.

One person may indicate another in various ways. The referring party may be indicated by his or her name, e-mail address, phone number, pseudonym or handle, or by an identifying code. An identifying code may be provided to e.g., an established customer of the vending machine. Such an identifying code may uniquely identify the customer. The customer's friend may then indicate the customer as a referring party by keying in the customer's identifying code when making a purchase from the vending machine.

A referring customer may benefit in a number of ways. The referring customer may receive free or discounted products, two-for-one specials, special notices about the presence of new products, entries into sweepstakes drawings, and so on. The referring customer may receive a benefit whose magnitude is related to the number of customers he refers, to the number of customers referred by the customers he refers (ad infinitum), to the amount of purchases made by customers he refers, etc. For example, a customer may receive twenty cents off the purchase price of an item for every customer he refers.

A promotional message sent to a customer may therefore pertain to the customer's referral history. For example, a promotional message may thank a customer for the five people he has referred in the past week. The promotional message may further indicate a benefit to which a customer is entitled based on the referrals he has made. A promotional message, such as a message to a new customer, may indicate that the person referring the new customer has been given adequate credit. For example, a message may say, “Thanks for trying the HealthNut vending machine. We have given your friend Linda credit for referring you.”

In various embodiments, a benefit to which a customer is entitled pursuant to a promotional message may change based on one or more conditions, such as the passage of time, weather, sports scores, interest rates, etc. Thus, a customer may receive a code in a promotional message, and may choose not to redeem the code unless or until a certain condition has been satisfied, which may in whole or part determine the value of the corresponding benefit. For example, a customer may hold onto a code provided in a promotional message until the stock of The Hershey™ Company surpasses one hundred dollars per share ($100/share), at which point the code may entitle the customer to fifty percent (50%) off any Hershey's™ product inventoried in a vending machine.

In various embodiments, a consumer may build towards a benefit through a series of transactions. For example, a consumer's eleventh item at a vending machine may be free. Thus, through ten (10) purchases, a consumer is building towards earning a free eleventh item. Exemplary benefits include free or discounted products, two-for-one (2-for-1) deals, free downloads from the vending machine, and so on.

A consumer's purchases may be tracked by the controller or vending machine. For example, each time the consumer makes a purchase, he provides an identifier, allowing the vending machine to add one (1) to a tally of his purchases. A consumer's purchases may also be tracked on a card the consumer may carry with him. For example, the consumer may carry a plastic card, which he inserts into the vending machine during each transaction. The vending machine may alter the information stored on a magnetic stripe of the card to indicate that the customer has completed another purchase. The vending machine may also alter the card by making a physical marking, such as punching a hole in the card, placing a stamp on the card, or nicking the edge of the card. The card may also include a smart card, in which case the vending machine may download updated information into the memory of the card with each purchase.

A consumer who is “building” towards a benefit may be motivated to continue returning to a vending machine, at least until he has received the benefit. Further, the consumer will be motivated to make a purchase at a particular vending machine, the one providing him with a benefit, rather than at any other.

Promotional messages may accordingly include information about a consumer's progress towards earning a benefit. For example, a promotional message may say, “Jane, great news! You need to make only three more purchases at the elevator vending machine before you can take a free Coke®!” In addition, promotional messages may advertise the fact that a person can work towards earning a benefit at a vending machine.

According to one embodiment, a location (e.g., a company) is identified and/or selected as having a potentially profitable location for one or more vending machines. A company (e.g., a law firm, accounting firm, manufacturing company, consulting firm, doctor partnership, government agency, nonprofit organization, school, university) may include a division of a company, a subsidiary of a company, a spin-off of a company, and the like. In various embodiments, a company may include any group of people who perform at least some work for a common organization, or who work in the same locale, facility, or complex. In addition, a company may include a group of companies.

In an embodiment, the company may possess an “office” where one or more employees of the company reside at one time or another. An office includes space in a building, a factory floor, a worksite, such as a mine, a farm, a construction site, a forest where trees are harvested, a distribution center, an airport, or any other physical locale where work is performed.

In various embodiments, an operator may identify a company according to one or more criteria (e.g., criteria reflecting the potential profitability of a vending machine placed with the company). The operator may identify/select potential companies manually, and or utilizing any of a number of known computer-based demographic targeting systems. The criteria may include one or more of:
a) The number of employees is within a desired range;
b) The average number of customers who visit the company offices per day is within a desired range;
c) The number of employees with access to e-mail at work is within a desired range;
d) The number of employees at a particular office (e.g., the company's headquarters) of the company is within a desired range;
e) The size (e.g., by the number of square feet) of a particular office of the company is within a particular range;
f) The typical working hours of employees at the company span a certain range (e.g., typically work late, typically work more than ten hours per day);
g) Whether one or more sources of food (e.g., cafeteria, restaurants, vending machines) are already available (e.g., in or near the offices of the company);
h) Whether there are certain types of food sources (e.g., snack food vending machines, beverage vending machines) available;
i) Whether one or more sources of water (e.g., water fountains, water coolers) or other drink are available;
j) Whether certain types of work performed, such as intense physical labor or exclusively computer-based data entry;
k) Whether the average temperature and/or peak temperature at the company is within a certain range;
l) Whether the average humidity/peak humidity at the company is within a certain range;
m) Whether company offices are used by other organizations (e.g., a Boy Scout troop); and/or
n) The location of the company, such as whether a vending machine placed at a company would be easier to stock and service.

Such criteria, as well as others, can indicate the types of vending machine that may be most successful. For example, if there are not many food sources available at or near a company, then a snack vending machine may be expected to be particularly profitable at the company. If company employees perform intense manual labor, then it may be expected that the employees would frequently become thirsty, and would therefore be likely to buy beverages from a vending machine. If many company employees have e-mail access, then sales at a vending machine may be increased by sending e-mail promotions to the employees, as is described herein.

Various embodiments may include receiving information about one or more companies before a company is determined or chosen. The operator or controller may receive information from a number of sources. Sources may include company filings, such as annual reports. Sources may include company Websites. Sources may include directory listings, such as listings in a phone book. Sources may include company employees. For example, a representative of the controller may contact a company employee by phone and ask for information about the company.

In some embodiments, the company may submit information via a Website of the operator. For example, the company may request a vending machine from the operator. Accordingly, a company representative may visit the Website of the operator and may provide any information required by the operator in order for the company to be considered as a potential recipient of a vending machine. The company representative may provide such information as the company location, the desired type of vending machine (e.g., snack, beverage), the number of employees, and any other information that may be useful for the operator in deciding whether to place a vending machine with the company. The Website may contain forms with fields into which the representative is to enter information about the company. Certain fields may contain required information (e.g., information about whether or not the company wants a vending machine) and other fields may contain optional information (e.g., the demographic breakdown of company employees). The Website may additionally or alternatively include check boxes, menus, radio buttons, or other input mechanisms.

In some embodiments, prior to a company representative visiting a Website of the operator, the operator may actively market to companies. For example, the operator may send a brochure to a company advertising the benefits of having a company vending machine. The brochure may direct a company representative to the Website of the operator. The controller may also market by sending e-mail messages or by sending a salesperson to visit the company.

The operator may maintain a database of companies and associated company information. If or when the operator has an opportunity to place a new vending machine (e.g., the operator has constructed or received a new vending machine), the operator may access its database of companies, determine which company is likely to generate the most profits for the operator, and decide to place the vending machine in the determined company. Many other criteria for selecting a company may also be employed by the operator.

In some embodiments, a company representative may identify one or more people relevant to the interaction between the operator and the company. For example, the company representative may indicate the identity of:
a) A company employee who will screen promotions sent by the operator;
b) A company employee who will be responsible for paying the operator for the use of the vending machine, for a revenue shortfall of the vending machine, or for any other reason;
c) A company employee who will encourage the use of the vending machine within the company;
d) A company employee who will be responsible for displaying company bulletins on the vending machine;
e) A company employee who will lead a group whose goal it is to make a minimum number of purchases from the vending machine;
f) A company employee who will provide the operator with contact information for other company employees;
g) A company employee who will fill or restock the vending machine;
h) A company employee who will perform maintenance on the vending machine; and/or
i) A company employee who will contact the operator to make requests for new products, for maintenance to be performed, for the vending machine to be moved, or for various other tasks to be accomplished.

The operator may later interact, as appropriate, with the people identified by the company representative. For example, the operator may later forward promotional e-mails to the employee designated to screen the e-mails.

In some embodiments, once a company representative has been in communication with the operator, such as via the operator's Website, the operator may generate an agreement or contract describing a potential relationship between the company and the operator. The agreement may be generated based on information provided to the operator by the company representative. For example, the company representative may indicate a number of employees at the company. The operator may then apply a formula to derive an expected amount of revenue to be made from placing a vending machine at the company. For example, based on the company having fifty (50) employees, the operator may determine that a vending machine placed at the company would be expected to make ninety dollars ($90) per week in revenue. The operator may require, however, that a vending machine receive at least one hundred dollars ($100) per week in revenue. Therefore, the operator may determine as part of the contract that the company must pay the operator ten dollars ($10) per week in order to have the vending machine stationed at the company. Alternatively, the operator may determine as part of the contract that the company must pay the operator the difference between one hundred dollars ($100) and the actual amount of revenue received, and need not pay anything if revenue exceeds one hundred dollars ($100).

A contract generated by the operator may be displayed on the operator's Website. The company representative may have the ability to view and to sign the contract on the Website. For example, supplying a signature may consist of supplying the initials of the company representative or of supplying an electronic signature. Alternatively, the company representative may print out the contract, sign it physically, and mail it in to an address of the operator. In some embodiments, the company representative may enter in an account number for the company. The account number may be a credit card account number. The company representative may authorize the operator to deduct funds from the company account in accordance with the contract between the company and the operator.

In various embodiments, the operator may determine a location other than a particular company. The location may be determined based on its proximity to one or more companies. The location may also be determined based on any of the other factors described above. If the location determined by the operator happens to be owned or controlled by a particular company, then the operator may negotiate with the company for the placement of a vending machine at the location.

To supply machines to one or more buildings of an office park, or to every building of an office park, the operator may negotiate with a property manager or property owner for the office park.

An appropriate vending machine may already be located in a desired proximity to the company offices. The operator may place a vending machine in proximity to the company offices, or retrofit an existing vending machine located in proximity to the company offices. Exemplary locations for the vending machine may include:

a) A lobby of the company offices;

b) A kitchen or cafeteria of the company offices;

c) Near an entrance or exit of the company offices;

d) Near an elevator shaft of the company offices;

e) A main hallway or corridor of the company offices;

f) Across the street from the company offices; and/or

g) In the building in which the company offices are located.

In various embodiments, the vending machine may be co-branded with the company. For example, if the vending machine is of a type that serves “Susan's Snacks” and the company is “Vanadium Enterprises,” then the vending machine may carry the two brands together, e.g., “Susan's Snacks and Vanadium Enterprises.” Employees of the company may be more trusting of a vending machine that has the company branding on it. For example, employees may trust that personal information will not be abused. Employees may also trust that they will not receive unsolicited marketing messages if they provide their e-mail addresses or other contact information.

When a vending machine is co-branded with the company in which it resides, the vending machine facade may contain color schemes, patterns, signage, and other markings that are hallmarks or trademarks of the company. For example, if the company at which the vending machine resides has a white and purple logo, then the vending machine facade may also be colored in white and purple. The vending machine may thereby fit in with general decor of the company. The vending machine may therefore be more acceptable, and not viewed as out of place in e.g., an elegant setting. Of course, a vending machine facade may also be made to match the colors of surrounding walls or furniture (e.g., a wood-grain surface), even if these colors are not those associated with the company in the public's mind. Such a consistency would again serve to make the vending machine less obtrusive.

A further advantage of co-branding a vending machine with the company's logo is that the vending machine may be understood to play a role in the company's function. For example, a vending machine may post messages for company employees on a display screen. For instance, remember to get your flu shots today.”

A further advantage of a co-branded vending machine is that employees may be less inclined to try to cheat the vending machine. For instance, if an employee purchases a product on credit, the employee may feel as if he owes money to his company rather than to some unknown vending operator. The person may thereby feel a greater obligation to repay the debt.

A further advantage of co-branded vending machine is that employees may be less inclined to abuse the vending machine by, for example, banging on the vending machine when a product does not immediately fall out.

### IX. Rules of Interpretation

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this patent application) nor the Abstract (set forth at the end of this patent application) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” means any one or more microprocessors, CPU devices, computing devices, microcontrollers, digital signal processors, or like devices.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

Some embodiments can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present disclosure.

What is claimed is:

1. A method, comprising:
providing an offer, via an interface at a vending machine, for a free unit of a product in exchange for an e-mail address associated with a customer;
receiving, via the interface at the vending machine, the e-mail address associated with the customer; and
transmitting, after receiving the e-mail address associated with the customer, a promotional message to the e-mail address associated with the customer, wherein the promotional message comprises an indication of a code that may be utilized to redeem the free unit of the product.

2. The method of claim 1, further comprising:
creating an account associated with the customer, the account being credited with the free unit of the product.

3. The method of claim 2, further comprising:
receiving, via the vending machine, the code that may be utilized to redeem the free unit of the product;
dispensing the free unit of the product; and
updating the account associated with the customer, the account being debited for the dispensed free unit of the product.

4. The method of claim 3, further comprising:
validating the code that may be utilized to redeem the free unit of the product.

5. The method of claim 2, wherein the promotional message comprising the indication of the code that may be utilized to redeem the free unit of the product is a first promotional message, further comprising:
transmitting, after receiving the e-mail address associated with the customer, a second promotional message to the e-mail address associated with the customer, wherein the second promotional message comprises a request that the customer fund the account associated with the customer.

6. The method of claim 5, wherein the request that the customer fund the account associated with the customer comprises an offer for a subscription to one or more products offered for sale by the vending machine.

7. The method of claim 5, further comprising:
receiving an indication of a funding of the account associated with the customer, the funding defining a funding amount;
determining a number of product units corresponding to the funding amount; and
updating the account associated with the customer, the account being credited by the determined number of product units corresponding to the funding amount.

8. The method of claim 7, wherein the indication of the funding comprises an indication of a credit card account, further comprising:
charging the funding amount to the credit card account.

9. The method of claim 8, further comprising:
determining that a number of product units available in the account associated with the customer is less than a pre-determined threshold;
automatically charging the credit card account, after the determining that the number of product units available in the account associated with the customer is less than the pre-determined threshold, an amount for the purchase of a number of additional product units; and
updating the account associated with the customer, the account being credited by the additional number of product units.

10. The method of claim 2, wherein the promotional message comprising the indication of the code that may be utilized to redeem the free unit of the product is a first promotional message, further comprising:
determining an expiration date after which the customer is not permitted to redeem the free unit of the product;
determining a pre-determined proximity of a current date to the expiration date; and transmitting, after receiving the e-mail address associated with the customer, a second promotional message to the e-mail address associated with the customer, wherein the second promotional message comprises a reminder that the customer must redeem the free unit of the product prior to the expiration date.

11. The method of claim 1, wherein the promotional message comprising the indication of the code that may be utilized to redeem the free unit of the product is a first promotional message further comprising:
transmitting, after receiving the e-mail address associated with the customer, a second promotional message to the e-mail address associated with the customer, wherein the second promotional message comprises information describing a current inventory of the vending machine.

12. The method of claim 1, further comprising:
validating the e-mail address associated with the customer.

13. The method of claim 1, further comprising:
determining, based on sales data from the vending machine, to provide the offer for the free unit of the product in exchange for the e-mail address associated with the customer.

14. The method of claim 1, further comprising:
determining, based on inventory of the vending machine, to transmit the promotional message.

15. The method of claim 1, wherein the interface at the vending machine comprises a touch screen interface.

16. The method of claim 1, wherein the free unit of the product comprises a free unit of a trial product.

17. A method, comprising:
associating a customer of a vending machine with a biometric identifier;
receiving, at the vending machine, and indication of the biometric identifier;
determining, based on the received biometric identifier, a profile associated with the customer;
updating the profile associated with the customer based on an interaction of the customer with the vending machine;
determining, based at least in part on the updated customer profile, a promotional message; and
providing the promotional message to the customer.

18. The method of claim 16, wherein the promotional message comprises at least one of: (i) an indication of a current inventory of the vending machine; (ii) an indication of a current inventory of another vending machine; (iii) an indication of a restock event at the vending machine; (iv) an offer for a subscription to one or more products offered for sale via the vending machine; (v) an offer for a membership to the vending machine; (vi) an indication of a sweepstakes entry; and (vii) an indication of a game piece.

19. The method of claim 16, wherein the interaction of the customer with the vending machine comprises a purchase, by the customer, of a unit of a particular product from the vending machine, and wherein the promotional message comprises at least one of: (i) an offer for a subscription to the particular product; (ii) an identification of another vending machine that currently has an inventory of the particular product; (iii) a promotion of a trial product that is similar to the particular product; and (iv) a promotion of a trial product that is complimentary to the particular product

20. A vending machine, comprising:
a touch screen interface to:
(i) provide an offer for a free unit of a product in exchange for an e-mail address associated with a customer;
(ii) to receive an indication of the e-mail address associated with the customer; and
(iii) to receive a code redeemable for the free unit of the product;
a dispensing device to dispense products;
a communication device to transmit a promotional message to the e-mail address associated with the customer, wherein the promotional message comprises an indication of the code that may be utilized to redeem the free unit of the product; and
a processor in communication with the touch screen interface, the dispensing device, and the communication device, the processor being operable to:
(i) cause the communication device to transmit the promotional message to the e-mail address associated with the customer;
(i) verify the code redeemable for the free unit of the product that is received by the touch screen interface; and
(iii) cause, after verifying the code redeemable for the free unit of the product that is received by the touch screen interface, the dispensing device to dispense the free unit of the product.
